(19) United States
(12) Patent Application Publication
(10) Pub. No.: US 2026/0128316 A1
(43) Pub. Date: May 7, 2026

(54) BINDER FOR ALL-SOLID-STATE SECONDARY BATTERY, INORGANIC SOLID ELECTROLYTE-CONTAINING COMPOSITION, SHEET FOR ALL-SOLID-STATE SECONDARY BATTERY, AND ALL-SOLID-STATE SECONDARY BATTERY

(71) Applicant: FUJIFILM Corporation, Tokyo (JP)

(72) Inventors: Yuzo NAGATA, Kanagawa (JP); Koji YASUDA, Kanagawa (JP)

(73) Assignee: FUJIFILM Corporation, Tokyo (JP)

(21) Appl. No.: 19/424,177

(22) Filed: Dec. 18, 2025

Related U.S. Application Data
(63) Continuation of application No. PCT/JP2024/023135, filed on Jun. 26, 2024.

(30) Foreign Application Priority Data
Jun. 30, 2023 (JP) 2023-108489
Dec. 27, 2023 (JP) 2023-220463

(51) Int. Cl. H01M 4/62; H01M 4/02; H01M 10/0525

(52) U.S. Cl. CPC H01M 4/623; H01M 10/0525; H01M 2004/021; H01M 2004/027; H01M 2004/028

(57) ABSTRACT

Provided are a binder for an all-solid-state secondary battery, which contains a polymer represented by Formula (I) and having an acid value of 3 mgKOH/g or less; an inorganic solid electrolyte-containing composition containing the binder, an inorganic solid electrolyte, and a dispersion medium; and a sheet for an all-solid-state secondary battery and an all-solid-state secondary battery using the composition.

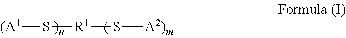

In Formula (I), R¹ represents an (m+n)-valent linking group, A¹ represents a hydrogen atom, or a functional group or a polymer chain, including at least one amide substituent, A² represents a functional group or a polymer chain, including at least one of a fluorine atom or a polysiloxane structure, n represents an integer of 1 to 8, and m represents an integer of 1 to 9, where m+n represents an integer of 2 to 10.

### CROSS-REFERENCE TO RELATED APPLICATIONS

This application is a Continuation of PCT International Application No. PCT/JP2024/023135 filed on Jun. 26, 2024, which claims priority under 35 U.S.C. § 119 (a) to Japanese Patent Application No. 2023-108489 filed in Japan on Jun. 30, 2023, and JP2023-220463 filed in Japan on Dec. 27, 2023. Each of the above applications is hereby expressly incorporated by reference, in its entirety, into the present application.

### BACKGROUND OF THE INVENTION

### 1. Field of the Invention

The present invention relates to a binder for an all-solid-state secondary battery, an inorganic solid electrolyte-containing composition, a sheet for an all-solid-state secondary battery, and an all-solid-state secondary battery.

### 2. Description of the Related Art

In an all-solid-state secondary battery, all of a negative electrode, an electrolyte, and a positive electrode consist of solid, and the all-solid-state secondary battery can greatly improve safety and reliability, which are said to be problems to be solved in a secondary battery in which an organic electrolytic solution is used. It is also said to be capable of extending battery life. Furthermore, the all-solid-state secondary battery can be provided with a structure in which the electrodes and the electrolyte are directly arranged in series. As a result, it is possible to increase an energy density to be high as compared with the secondary battery in which an organic electrolytic solution is used, and thus the application to electric vehicles, large-sized storage batteries, and the like is expected.

In such an all-solid-state secondary battery, a constituent layer (a solid electrolyte layer, a negative electrode active material layer, a positive electrode active material layer, or the like) is composed of solid particles such as an inorganic solid electrolyte, an active material, and a conductive auxiliary agent, and a binder which binds these solid particles in the constituent layer is also used in combination in general. In consideration of improvement in productivity and the like, the constituent layer is usually formed of a constituent layer-forming material containing the solid particles and the binder. Therefore, studies on the binder and the constituent layer-forming material have been carried out. For example, JP2015-164125A discloses, as a binder, a multibranched polymer which is an amorphous polymer and has a core portion and at least three polymeric arm portions bonded to the core portion, and a solid electrolyte composition containing the multibranched polymer and an inorganic solid electrolyte. Specifically, a solid electrolyte composition containing a particulate multibranched polymer having a polymer chain in which all arm portions bonded to the core portion have the same constitutional component, the polymer chain being a copolymer chain of an acidic group-containing (meth)acrylic acid-based monomer and a methacrylic acid alkyl monomer, a homopolymer chain of a methacrylic acid alkyl monomer, or a copolymer chain of a methacrylic acid alkyl monomer, an inorganic solid electrolyte, and a dispersion medium is disclosed. In addition, WO2020/067106A discloses, as a binder, a polymer represented by Formula 1, and a solid electrolyte composition containing the polymer and an inorganic solid electrolyte. In WO2020/067106A, as an example of the polymer represented by Formula 1, a polymer D-14 (acid value: approximately 4 mgKOH/g) having a polymer chain of a methacrylamide which has a sulfonic acid group as “(A¹)p-R²—” of Formula 1 is disclosed.

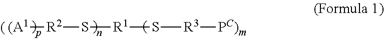

“in the formula, R¹ represents an (m+n)-valent linking group, A¹ represents an acidic group, a group having a basic nitrogen atom, a urea group, a urethane group, an alkoxysilyl group, an epoxy group, an isocyanate group, or a hydroxyl group, p represents an integer of 1 to 10, R² and R³ represent a single bond or a linking group, Pc represents a polymer chain which has a constitutional component including at least one selected from a fluoroalkylene group or a siloxane structure, m represents an integer of 1 to 8, and n represents an integer of 2 to 9, where m+n represents an integer of 3 to 10”

### SUMMARY OF THE INVENTION

In the all-solid-state secondary battery including the constituent layer formed of the constituent layer-forming material, from the viewpoint of improving battery performance (for example, reducing battery resistance), it is required that the solid particles are dispersed in the dispersion medium without being deteriorated or decomposed (dispersion state of the solid particles) in the constituent layer-forming material. In addition, in recent years, research and development of high performance, practicality, and the like of electric vehicles have been rapidly progressing, and the performance required for the all-solid-state secondary battery has also been increased. Therefore, it is required to further improve the dispersion state of the solid particles in the constituent layer-forming material.

In order to meet such a demand, the present inventors have intensively studied a constituent layer-forming material and a polymer functioning as a binder used for the constituent layer-forming material. As a result, the present inventors have conceived that, in a case of preparing the constituent layer-forming material by mixing solid particles such as an inorganic solid electrolyte and a binder, particularly in a case of mixing the inorganic solid electrolyte and the binder, heat generation may be a factor in reducing the dispersion state of the solid particles in the constituent layer-forming material.

However, in the related art, the constituent layer-forming material and the binder have been variously studied with the focus on dispersibility of the solid particles in the constituent layer-forming material after the mixing, and studies on the heat generation during the mixing have not been carried out.

An object of the present invention is to provide a binder for an all-solid-state secondary battery, which is capable of preparing a constituent layer-forming material by suppressing heat generation during mixing with an inorganic solid electrolyte, and an inorganic solid electrolyte-containing composition containing the binder for an all-solid-state secondary battery and an inorganic solid electrolyte. Another object of the present invention is to provide a sheet for an all-solid-state secondary battery and an all-solid-state secondary battery, using the inorganic solid electrolyte-containing composition.

As a result of studies based on the above-described concept, the present inventors have found that, as a binder to be used in combination with an inorganic solid electrolyte, a binder containing a multibranched polymer which has a specific chemical structure represented by Formula (I) and has an acid value of 3 mgKOH/g or less can be used for preparing an inorganic solid electrolyte-containing composition by suppressing heat generation during mixing with the inorganic solid electrolyte, and more preferably suppressing excessive interaction between binders and excessive adsorption of the binder on solid particles. In addition, it is found that, in a case where the inorganic solid electrolyte-containing composition containing the specific binder, the inorganic solid electrolyte, and a dispersion medium is used as a constituent layer-forming material, it is possible to realize a sheet for an all-solid-state secondary battery, which has a constituent layer having low resistance, and realize an all-solid-state secondary battery having low resistance. The present invention has been completed by further repeating studies on the basis of the above-described finding.

That is, the above-described object has been achieved by the following method.
<1> A binder for an all-solid-state secondary battery, comprising:
a polymer which is represented by Formula (I) and has an acid value of 3 mgKOH/g or less,

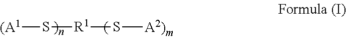

in Formula (I), R¹ represents an (m+n)-valent linking group,
A¹ represents a hydrogen atom, or a functional group or a polymer chain, including at least one of an amide group, a sulfonamide group, or an imide group,
A² represents a functional group or a polymer chain, including at least one of a fluorine atom or a polysiloxane structure,
n represents an integer of 1 to 8, and m represents an integer of 1 to 9, where m+n represents an integer of 2 to 10.
<2> The binder for an all-solid-state secondary battery according to <1>,
in which A¹ represents a functional group or a polymer chain, including at least one of an amide group, a sulfonamide group, or an imide group.
<3> The binder for an all-solid-state secondary battery according to <1> or <2>,
in which A² includes a functional group or a polymer chain, including a polysiloxane structure.
<4> The binder for an all-solid-state secondary battery according to any one of <1> to <3>,
in which the acid value of the polymer is 0.5 mgKOH/g or less, and a base value of the polymer is 0.5 mgKOH/g or less.
<5> The binder for an all-solid-state secondary battery according to any one of <1> to <4>,
in which A¹ includes a polymer chain of a (meth)acrylamide compound.
<6> The binder for an all-solid-state secondary battery according to any one of <1> to <5>,
in which A¹ includes a hydrogen atom and a polymer chain of a (meth)acrylamide compound.
<7> The binder for an all-solid-state secondary battery according to any one of <1> to <6>,
in which a content of A¹ in the polymer is 1% to 30% by mass.
<8> The binder for an all-solid-state secondary battery according to any one of <1> to <7>,
in which a weight-average molecular weight of the polymer is 30,000 or less.
<9> An inorganic solid electrolyte-containing composition comprising:
the binder for an all-solid-state secondary battery according to any one of <1> to <8>;
an inorganic solid electrolyte having conductivity of an ion of a metal belonging to Group 1 or Group 2 of the periodic table; and
a dispersion medium.
<10> The inorganic solid electrolyte-containing composition according to <9>, further comprising:
an active material.
<11> The inorganic solid electrolyte-containing composition according to <9> or <10>, further comprising:
a conductive auxiliary agent.
<12> A sheet for an all-solid-state secondary battery, comprising:
a layer formed of the inorganic solid electrolyte-containing composition according to any one of <9> to <11>.
<13> An all-solid-state secondary battery comprising, in the following order:
a positive electrode active material layer;
a solid electrolyte layer; and
a negative electrode active material layer,
in which at least one of the positive electrode active material layer, the solid electrolyte layer, or the negative electrode active material layer is a layer formed of the inorganic solid electrolyte-containing composition according to any one of <9> to <11>.

According to the present invention, it is possible to provide a binder for an all-solid-state secondary battery, which is capable of preparing a constituent layer-forming material by suppressing heat generation during mixing with an inorganic solid electrolyte, and an inorganic solid electrolyte-containing composition containing the binder for an all-solid-state secondary battery and an inorganic solid electrolyte. In addition, according to the present invention, it is possible to provide a sheet for an all-solid-state secondary battery and an all-solid-state secondary battery, which includes a layer formed of the inorganic solid electrolyte-containing composition.

The above-described and other features and advantages of the present invention will become more apparent from the following description, appropriately referring to the accompanying drawing.

### BRIEF DESCRIPTION OF THE DRAWINGS

FIG. 1 is a vertical cross-sectional view schematically showing an all-solid-state secondary battery according to a preferred embodiment of the present invention.

FIG. 2 is a vertical cross-sectional view schematically showing a coin-type all-solid-state secondary battery produced in Examples.

### DESCRIPTION OF THE PREFERRED EMBODIMENTS

In the present invention, in a case where a numerical range is shown to describe a content, physical properties, or the like of a component, any upper limit value and any lower limit value can be appropriately combined to obtain a specific numerical range in a case where an upper limit value and a lower limit value of the numerical range are described separately. On the other hand, in a case where a numerical range expressed using “to” is described by setting a plurality of numerical ranges, the upper limit value and the lower limit value forming the numerical range are not limited to a specific numerical range before and after “to” in a specific combination, and the upper limit value and the lower limit value of each numerical range can be appropriately combined. In the present invention, a numerical range represented by using “to” means a range including numerical values described before and after “to” as a lower limit value and an upper limit value.

In the present invention, an expression of a compound (for example, in a case where a compound is represented by an expression with “compound” added to the end) refers to not only the compound itself but also a salt or an ion thereof. In addition, the expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same is applied to a compound which is not specified regarding whether to be substituted or unsubstituted. Preferred examples of the substituent include a substituent Z described later.

In the present invention, in a case where a plurality of substituents or the like represented by a specific reference numeral are present or a plurality of substituents or the like are simultaneously defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer, but it is synonymous with a so-called polymeric compound.

[Binder for all-Solid-State Secondary Battery]

A binder for an all-solid-state secondary battery according to the embodiment of the present invention (hereinafter, may be simply referred to as “binder according to the embodiment of the present invention”) contains a polymer represented by Formula (I) described later and having an acid value of 3 mgKOH/g or less.

In the present invention, the binder for an all-solid-state secondary battery (hereinafter, may be simply referred to as “binder”) containing a polymer includes both forms of a binder consisting of the polymer itself and a binder containing the polymer and other components. Examples of the other components which can be contained in the binder are not particularly limited, and examples thereof include a synthesis by-product of the polymer, a decomposition product (residue) such as a polymerization catalyst, and a residual synthetic solvent. A content of the other components in the binder according to the embodiment of the present invention can be appropriately set within a range not impairing the effect of the present invention, and can be, for example, 10% by mass or less.

The binder according to the embodiment of the present invention may contain one or two or more of the polymers represented by Formula (I). In addition, the binder according to the embodiment of the present invention is usually formed of the polymer represented by Formula (I) as a polymer component, but may contain other polymers or the like within a range not impairing the action of the polymer represented by Formula (I). Examples of the other polymers include a polymer having no chemical structure represented by Formula (I), and a polymer usually used as a binder for an all-solid-state secondary battery can be used without particular limitation.

The binder according to the embodiment of the present invention can suppress heat generation during mixing with solid particles, particularly an inorganic solid electrolyte, in a case of preparing an inorganic solid electrolyte-containing composition. Therefore, it is considered that, even without setting preparation conditions (mixing conditions), for example, without performing an excessive cooling operation, the solid particles, particularly the inorganic solid electrolyte, can be suppressed from being deteriorated or decomposed, and thus the solid particles can be dispersed in the dispersion medium. In addition, since the binder according to the embodiment of the present invention has an acid value of 3 mgKOH/g, it is considered that the binder can suppress excessive interaction between the binders and excessive adsorption of the binder on the solid particles in the dispersion medium, and thus can suppress excessive aggregation and precipitation of the binder and the solid particles. As a result, the solid particles can be dispersed in the dispersion medium while suppressing deterioration and decomposition of the solid particles, and thus the dispersion state of the solid particles can be improved. By using, as a constituent layer-forming material of an all-solid-state secondary battery, the inorganic solid electrolyte-containing composition according to the embodiment of the present invention, in which the dispersion state of the solid particles is excellent, a sheet for an all-solid-state secondary battery including a constituent layer having low resistance (high conductivity) and an all-solid-state secondary battery having low resistance (high conductivity) can be realized.

As described above, in the preparation of the inorganic solid electrolyte-containing composition, the binder according to the embodiment of the present invention functions as a dispersant which suppresses the deterioration and decomposition of the solid particles and disperses the solid particles in the dispersion medium. In addition, in the constituent layer formed of the inorganic solid electrolyte-containing composition, the binder according to the embodiment of the present invention functions as a binder which adsorbs to the solid particles to bind the solid particles and further binds the collector and the solid particles. In the inorganic solid electrolyte-containing composition, the binder according to the embodiment of the present invention may or may not have a function of binding the solid particles. The adsorption of the binder according to the embodiment of the present invention to the solid particles includes not only physical adsorption but also chemical adsorption (adsorption by chemical bond formation, adsorption by electron transfer, and the like).

The binder according to the embodiment of the present invention, which exhibits the above-described excellent action and effect, can be preferably used as a forming material of a solid electrolyte layer or an active material layer of a sheet for an all-solid-state secondary battery (including an electrode sheet for an all-solid-state secondary battery) or an all-solid-state secondary battery.

### <Polymer Represented by Formula (I)>

The polymer represented by Formula (I) (hereinafter, may be simply referred to as “polymer (I)”) is a multibranched polymer (also referred to as a star polymer) having a chemical structure represented by Formula (I).

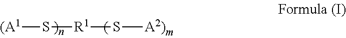

In Formula (I), R¹ represents an (m+n)-valent linking group, A¹ represents a hydrogen atom, or a functional group or a polymer chain, including at least one of an amide group, a sulfonamide group, or an imide group, A² represents a functional group or a polymer chain, including at least one of a fluorine atom or a polysiloxane structure, n represents an integer of 1 to 8, and m represents an integer of 1 to 9, where m+n represents an integer of 2 to 10. In Formula (I), in a case of a plurality of A's or A²'s, the plurality of A's or A²'s may be the same or different from each other.

### (R¹ in Formula (I))

In Formula (I), R¹ is an (m+n)-valent linking group, and is usually a linking group consisting of an organic group including a skeleton in which carbon atoms are bonded to each other by a covalent bond, and it is preferably a linking group further including an oxygen atom. Examples of the linking group include a linking group described in a linking group Ric of Formula 1B described later. A molecular weight of the linking group R¹ is not particularly limited, and is, for example, preferably 100 or more, more preferably 200 or more, and still more preferably 300 or more. The upper limit of the molecular weight is preferably 5,000 or less, more preferably 4,000 or less, and particularly preferably 3,000 or less. It is preferable that the linking group does not consist of only one tetravalent carbon atom.

The valence of the linking group is 2 to 10, and has the same definition and the same preferred range as those of (m+n) as the sum of m and n described below.

It is preferable that the linking group has a group represented by Formula 1a. It is preferable that the number of groups represented by Formula 1a in the linking group R¹ is the same as (m+n) which is the valence of R¹. In a case where the linking group has a plurality of the groups, the groups may be the same or different from each other.

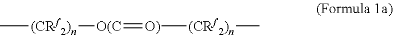

In Formula (Ia), n is an integer of 0 to 10, preferably an integer of 1 to 6, and more preferably 1 or 2. Two n's may be the same or different from each other.

R^{f} represents a hydrogen atom or a substituent, and is preferably a hydrogen atom. The substituent which can be adopted as R^{f} is not particularly limited, and examples thereof include the substituent Z described later; and specific examples thereof include a halogen atom (for example, a fluorine atom, a chlorine atom, an iodine atom, or a bromine atom), an alkyl group (preferably having 1 to 12 carbon atoms, more preferably 1 to 6 carbon atoms, and particularly preferably 1 to 3 carbon atoms), an alkoxy group (preferably having 1 to 12 carbon atoms, more preferably 1 to 6 carbon atoms, and particularly preferably 1 to 3 carbon atoms), an acyl group (preferably having 2 to 12 carbon atoms, more preferably 2 to 6 carbon atoms, and particularly preferably 2 or 3 carbon atoms), an aryl group (preferably having 6 to 22 carbon atoms and more preferably 6 to 10 carbon atoms), an alkenyl group (preferably having 2 to 12 carbon atoms and more preferably 2 to 5 carbon atoms), a hydroxy group, a nitro group, a cyano group, a mercapto group, an amino group, an amide group, and an acidic group (a carboxyl group, a phosphate group, a sulfonate group, or the like). The acidic group may be a salt. Examples of a counter ion forming the salt include an alkali metal ion, an alkaline earth metal ion, an ammonium ion, and an alkylammonium ion.

The linking group R¹ is more preferably a linking group represented by Formula 1A or Formula 1B.

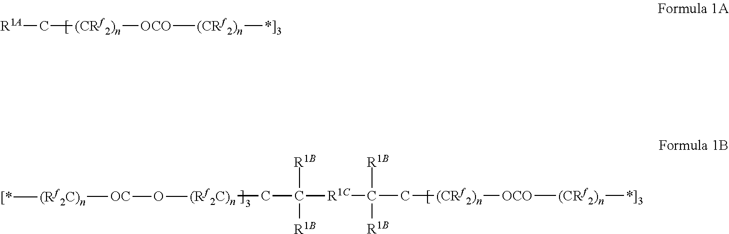

In both the formulae, R^{f} and n have the same definitions and the same preferred ranges as those of R^{f} and n in Formula 1a. * represents a bonding portion to a sulfur atom in Formula 1.

In Formula 1A, R^{1A} represents a hydrogen atom or a substituent. The substituent which can be adopted as R^{1A} is not particularly limited, and examples thereof include the respective substituents which can be adopted as R^{f} and the above-described group represented by Formula 1a. Among these, an alkyl group or the above-described group represented by Formula 1a is preferable. The number of carbon atoms in the alkyl group is preferably 1 to 12, more preferably 1 to 6, and particularly preferably 1 to 3. The substituent which can be adopted as R^{1A} may have one or two or more substituents, and the substituent which may be further included is not particularly limited; and examples thereof include the respective substituents which can be adopted as R^{f}. Among these, a hydroxy group is preferable. Examples of the substituent which may further have one or two or more substituents include a hydroxyalkyl group (the number of carbon atoms is as described above), and specifically, hydroxymethyl is preferable.

In Formula 1B, Ric represents a linking group. The linking group which can be adopted as Ric is not particularly limited, and is preferably an alkylene group having 1 to 30 carbon atoms, a cycloalkylene group having 3 to 12 carbon atoms, an arylene group having 6 to 24 carbon atoms, a heteroarylene group having 3 to 12 carbon atoms, an ether group (—O—), a sulfide group (—S—), a phosphinidene group (—PR—; R represents a hydrogen atom or an alkyl group having 1 to 6 carbon atoms), a silylene group (—SiR^{S1}R^{S2}—; R^{S1} and R^{S2} represent a hydrogen atom or an alkyl group having 1 to 6 carbon atoms), a carbonyl group, an imino group (—NR^{N}—; R^{N} represents a bonding site, a hydrogen atom, an alkyl group having 1 to 6 carbon atoms, or an aryl group having 6 to 10 carbon atoms), or a linking group of a combination of two or more (preferably 2 to 10) thereof. Among these, an alkylene group, an ether group, a sulfide group, a carbonyl group, or a linking group of a combination of two or more (preferably 2 to 5) thereof is preferable, and an ether group is more preferable. R^{1B} represents a hydrogen atom or a substituent, and is preferably a hydrogen atom. The substituent which can be adopted as R^{1B} is not particularly limited, and examples thereof include the respective substituents which can be adopted as R^{f}.

In Formula 1A and Formula 1B, groups represented by the same reference numeral may be the same or different from each other.

In addition to the above-described linking groups, as the linking group R¹, for example, a linking group in Formula 1B in which one or two or more of the groups represented by Formula 1a are substituted with each of the substituents which can be adopted as R^{f}, in particular, hydroxymethyl is also a preferred aspect.

As the linking group R¹, a linking group represented by any one of Formulae 1C to 1H is also preferable. In each of the formulae, * represents a bonding portion to S in Formula 1.

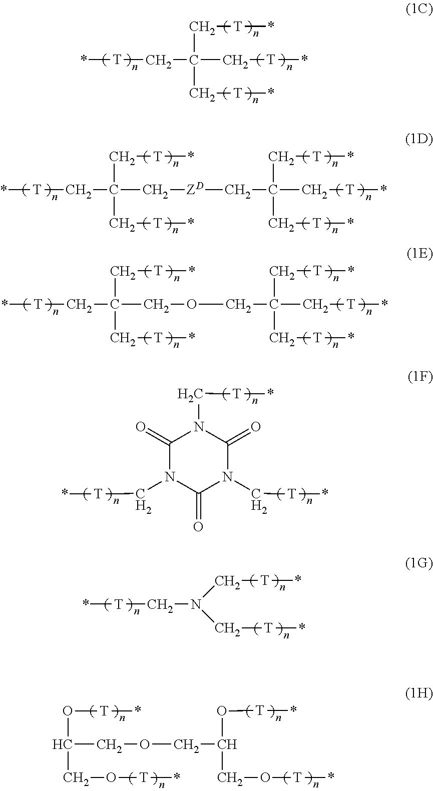

In Formulae 1C to 1H, T represents a linking group, preferably a group represented by any one of Formulae T1 to T6 or a linking group of a combination of two or more (preferably 2 or 3). Examples of the linking group of the combination include a linking group (—OCO-alkylene group) of a combination of the linking group represented by Formula T6 and the linking group represented by Formula T1. In the group represented by any one of Formulae T1 to T6, a sulfur atom in Formula 1 may be bonded to any bonding portion. However, in a case where T represents an oxyalkylene group (the group represented by any one of Formulae T2 to T5) or an —OCO-alkylene group, it is preferable that a sulfur atom in Formula 1 is bonded to a carbon atom (bonding portion) at a terminal.

A plurality of T's present in each of the above formulae may be the same or different from each other.

In each of Formulae 1C to 1H, n represents an integer, preferably an integer of 0 to 14, more preferably an integer of 0 to 5, and particularly preferably an integer of 1 to 3.

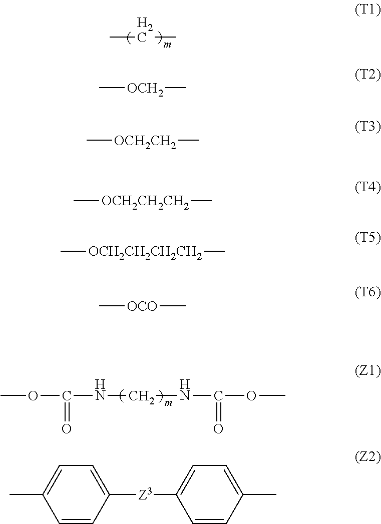

Z^{D} represents a linking group, and is preferably a group represented by Z1 or Z2.

In each of Formula T1 and Formula Z1, m represents an integer of 1 to 8, more preferably an integer of 1 to 5 and particularly preferably an integer of 1 to 3.

In Formula Z2, Z³ is a linking group, and is preferably an alkylene group having 1 to 12 carbon atoms and more preferably an alkylene group having 1 to 6 carbon atoms. Among these, a 2,2-propanediyl group is particularly preferable.

Hereinafter, specific examples of the linking group R¹ are shown, but the present invention is not limited thereto. In each of the specific examples, * represents a bonding portion to a sulfur atom in Formula 1.

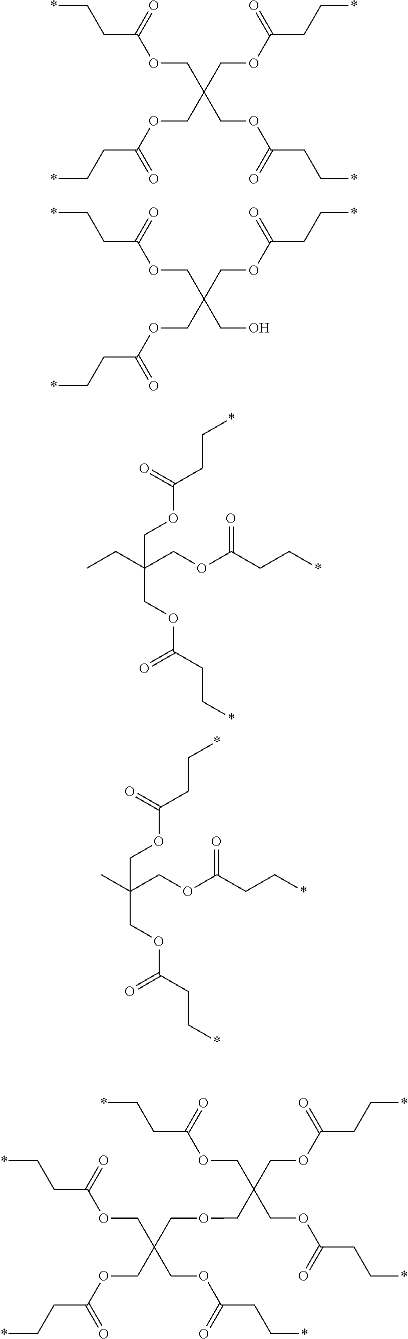

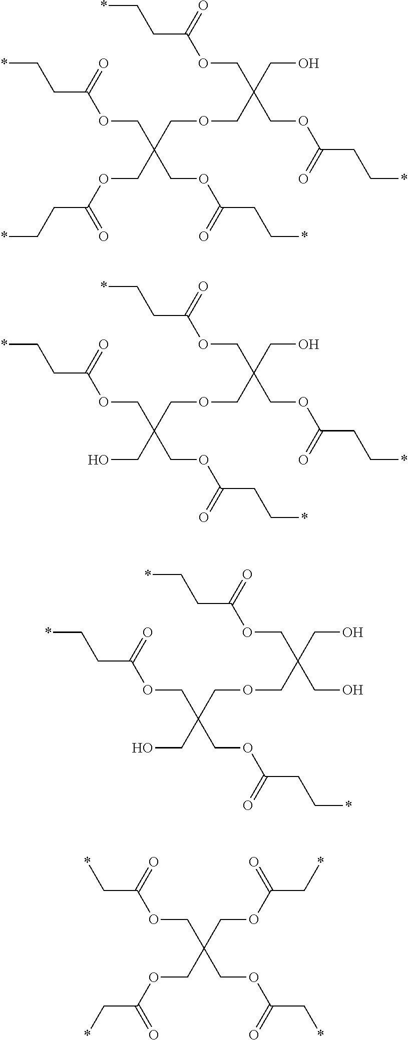 [SMILES: *CCC(=O)OCC(CO)(COCC(COC(=O)CC*)(COC(=O)CC*)COC(=O)CC*)COC(=O)CC* ; *CCC(=O)OCC(CO)(COCC(CO)(COC(=O)CC*)COC(=O)CC*)COC(=O)CC* ; *CCC(=O)OCC(CO)(CO)COCC(CO)(COC(=O)CC*)COC(=O)CC* ; *CC(=O)OCC(COC(=O)C*)(COC(=O)C*)COC(=O)C*]

### (A¹ in Formula (I))

(A-1) Hydrogen atom
(A-2) Functional group including at least one of an amide group, a sulfonamide group, or an imide group
(A-3) Polymer chain including at least one of an amide group, a sulfonamide group, or an imide group

In a case where the polymer (I) has A¹, the heat generation during mixing of the binder according to the embodiment of the present invention and the inorganic solid electrolyte can be suppressed, and the adsorption on the solid particles such as an active material is promoted, and as a result, the deterioration of the solid particles can be suppressed.

A¹ may be any one of (A-1) to (A-3), but from the viewpoint of suppressing the deterioration of the solid particles, it is preferable to include the polymer chain (A-3) including at least one of an amide group, a sulfonamide group, or an imide group, and it is more preferable to include a polymer chain including an amide group.

In a case where A¹ includes two or three of (A-1) to (A-3), a combination thereof is not particularly limited, and (A-1) to (A-3) can be appropriately combined. Examples of the combination thereof include a combination of (A-1) and (A-2) and a combination of (A-1) and (A-3), and from the viewpoint of suppressing the deterioration of the solid particles, a combination of (A-1) and (A-3) is preferable. In these combinations, the polymer chain (A-3) which can be adopted as A¹ is preferably the polymer chain including an amide group.

In the present invention, the functional group or the polymer chain, including at least one of an amide group, a sulfonamide group, or an imide group (hereinafter, may be referred to as “amide substituent”), includes both aspects of an aspect in which the functional group or the polymer chain consists of the amide substituent and an aspect in which the functional group or the polymer chain consists of the amide substituent and other partial structures.

In the present invention, the amide group refers to a group having an amide bond represented by *—CONR^{NA1}—** However, the amide group does not form other functional groups including an amide bond, such as a urethane group, a urea group, an imide group, and a carbamate group. The sulfonamide group refers to a group having a sulfonamide bond represented by *—SO₂NR^{NA1}—**. The imide group refers to a group having an imide bond represented by *—CO—NR^{NA2}—CO—**. * and ** represent a bonding portion.

R^{NA1} represents a hydrogen atom or a substituent, and R^{NA2} represents a bonding portion, a hydrogen atom, or a substituent. The substituent which can be adopted as R^{NA1} and R^{NA2} is not particularly limited, and examples thereof include the substituent Z described later. Among these, an alkyl group (including a cycloalkyl group), an aryl group, a heterocyclic group, or an alkoxy group is preferable, and an alkyl group or an aryl group is preferable. The number of carbon atoms in the alkyl group is preferably 1 to 20, more preferably 1 to 12, and still more preferably 1 to 6. The number of carbon atoms in the aryl group is preferably 6 to 26, more preferably 6 to 20, and still more preferably 6 to 12. R^{NA1} in the amide group and the sulfonamide group is preferably a hydrogen atom, and R^{NA2} is preferably a bonding portion or a hydrogen atom, and more preferably a bonding portion.

In each of the above-described groups, any of the two bonding portions * and ** may be bonded to the R¹ side of the polymer (I); but in the amide group and the sulfonamide group, it is preferable that the bonding portion * is bonded to the R¹ side of the polymer (I), and in the imide group, it is preferable that R^{NA2} is bonded to the R¹ side of the polymer (I).

The amide group, the sulfonamide group, and the imide group may each directly or through the two bonding portions * and ** form a cyclic structure through a linking group described later. For example, the imide group preferably forms a cyclic imide group, specifically, a cyclic imide group derived from maleimide or phthalimide. On the other hand, it is preferable that the amide group and the sulfonamide group each bond to a terminal group described later through the other bonding portion to form an acyclic molecular structure.

The amide group, the sulfonamide group, and the imide group each have a terminal group bonded to a terminal (one bonding portion) of each group. The terminal group is not particularly limited, and examples thereof include a hydrogen atom and a substituent. The substituent which can be adopted as the terminal group is not particularly limited, and examples thereof include the substituent Z described later. Among these, an alkyl group (including a cycloalkyl group), an aryl group, a heterocyclic group, or an alkoxy group is preferable, and an alkyl group or an aryl group is more preferable. The number of carbon atoms in the alkyl group is preferably 1 to 20, more preferably 2 to 8, and still more preferably 3 or 4. The number of carbon atoms in the aryl group is the same as the number of carbon atoms in the aryl group which can be adopted as R^{NA1} or the like.

In the present invention, in a case where any one of R^{NA1} or the terminal group is a hydrogen atom, the hydrogen atom is interpreted as R^{NA1}

In the polymer (I), from the viewpoint of the dispersion state of the solid particles and the resistance, the amide substituent included in A¹ is preferably an amide group.

The kind of the amide substituent included in A¹ may be at least one kind, and is preferably one kind or two kinds. In a case where A¹ has a plurality of kinds of the amide substituents, a combination thereof is not particularly limited, and can be appropriately determined. The number of amide substituents included in A¹ and the polymer (I) is not particularly limited, and can be appropriately determined depending on the functional group or the polymer chain.

### (Functional Group A^{1G} Including at Least One of Amide Group, Sulfonamide Group, or Imide Group)

A functional group A^{1G} ((A-2)) including at least one of an amide group, a sulfonamide group, or an imide group may be a functional group consisting of at least one of an amide group, a sulfonamide group, or an imide group, but is preferably a functional group further including a linking group L^{A1} which is linked to “S” (sulfur atom) in Formula (I). That is, each of the amide group, the sulfonamide group, and the imide group may be directly (without through the linking group L^{A1}) bonded to the sulfur atom in Formula (I), but is preferably bonded through the linking group L^{A1}.

The linking group L^{A1} is not particularly limited, and examples thereof include an alkylene group (preferably having 1 to 12 carbon atoms, more preferably 2 to 6 carbon atoms, and still more preferably having 2 or 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—; R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P)(OH)(O)—O—), and a group of a combination thereof. The linking group L^{A1} is preferably an alkylene group, an arylene group, a carbonyl group, an oxygen atom, a sulfur atom, an imino group, or a group of a combination thereof, and more preferably a group including an alkylene group, an arylene group, or a group of a combination thereof. The linking group L^{A1} is still more preferably a group including an alkylene group, and is particularly preferably an alkylene group or an alkylene group-arylene group. The linking group L^{A1} is one of preferred aspects of the group different from the amide group, the sulfonamide group, and the imide group.

The number of atoms constituting the above-described linking group L^{A1} is preferably 1 to 36, more preferably 1 to 24, and still more preferably 1 to 12. The number of linking atoms of the linking group L^{A1} is preferably 12 or less, more preferably 10 or less, and particularly preferably 8 or less. The lower limit thereof is 1 or more. The above-described number of linking atoms refers to the minimum number of atoms linking predetermined structural moieties. For example, in a case of a —CH₂—CH₂-(p-C₆H₄)— group, the number of atoms constituting the linking group is 16 and the number of linking atoms is 6.

The functional group A^{1G} including one kind of the amide substituent is preferably a group derived from a low-molecular-weight compound, and more preferably does not have a polymer chain A^{1P} described later, which can be adopted as A¹. In addition, it is preferable that the functional group A^{1G} does not have a fluorine atom and a polysiloxane structure.

From the viewpoint of the dispersion state of the solid particles and the resistance, the functional group A^{1G} is preferably a functional group including an amide group.

The compound from which the functional group A^{1G} which can be adopted as A¹ is derived is not particularly limited, and examples thereof include a reactive compound in which a reactive group with respect to a sulfanyl group and at least one amide substituent are directly or through a linking group L^{A2} (excluding the above-described reactive group) bonded to each other; and a reactive compound in which the reactive group and at least one amide substituent are directly bonded to each other is preferable.

The reactive group is appropriately selected depending on the type of reaction with respect to the sulfanyl group, and examples thereof include an ethylenically unsaturated group capable of thiol-ene reaction or radical polymerization, a carboxyl group capable of condensation reaction, and a halogenated alkyl group capable of thio-etherification. Examples of the ethylenically unsaturated group include a vinyl group. The reactive group may be included at one or more positions in the terminal or the side chain of the molecular structure of the reactive compound, and is preferably included at 1 to 4 positions and more preferably at 1 position.

The linking group L^{A2} is not particularly limited, and each group described in the linking group L^{A1} above can be adopted, and an arylene group is still more preferable as the linking group L^{A2}. The above-described linking group L^{A1} is the same as a group formed of the above-described reactive group after reacting with the sulfanyl group and the linking group L^{A2}.

The reactive compound from which the functional group A^{1G} is derived is not particularly limited, and preferred examples thereof include a reactive compound having an ethylenically unsaturated bond. Examples thereof include (meth)acrylic compounds (M1) such as a (meth)acrylic acid compound, a (meth)acrylic acid ester compound, a (meth)acrylamide compound, and a (meth)acrylonitrile compound; vinyl compounds (M2) including vinyl aromatic compounds such as a styrene compound, a vinyl naphthalene compound, and a vinyl carbazole compound, allyl compounds, vinyl ether compounds, vinyl ester compounds, cyclic olefin compounds, diene compounds, and vinyl carboxylic acid ester compounds; and reactive compounds in which at least one of the above-described amide substituents is introduced into compounds such as dialkyl itaconate compounds and unsaturated carboxylic acid anhydrides. In addition to these compounds, examples thereof also include a (meth)acrylamide compound, a maleimide compound, an N-vinyl-substituted imide compound, and a vinyl succinimide compound. Among these, a styrene compound, a vinyl naphthalene compound, a reactive compound which is a (meth)acrylic acid ester compound in which at least one of the above-described amide substituents is introduced, a (meth)acrylamide compound, or an N-vinyl-substituted imide compound is preferable.

Examples of the (meth)acrylic acid ester compound include a (meth)acrylic acid alkyl ester compound and a (meth)acrylic acid aryl ester compound, and a (meth)acrylic acid alkyl ester compound is preferable. The number of carbon atoms in the alkyl group constituting the (meth)acrylic acid alkyl ester compound is not particularly limited, but it can be set to, for example, 1 to 24, preferably 1 to 12, more preferably 1 to 6, and still more preferably 1 to 4. The number of carbon atoms in the aryl group constituting the aryl ester is not particularly limited, but it can be set to, for example, 6 to 24, preferably 6 to 10 and more preferably 6.

Examples of a reactive compound which derives the functional group including an amide group include (meth)acrylamide compounds such as an N-unsubstituted (meth)acrylamide compound and an N-monosubstituted or N-disubstituted (meth)acrylamide compound; vinyl compounds containing an amide group; (meth)acrylic acid ester compounds containing an amide group; and (meth)acrylamide compounds containing an amide group. Specific examples thereof include an N-unsubstituted (meth)acrylamide compound, an N-alkyl (meth)acrylamide compound, an N,N-dialkyl (meth)acrylamide compound, an N-aryl (meth)acrylamide compound, and an N,N-diaryl (meth)acrylamide compound.

Examples of the substituent which substitutes a nitrogen atom in the acrylamide compound include R^{NA1} or the terminal group bonded to the terminal of the amide bond described above, and an alkyl group is preferable.

As the reactive compound which derives the functional group including an amide group, a compound which derives a group having a chemical structure represented by Formula (A1) described later is also preferable. The terminal group bonded to one end of the chemical structure represented by Formula (A1) is the same as the terminal group included in the amide substituent described above.

Examples of a reactive compound which derives the functional group including a sulfonamide group include a vinyl aromatic sulfonamide compound and a (meth)acrylic compound (M1) containing a sulfonamide group. Among these, a compound in which a sulfonamide group is introduced into a vinyl aromatic compound such as a styrene compound and a vinyl naphthalene compound is preferable, and vinylbenzenesulfonamide is more preferable.

The reactive compound which derives the functional group including a sulfonamide group may be an N-monosubstituted or N-disubstituted sulfonamide compound, and examples of the substituent which substitutes a nitrogen atom of the sulfonamide group include R^{NA1} or the terminal group bonded to the terminal of the amide bond described above, and an alkyl group is preferable.

Examples of a reactive compound which derives the functional group including an imide group include a maleimide compound and an N-vinyl-substituted imide compound, and preferred examples thereof include maleimide, a vinyl phthalimide compound, and a vinyl succinimide compound.

(Polymer Chain A^{1P} Including at Least One of Amide Group, Sulfonamide Group, or Imide Group) A polymer chain A^{1P} ((A-3)) may be a polymer chain consisting of at least one of an amide group, a sulfonamide group, or an imide group, but is preferably a polymer chain introduced into the polymer (I) by reacting with a group (for example, a sulfanyl group) which derives the sulfur atom in Formula (I). Such a polymer chain is not particularly limited, and a chain consisting of a normal polymer can be applied. For example, it is preferably a chain consisting of a polymer having a polymerized chain of carbon-carbon double bonds as a main chain. In the present invention, the polymerized chain of carbon-carbon double bonds refers to a polymerized chain which is obtained by polymerizing carbon-carbon double bonds (ethylenically unsaturated groups), and specifically, it refers to a polymerized chain obtained by polymerizing (homopolymerizing or copolymerizing) a monomer having a carbon-carbon unsaturated bond. Examples of the polymer having the polymerized chain of carbon-carbon double bonds as a main chain include chain polymerization polymers such as a hydrocarbon-based polymer, a vinyl polymer, and a (meth)acrylic polymer; and a vinyl polymer or a (meth)acrylic polymer is preferable. Here, examples of the (meth)acrylic polymer include a polymer consisting of a (co)polymer containing 50% by mass or more of a constitutional component derived from the above-described (meth)acrylic compound (M1). Examples of the vinyl polymer include a polymer consisting of a copolymer containing 50% by mass or more of a constitutional component derived from the above-described vinyl-based compound (M2) (where a content of a constitutional component derived from the (meth)acrylic compound (M1) is less than 50% by mass). In addition to the above, examples of the polymer chain including an imide group also include a polymerized chain formed by homopolymerizing or copolymerizing maleimide such as polybismaleimide. Here, it is preferable that the polymer chain A^{1P} which can be adopted as A¹ does not have a fluorine atom and a polysiloxane structure.

In the polymer chain A^{1P} which can be adopted as A¹, the amide substituent may be included in the main chain of the polymer chain or the terminal of the main chain, but is preferably included in a molecular chain which is a side chain, and for example, more preferably incorporated into an inside or a terminal of the molecular chain which is the side chain of the polymer chain.

In the present invention, the molecular chain which is the side chain of the polymer chain refers to a molecular chain constituting the side chain in the polymer chain, and is a molecular chain bonded to a molecular chain (atomic group) constituting the main chain of the polymer chain.

In addition, in the present invention, the main chain of the polymer and the polymer chain refers to all molecular chains constituting the polymer or the polymer chain, which are linear molecular chains that can be regarded as branched chains or pendant groups with respect to the main chain. Although it depends on a weight-average molecular weight of a branch chain regarded as the branched chain or the pendant group, the longest chain among the molecular chains constituting the polymer is typically the main chain. However, the main chain does not include a terminal group included in the terminal of the polymer. On the other hand, the side chain of the polymer and the polymer chain refers to a branched chain other than the main chain, and includes a short chain and a long chain (graft chain). The terminal group of the polymer and the polymer chain is not particularly limited, and an appropriate group can be adopted depending on a polymerization method or the like. Examples thereof include a hydrogen atom, an alkyl group, an aryl group, a hydroxy group, and a residue of a polymerization initiator.

Examples of the polymer chain A^{1P} include a polymer chain having a constitutional component containing at least one amide substituent (hereinafter, may be referred to as an amide substituent-containing constitutional component). In the polymer chain A^{1P}, among the amide substituent-containing constitutional components, it is preferable to have a constitutional component including any one of an amide group, a sulfonamide group, or an imide group, and it is more preferable to have a constitutional component including an amide group from the viewpoint of the dispersion state of the solid particles and the resistance.

Examples of the amide substituent-containing constitutional component include a constitutional component derived from the reactive compound from which the above-described functional group A^{1G} is derived.

Examples of the polymer chain A^{1P} include a chain consisting of a homopolymer or a copolymer of the reactive compound from which the functional group A^{1G} is derived. Among the chains consisting of the homopolymer or the copolymer of the reactive compound, the polymer chain A^{1P} is preferably a polymer chain which includes a constitutional component derived from at least one reactive compound selected from (meth)acrylic acid, a (meth)acrylic acid ester compound, a (meth)acrylamide compound, or a (meth)acrylonitrile compound (referred to as a chain consisting of a (meth)acrylic polymer); more preferably a polymer chain which includes a constitutional component derived from at least one reactive compound selected from (meth)acrylic acid, a (meth)acrylic acid ester compound, or a (meth)acrylamide compound; still more preferably a polymer chain which includes a constitutional component derived from at least one reactive compound selected from a (meth)acrylic acid ester compound or a (meth)acrylamide compound; even more preferably a polymer chain which includes a constitutional component derived from a (meth)acrylamide compound (also referred to as a polymer chain of a (meth)acrylamide compound); even still more preferably a polymer chain consisting of a homopolymer of a (meth)acrylamide compound; and most preferably a polymer chain consisting of a homopolymer of an N-unsubstituted (meth)acrylamide compound. Preferred examples of the constitutional component derived from the (meth)acrylamide compound include a constitutional component represented by Formula (A1) described later.

The polymer chain A^{1P} may have a constitutional component (referred to as other constitutional components) other than the amide substituent-containing constitutional component. The other constitutional components are not particularly limited as long as they are constitutional components not having an amide group, a sulfonamide group, and an imide group, and examples thereof include a constitutional component derived from a polymerizable compound which can be copolymerized with the reactive compound from which the amide substituent-containing constitutional component is derived. Examples of the other constitutional components include constitutional components derived from a low-molecular-weight polymerizable compound having an ethylenically unsaturated group, and more specific examples thereof include constitutional components derived from each of the above-described compounds exemplified as the reactive compound (before the introduction of the amide substituent), and compounds obtained by introducing a functional group (a) described later into the compound. Among these, constitutional components derived from a reactive compound selected from a (meth)acrylic acid compound, a (meth)acrylic acid ester compound, or a (meth)acrylonitrile compound, or constitutional components derived from a compound obtained by introducing the functional group (a) described later into a (meth)acrylic acid ester compound are preferable.

In the present invention, in a case where the polymer chain A^{1P} has a constitutional component derived from a (meth)acrylic acid ester compound, particularly an unsubstituted alkyl (meth)acrylate, a content of the constitutional component derived from the (meth)acrylic acid ester compound in the polymer chain is preferably 50% by mass or less, more preferably 25% by mass or less, and still more preferably 10% by mass or less. It is also one of preferred aspects that the polymer chain A^{1P} does not have the constitutional component derived from a (meth)acrylic acid ester compound.

Examples of the (meth)acrylic acid ester compound from which the other constitutional components are derived include a (meth)acrylic acid alkyl ester compound and a (meth)acrylic acid aryl ester compound, and a (meth)acrylic acid alkyl ester compound is preferable. The number of carbon atoms in the alkyl group constituting the (meth)acrylic acid alkyl ester compound is not particularly limited, and it can be set to, for example, 1 to 24. Usually, the number of carbon atoms in the alkyl group is preferably 1 to 12, more preferably 1 to 6, and from the viewpoint of solubility in the dispersion medium and the like, preferably 3 to 16 and more preferably 6 to 14. The number of carbon atoms in the aryl group constituting the aryl ester is not particularly limited, but it can be set to, for example, 6 to 24, preferably 6 to 10 and more preferably 6. The (meth)acrylic acid ester compound may have a substituent. The substituent is not particularly limited, and examples thereof include the substituent Z described later (where a group included in the functional group (a) described later is excluded). Preferred examples of the substituent include a fluorine atom.

In a case where the polymer chain A^{1P} contains the other constitutional components, a primary structure (bonding mode of the constitutional components) of the polymer chain A^{1P} is not particularly limited; and any bonding mode such as a random structure, a block structure, an alternating structure, and a graft structure can be adopted, but a random structure or a block structure is preferable.

The group bonded to the terminal of the polymer chain A^{1P} is not particularly limited, and an appropriate group can be adopted depending on the polymerization method or the like as described above.

A weight-average molecular weight Mw^{1P} of the polymer chain A^{1P} is not particularly limited, and is appropriately set in consideration of the weight-average molecular weight of the polymer (I) described later, and is, for example, preferably 200 to 10,000 and more preferably 400 to 3,000. In addition, a polymerization degree of all constitutional components in the polymer chain A^{1P} is not particularly limited, and is preferably 2 to 100 and more preferably 4 to 30.

A content of the amide substituent-containing constitutional component in the polymer chain A^{1P} is not particularly limited, but is preferably 10% by mass or more, and from the viewpoint of the dispersion state of the solid particles and the resistance, preferably 20% by mass or more, more preferably 30% by mass or more, still more preferably 50% by mass or more, and a case in which the content is 100% by mass is one of preferred aspects. In a case where the polymer chain A^{1P} contains other constitutional components, an upper limit of the content of the amide substituent-containing constitutional component in the polymer chain A¹p is appropriately determined, but can be, for example, 99% by mass or less.

A content of the other constitutional components in the polymer chain A^{1P} is set within a range not impairing the effect of the present invention, but from the viewpoint of the dispersibility and the bonding property of the solid particles, it is preferably 0% to 85% by mass, more preferably 0% to 80% by mass, still more preferably 0% to 50% by mass, and particularly preferably 0% to 40% by mass. Among the other constitutional components, a content of the constitutional component having a substituent (a) described later in the polymer chain A^{1P} is appropriately determined in consideration of the above-described total content of the other constitutional components, and is, for example, preferably 0% to 70% by mass, more preferably 0% to 50% by mass, and still more preferably 2% to 40% by mass.

—Preferred Aspect of Functional Group A^{1G} or Polymer Chain A^{1P}—

The functional group A^{1G} or the polymer chain A¹p, which can be adopted as A¹, is preferably a functional group having a chemical structure represented by Formula (A1) or a polymer chain having a constitutional component represented by Formula (A1).

In a case where the functional group A^{1G} which can be adopted as A¹ is the functional group having a chemical structure represented by Formula (A1), a group bonded to one bonding portion thereof is preferably the above-described terminal group included in the above-described amide substituent. In addition, in a case where the polymer chain A^{1P} which can be adopted as A¹ is the polymer chain having a constitutional component represented by Formula (A1), the terminal group of the polymer chain is as described above.

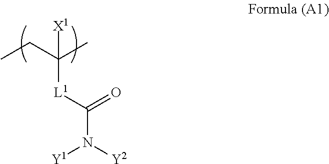

In Formula (A1), X¹ represents a hydrogen atom or a substituent. The substituent which can be adopted as X¹ is not particularly limited, and examples thereof include a group selected from the substituent Z described later; and among these, an alkyl group is preferable. X¹ is preferably a hydrogen atom or a methyl group.

L¹ represents a single bond or a linking group, and is preferably a single bond. The linking group which can be adopted as L¹ is not particularly limited, and the above-described linking group L^{A2} can be applied without particular limitation. Here, the linking group which can be adopted as L¹ does not form a urethane group, a urea group, or an imide group together with the amide group in Formula (A1).

Y¹ and Y² each represent a hydrogen atom or a substituent. The substituents which can be adopted as Y¹ and Y² are not particularly limited, one substituent is synonymous with R^{NA1} described above, and the other substituent is synonymous with the terminal group of the above-described amide substituent, where Y¹ is preferably a hydrogen atom and Y² is more preferably an alkyl group. However, the substituents which can be adopted as Y¹ and Y² do not form an imide group together with the amide group in Formula (A1). Y¹ and Y² may be the same or different from each other.

In a case where both Y¹ and Y² are alkyl groups, a preferred aspect of the alkyl group which can be adopted as Y¹ and Y² is an aspect which is synonymous with the alkyl group which can be adopted as R^{NA1} described above or as the terminal group bonded to the terminal of the amide bond; and examples thereof include methyl, ethyl, normal propyl, isopropyl, normal butyl, tertiary butyl, a linear or branched octyl group, and a linear or branched dodecyl group. A combination of the alkyl groups which can be adopted as Y¹ and Y² is not particularly limited, and the above-described alkyl groups can be appropriately combined with each other.

The functional group or the constitutional component represented by Formula (A1) may have a substituent. For example, in Formula (A1), a carbon atom bonded to a carbon atom having X¹ is represented as an unsubstituted carbon atom (methylene group; —CH₂—), but may have a substituent. Such a substituent is not particularly limited, and examples thereof include the above-described substituent which can be adopted as X¹.

In the present invention, it is preferable that the functional group A^{1G} or the polymer chain A^{1P}, which can be adopted as A¹, does not have a fluorine atom and a polysiloxane structure. In addition, the functional group A^{1G} or the polymer chain A^{1P}, which can be used as A¹, for example, the terminal group of the amide substituent, Y¹ and Y² may have a substituent, but preferably do not have the functional group (a) described later, and more preferably are unsubstituted.

Specific examples of the functional group A^{1G} or the polymer chain A^{1P}, which can be adopted as A¹, include each constitutional component of polymers in specific examples described later or polymers synthesized in Examples, and a constitutional component derived from an acrylamide compound; but the present invention is not limited thereto.

### (A² in Formula (I))

In Formula (I), A² represents a functional group A^{2G} or a polymer chain A^{2P}, including at least one of a fluorine atom or a polysiloxane structure, and it is preferably a functional group or a polymer chain, including a polysiloxane structure, and more preferably a polymer chain including a polysiloxane structure. In a case where the polymer (I) has A², the heat generation during mixing of the binder according to the embodiment of the present invention and the inorganic solid electrolyte can be suppressed, and the adsorption on the solid particles such as an active material is promoted, and as a result, the deterioration of the solid particles can be suppressed. In addition, since a surface energy of the polymer (I) is reduced, excessive condensation of the solid particles can be suppressed, and thus the dispersion state of the solid particles can be improved.

In the present invention, the functional group or the polymer chain, including a fluorine atom or a polysiloxane structure, includes both aspects of an aspect in which the functional group or the polymer chain consists of a fluorine-substituted group substituted with a fluorine atom or a polysiloxane structure and an aspect in which the functional group or the polymer chain consists of the fluorine-substituted group or the polysiloxane structure, and other partial structures.

In the present invention, the polysiloxane structure in A² refers to a structure represented by —(Si(R^{S2})—O)ₙₛ—. R^{S} represents a hydrogen atom or a substituent and the substituent is not particularly limited; and examples thereof include substituents selected from the substituent Z described later, for example, a hydroxy group, an alkyl group (preferably having 1 to 12 carbon atoms, more preferably 1 to 6 carbon atoms, and particularly preferably 1 to 3 carbon atoms), an alkenyl group (preferably having 2 to 12 carbon atoms, more preferably 2 to 6 carbon atoms, and particularly preferably 2 or 3 carbon atoms), an alkoxy group (preferably having 1 to 24 carbon atoms, more preferably 1 to 12 carbon atoms, still more preferably 1 to 6 carbon atoms, and particularly preferably 1 to 3 carbon atoms), an aryl group (preferably having 6 to 22 carbon atoms, more preferably 6 to 14 carbon atoms, and particularly preferably 6 to 10 carbon atoms), an aryloxy group (preferably having 6 to 22 carbon atoms, more preferably 6 to 14 carbon atoms, and particularly preferably 6 to 10 carbon atoms), an aralkyl group (preferably having 7 to 23 carbon atoms, more preferably 7 to 15 carbon atoms, and particularly preferably 7 to 11 carbon atoms), an alkylsilyl group, an arylsilyl group, an alkoxysilyl group, and a group represented by Formula Z described later. Among these, an alkyl group having 1 to 3 carbon atoms, a phenyl group, or a group represented by Formula Z described later is more preferable, and an alkyl group having 1 to 3 carbon atoms is still more preferable. ns represents a polymerization degree (average repetition number) of the siloxane structure, and is appropriately determined in consideration of a number-average molecular weight of the polymerized chain described later and the like, and is preferably as described later. The polysiloxane structure has a terminal group bonded to a terminal thereof. The terminal group is not particularly limited, and examples thereof include a hydrogen atom and a substituent. Examples of the substituent which can be adopted as the terminal group include the substituent which can be adopted as R^{S}.

The polysiloxane structure is preferably a polysiloxane structure represented by Formula 4A.

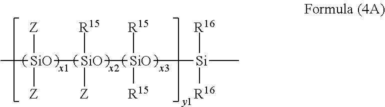

In Formula 4A, R¹⁵ and R¹⁶ represent an alkyl group or an aryl group, and Z represents a group represented by Formula (Z). R¹⁵, R¹⁶, and Z in Formula 4A are the same as R¹⁵, R¹⁶, and Z in Formula 4 described later, respectively.

In Formula 4A, x1, x2, and x3 are integers of 0 or more, and y1 is an integer of 1 to 30. x1, x2, x3, and y1 in Formula 4A are the same as x1, x2, x3, and y1 in Formula 4 described later, respectively.

The kind of the fluorine atom and the polysiloxane structure in A² may be at least one kind, and is preferably one kind or two kinds. In addition, the number of fluorine atoms and polysiloxane structures in A² is not particularly limited, and can be appropriately determined depending on the functional group or the polymer chain.

It is preferable that the functional group A^{2G} or the polymer chain A^{2P} does not have the amide substituent.

### (Functional Group A^{2G} Including at Least One of Fluorine Atom or Polysiloxane Structure)

### —Functional Group A^{2GF} Including Fluorine Atom—

A functional group A^{2GF} including a fluorine atom, which can be adopted as A², is not particularly limited, but is preferably a group including a group substituted with a fluorine atom (may be referred to as “fluorine-substituted group”) and a linking group L^{A3} which is linked to “S” (sulfur atom) in Formula (I).

The fluorine-substituted group is not particularly limited, and examples thereof include a group obtained by introducing a fluorine atom into the substituent Z described later. A group obtained by introducing a fluorine atom into an alkyl group, an aryl group, or a heterocyclic group is preferable, and a fluoroalkyl group obtained by introducing a fluorine atom into an alkyl group is preferable.

The fluoroalkyl group is a fluoroalkyl group in which at least one hydrogen atom in the alkyl group is replaced with a fluorine atom, and a molecular structure thereof may be linear, branched, or cyclic, and is preferably linear or branched. The number of carbon atoms in the fluoroalkyl group is not particularly limited, but is preferably 1 to 20, more preferably 1 to 12, and still more preferably 2 to 8. An aspect in which the lower limit of carbon atoms is 3 or more is a preferred aspect, and in a case where the fluoroalkyl group is linear, an aspect in which the lower limit of carbon atoms is 4 or more is a preferred aspect.

In the fluoroalkyl group, a part of hydrogen atoms may be replaced with fluorine atoms, or all hydrogen atoms may be replaced with fluorine atoms. In the present invention, a fluoroalkyl group in which a part of hydrogen atoms are replaced with fluorine atoms is preferable, a fluoroalkyl group in which a carbon atom bonded to the above-described linking group L^{A3} is not substituted with a fluorine atom and includes a methylene group (—CH₂—) is more preferable, and a fluoroalkyl group in which two or three continuous carbon atoms including the carbon atom bonded to the above-described linking group L^{A3} are not substituted with fluorine atoms and includes an ethylene group (—CH₂—CH₂—) or a propylene group (—CH₂—CH₂—CH₂—) is still more preferable. In the fluoroalkyl group in which a part of hydrogen atoms is replaced with a fluorine atom, it is preferable that the remaining alkyl group bonded to a carbon atom not substituted with a fluorine atom is a perfluoroalkyl group in which all hydrogen atoms are replaced with fluorine atoms.

The fluoroalkyl group may have a substituent other than the fluorine atom, for example, may have the substituent (other than the fluorine atom) which can be adopted as R^{f} described above.

The linking group L^{A3} is not particularly limited, and examples thereof include the linking group LA. Here, the linking group L^{A3} is more preferably an alkylene group, an alkenylene group, an arylene group, a carbonyl group, an oxygen atom, a sulfur atom, an imino group, or a group of a combination thereof, still more preferably a group including an alkylene group, and particularly preferably an alkylene group-CO—O— group or a group obtained by combining an alkylene group and B² of Formula 4 described later. Examples of the group obtained by combining an alkylene group and B² of Formula 4 described later include an alkylene group-CO—O-alkylene group. It is preferable that the linking group L_{A3} does not have a fluorine atom and a polysiloxane structure.

The functional group A^{2GF} including a fluorine atom is preferably a group derived from a low-molecular-weight compound, and more preferably does not have a polymer chain A^{2P} described later, which can be adopted as A². In addition, it is preferable that the functional group A^{2GF} does not have the amide substituent.

A compound from which the functional group A^{2GF} including a fluorine atom, which can be adopted as A², is derived is not particularly limited, and examples thereof include a reactive compound having a reactive group with respect to a sulfanyl group, the above-described fluorine-substituted group, and a linking group L^{A4} (where the above-described reactive group is excluded) which links these groups. The reactive group is the same as the reactive group in the compound from which the functional group A^{1G} including one kind amide substituent, which can be adopted as A¹, is derived. The linking group L^{A4} is not particularly limited, and each group described in the linking group L^{A3} above can be adopted, but a group including a —CO—O—group is still more preferable, and a —CO—O— group or a linking group described in B² of Formula 4 described later is particularly preferable.

The reactive compound from which the functional group A^{2GF} is derived is not particularly limited, and preferred examples thereof include a reactive compound having an ethylenically unsaturated bond. Examples thereof include (meth)acrylic compounds (M1) such as a (meth)acrylic acid compound, a (meth)acrylic acid ester compound, a (meth)acrylamide compound, and a (meth)acrylonitrile compound; vinyl compounds (M2) including vinyl aromatic compounds such as a styrene compound, a vinyl naphthalene compound, and a vinyl carbazole compound, allyl compounds, vinyl ether compounds, vinyl ester compounds, cyclic olefin compounds, diene compounds, and vinyl carboxylic acid ester compounds; and reactive compounds in which the above-described fluorine-substituted groups are introduced into compounds such as dialkyl itaconate compounds and unsaturated carboxylic acid anhydrides. Among these, a reactive compound obtained by introducing the above-described fluorine-substituted group into a (meth)acrylic acid compound, a (meth)acrylic acid ester compound, a (meth)acrylamide compound, or the like is preferable; a reactive compound which is a constitutional component represented by Formula 3 described later is more preferable; and a (meth)acrylic acid ester compound having the fluorine-substituted group is still more preferable.

### —Functional Group A^{2GS} Including Polysiloxane Structure—

A functional group A^{2GS} including a polysiloxane structure, which can be adopted as A², is not particularly limited, but is preferably a group including the above-described polysiloxane structure and the above-described linking group L^{A3} which is linked to “S” (sulfur atom) in Formula (I). Here, it is preferable that the linking group L^{A3} bonded to the polysiloxane structure does not have a fluorine atom and a polysiloxane structure.

The functional group A^{2GS} including a polysiloxane structure is the same as the functional group including a fluorine atom, except that the fluorine-substituted group is replaced with the polysiloxane structure. The functional group A^{2GS} is preferably a group derived from a low-molecular-weight compound, and more preferably does not have a polymer chain A^{2P} described later, which can be adopted as A². In addition, it is preferable that the functional group A^{2G}s does not have the amide substituent. A compound from which the functional group A^{2GS} including a polysiloxane structure, which can be adopted as A², is derived is the same as the compound from which the functional group A^{2GF} including a fluorine atom, which can be adopted as A², is derived, except that the fluorine-substituted group is replaced with the siloxane structure, and specific examples thereof include a compound having a group represented by Formula 4 described later.

### (Polymer Chain A^{2P} Including at Least One of Fluorine Atom or Siloxane Structure)

The polymer chain may be a polymer chain consisting of the fluorine-substituted group or the polysiloxane structure, but is preferably a polymer chain introduced into the polymer (I) by reacting with a group (for example, a sulfanyl group) which derives the sulfur atom in Formula (I). Such a polymer chain is not particularly limited and a chain consisting of a normal polymer can be applied; and for example, a chain consisting of a polymer having the above-described polymerized chain of carbon-carbon double bonds as a main chain is preferable, and a chain consisting of a vinyl polymer or a (meth)acrylic polymer is more preferable. Here, it is preferable that the polymer chain A^{2P} which can be adopted as A² does not have the amide substituent.

In the polymer chain A^{2P} which can be adopted as A², the fluorine atom and the polysiloxane structure may be included in the main chain of the polymer chain A^{2P} or the terminal of the main chain, but is preferably included in a molecular chain which is a side chain, and for example, more preferably incorporated into an inside or a terminal of the molecular chain which is the side chain of the polymer chain.

Examples of the polymer chain A^{2P} include a polymer chain having a constitutional component including at least one of the fluorine atom or the polysiloxane structure. The polymer chain A^{2P} preferably has a constitutional component including any of the fluorine atom or the polysiloxane structure, and more preferably has a constitutional component including the polysiloxane structure. The constitutional component including the fluorine atom is preferably a constitutional component including the above-described fluorine-substituted group. The constitutional component including the polysiloxane structure is preferably a constitutional component including the above-described siloxane structure.

Examples of the polymer chain A^{2P} include a chain consisting of a homopolymer or a copolymer of the reactive compound from which the functional group A^{2G} is derived. Among the chains consisting of the homopolymer or the copolymer of the reactive compound, the polymer chain A^{2P} is preferably a polymer chain including a constitutional component derived from at least one reactive compound selected from the above-described (meth)acrylic compounds (M1) (referred to as a chain consisting of a (meth)acrylic polymer), more preferably a polymer chain including a constitutional component derived from at least one reactive compound selected from a (meth)acrylic acid or a (meth)acrylic acid ester compound, and still more preferably a polymer chain of a (meth)acrylic acid ester compound having a fluorine-substituted group or a polysiloxane structure. Preferred examples of the constitutional component derived from the (meth)acrylic acid ester compound having a fluorine-substituted group or a polysiloxane structure include a constitutional component represented by Formula 3 or Formula 4 described later.

The polymer chain may have a constitutional component (referred to as other constitutional components) other than the constitutional component including at least one of a fluorine atom or a polysiloxane structure. The other constitutional components are not particularly limited as long as they are constitutional components not having a fluorine atom and a polysiloxane structure, and for example, are not particularly limited as long as they are constitutional components derived from a polymerizable compound which can be copolymerized with the reactive compound from which the constitutional component including at least one of a fluorine atom or a polysiloxane structure is derived. Examples of the other constitutional components include constitutional components derived from a low-molecular-weight polymerizable compound having an ethylenically unsaturated group, and more specific examples thereof include constitutional components derived from each of the above-described compounds exemplified as the reactive compound (before the introduction of the fluorine-substituented group and the polysiloxane structure), and compounds obtained by introducing a functional group (a) described later into the compound. Among these, constitutional components derived from a reactive compound selected from a (meth)acrylic acid compound, a (meth)acrylic acid ester compound, a (meth)acrylamide compound, or a (meth)acrylonitrile compound, or constitutional components derived from a compound obtained by introducing the functional group (a) described later into a (meth)acrylic acid ester compound are preferable. The (meth)acrylic acid ester compound is as described in the polymer chain A^{1P}.

In a case where the polymer chain A^{2P} contains the other constitutional components, a primary structure (bonding mode of the constitutional components) of the polymer chain A^{2P} is not particularly limited; and any bonding mode such as a random structure, a block structure, an alternating structure, and a graft structure can be adopted, but a random structure or a block structure is preferable.

The group bonded to the terminal of the polymer chain A^{2P} is not particularly limited, and an appropriate group can be adopted depending on the polymerization method or the like as described above.

A weight-average molecular weight Mw^{2P} of the polymer chain A^{2P} is not particularly limited, and is appropriately set in consideration of the weight-average molecular weight of the polymer (I) described later, and is, for example, preferably 100 to 30,000 and more preferably 400 to 10,000. In addition, a polymerization degree of all constitutional components in the polymer chain A^{2P} is not particularly limited, and is preferably 1 to 200 and more preferably 1 to 50.

Here, in a case where the polymer chain A^{2P} is a polymer chain including a polymerized chain of a polysiloxane structure, a polymerization degree of all structural units forming the polymerized chain is not particularly limited, and is preferably 2 to 1,000, more preferably 2 to 200, and still more preferably 6 to 80. A number-average molecular weight of the above-described polymerized chain is not particularly limited, and is preferably 400 or more, more preferably 800 or more, and still more preferably 2,000 or more. The upper limit thereof is not particularly limited, and is preferably 500,000 or less, more preferably 100,000 or less, and still more preferably 30,000 or less. The number-average molecular weight of the polymerized chain can be measured as a standard polystyrene-equivalent number-average molecular weight in the same manner as the weight-average molecular weight of the polymer (I).

A content of the constitutional component including at least one of a fluorine atom or a polysiloxane structure in the polymer chain A^{2P} is not particularly limited, but is preferably 10% by mass or more, and from the viewpoint of the dispersion state of the solid particles and the resistance, preferably 20% by mass or more, more preferably 30% by mass or more, still more preferably 50% by mass or more, and one of preferred aspects is also a case in which the content is 100% by mass.

The total content of the other constitutional components in the polymer chain A^{2P} is set within a range not impairing the effect of the present invention, but from the viewpoint of the dispersibility and the bonding property of the solid particles, it is preferably 0% to 90% by mass, more preferably 0% to 70% by mass, and still more preferably 0% to 50% by mass. Among the other constitutional components, a content of the constitutional component having the substituent (a) described later in the polymer chain A^{2P} is appropriately determined in consideration of the above-described total content of the other constitutional components, and is, for example, preferably 0% to 70% by mass, more preferably 0% to 50% by mass, and still more preferably 0% to 30% by mass.

—Preferred Aspect of Functional Group A^{2G} or Polymer Chain A^{2P}—

The functional group A^{2GF} including a fluorine atom or the polymer chain A^{2PF}, which can be adopted as A², is preferably a functional group having a chemical structure represented by Formula 3 or a polymer chain having a constitutional component represented by Formula 3.

In a case where the functional group A²GF including a fluorine atom, which can be adopted as A², is the functional group having a chemical structure represented by Formula 3, a group bonded to one bonding portion thereof is preferably the terminal group included in the above-described fluorine-substituted group. In addition, in a case where the polymer chain A^{2PF} which can be adopted as A² is the polymer chain having a constitutional component represented by Formula 3, the terminal group of the polymer chain is as described above.

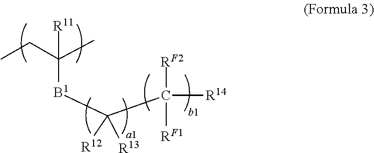

In Formula 3, R¹¹ represents a hydrogen atom or methyl.

B¹ represents a single bond or a linking group, preferably a linking group. The linking group which can be adopted as B¹ is not particularly limited, and examples thereof include the linking groups which can be adopted as the linking group L^{A4} described above. Among these, an ether group, a sulfide group, an imino group, a carbonyl group, or a linking group of a combination of two or more (preferably 2 to 5) thereof is preferable, and a —CO—O— group is more preferable.

R¹² and R¹³ each represent a hydrogen atom, a hydroxy group or an alkyl group having 1 to 4 carbon atoms (which may have a fluorine atom as a substituent; but preferably does not have a substituent), and preferably represent a hydrogen atom or a hydroxy group. R¹² and R¹³ may be the same or different from each other.

R¹⁴ represents a hydrogen atom or a fluorine atom.

R^{F1} and R^{F2} each represent a fluorine atom or a fluoroalkyl group having 1 to 4 carbon atoms. In the fluoroalkyl group which can be adopted as R^{F1} and R^{F2}, a part of hydrogen atoms may be replaced with fluorine atoms, and a perfluoroalkyl group is preferable. The number of carbon atoms in the fluoroalkyl group is preferably 1 or 2 and more preferably 1. R^{F1} and R^{F2} each preferably represent a fluorine atom or trifluoromethyl and more preferably represent a fluorine atom. R^{F1} and R^{F2} may be the same or different from each other, and it is preferable that both represent a fluorine atom.

a1 is not particularly limited as long as it represents an integer of 0 or more, and preferably represents an integer of 0 to 10, more preferably represents an integer of 1 to 5, and still more preferably represents an integer of 1 to 3.

b1 is not particularly limited as long as it represents an integer of 1 or more, and preferably represents an integer of 1 to 20, more preferably represents an integer of 1 to 10, and still more preferably represents an integer of 2 to 6.

In Formula 3, the total of a1 and b1 is not particularly limited as long as a1 and b1 are within the above-described ranges, and is, for example, the same as the number of carbon atoms in the fluoroalkyl group as the above-described fluorine-substituted group, and the same applies to the preferred range thereof.

In a case where a1 and b1 each represent an integer of 2 or more, a plurality of —C(R¹²)(R¹³)— groups or —C(R^{F1})(R^{F2})— groups in Formula 3 may be the same or different from each other, respectively.

Specific examples of the functional group or the constitutional component represented by Formula 3 include those shown in the specific examples of the polymer described later or each polymer synthesized in Examples described later, but the present invention is not limited thereto.

A^{2GS} including a polysiloxane structure or the polymer chain A^{2PS}, which can be adopted as A², is preferably a functional group having a chemical structure represented by Formula 4 or a polymer chain having a constitutional component represented by Formula 4.

In a case where the functional group A^{2GS} including a polysiloxane structure, which can be adopted as A², is the functional group having a chemical structure represented by Formula 4, a group bonded to one bonding portion thereof is preferably the terminal group included in the above-described fluorine-substituted group. In addition, in a case where the polymer chain A^{2P}S which can be adopted as A² is the polymer chain having a constitutional component represented by Formula 4, the terminal group of the polymer chain is as described above.

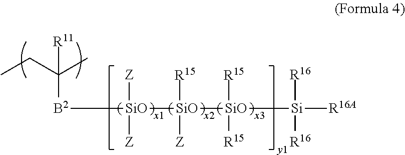

In Formula 4, R¹¹ represents a hydrogen atom or methyl.

B² represents a linking group. The linking group which can be adopted as B² is not particularly limited, and examples thereof include the linking groups which can be adopted as the linking group L^{A1} described above. Among these, the linking group as B² is preferably an alkylene group, an alkenylene group, an arylene group, an oxygen atom, a sulfur atom, a carbonyl group, or a group of a combination thereof, more preferably a group including a —CO—O-group, and still more preferably a —CO—O-group or a —CO—O-alkylene group.

R¹⁵ represents an alkyl group or an aryl group, preferably an alkyl group. The alkyl group and the aryl group, which can be adopted as R¹⁵, have the same definitions and the same preferred ranges as those of the alkyl group and the aryl group which can be adopted as R^{S} in the above-described polysiloxane structure, respectively. Here, R¹⁵ particularly preferably represents methyl. Two R¹⁵'s bonded to the same silicon atom may be the same or different from each other, and preferably represent methyl.

R¹⁶ represents an alkyl group or an aryl group, preferably an alkyl group. Two R¹⁶'s bonded to the same silicon atom may be the same or different from each other. The alkyl group and the aryl group, which can be adopted as R¹⁶, have the same definitions and the same preferred ranges as those of the alkyl group and the aryl group which can be adopted as R^{S} in the above-described polysiloxane structure, respectively. Here, R¹⁶ particularly preferably represents methyl.

R^{16A} represents a hydrogen atom or a substituent. The substituent which can be adopted as R^{16A} is not particularly limited, and examples thereof include the substituent Z described later; and a substituent which can be adopted as R^{S} described above is preferable. Here, the substituent which can be adopted as R^{16A} is more preferably an alkyl group, an alkenyl group, an aralkyl group, an aryl group, an alkoxy group, or an aryloxy group, and still more preferably an alkyl group or the like.

Z represents a group represented by Formula (Z).

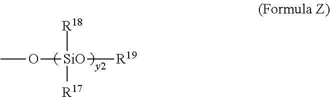

In Formula (Z), R¹⁷ and R¹⁸ each represent an alkyl group or an aryl group. The alkyl group and the aryl group, which can be adopted as R¹⁷ and R¹⁸, have the same definitions and the same preferred ranges as those of the alkyl group and the aryl group which can be adopted as R^{S} in the above-described polysiloxane structure, respectively. R¹⁷ and R¹⁸ may be the same or different from each other. R¹⁹ represents an unsubstituted alkyl group having 1 to 4 carbon atoms. y2 represents an integer of 1 to 100, preferably an integer of 1 to 50 and more preferably an integer of 1 to 20.

In the constitutional component represented by Formula 4, x1, x2, x3, y1, and y2 are appropriately determined, the total of x1, x2, x3, y1, and y2 (polymerization degree) is the same as the polymerization degree in the polymerized chain of the polysiloxane structure described above, and it is particularly preferable that a value of (x1+x2+x3)×y1 is the same as the polymerization degree in the polymerized chain of the polysiloxane structure described above.

In Formula 4, x1, x2, and x3 each represent an integer of 0 or more.
x1 is preferably an integer of 0 to 50 and more preferably an integer of 0 to 20.
x2 is preferably an integer of 0 to 50 and more preferably an integer of 0 to 20.
x3 is preferably an integer of 1 to 100 and more preferably an integer of 1 to 30.

The sum of x1, x2, and x3 is an integer of 1 to 100, preferably an integer of 2 to 70 and more preferably an integer of 2 to 50.

In a case where x1 and x3 each represent an integer of 2 or more, two Z's or R¹⁵'s bonded to the same silicon atom in Formula 4 may be the same or different from each other.
y1 represents an integer of 1 to 30, preferably an integer of 1 to 20 and more preferably an integer of 1 to 10.
x1, x2, x3, y1, and y2 are preferably x1=x2=y2=0, x3=integer of 1 to 100, and y1=integer of 1 to 30.

Specific examples of the functional group or the constitutional component represented by Formula 4 include a terminal (meth)acrylic-modified silicone compound, specifically, those shown in the specific examples of the polymer described later or each polymer synthesized in Examples described later, but the present invention is not limited thereto.

In the polymer represented by Formula (I), a combination of A¹ and A² is not particularly limited, and an appropriate combination of the functional group A^{1G} or the polymer chain A¹p, which can be adopted as A¹, and the functional group A^{2G} or the polymer chain A^{2P}, which can be adopted as A², can be used. As the combination of A¹ and A², a combination of the suitable functional group A^{1P} or polymer chain A¹p, which can be adopted as A¹, and the suitable functional group A^{2G} or polymer chain A^{2P}, which can be adopted as A², is preferable, and a combination of the suitable polymer chain A^{1P} which can be adopted as A¹ and the suitable polymer chain A^{2P} which can be adopted as A² is more preferable; and examples thereof include combinations in the polymers shown in Examples.

The polymer (I) may have a substituent. The substituent which may be included is not particularly limited, and examples thereof include the substituent Z described later, and a group other than an acidic group among the following substituents (a) is preferable from the viewpoint of adsorption on the solid particles and the like.

In the present invention, the polymer (I) may have an acidic group in the following substituent (a) as long as the acid value satisfies 3 mgKOH/g or less. However, from the viewpoint of being able to suppress the acid value to be low, the dispersion state of solid particles, and the resistance, it is also preferable that the polymer (I) does not have the acidic group in the following substituent (a), and from the viewpoint of being able to suppress the acid value and the base value to be low, it is also preferable that the polymer (I) does not have any of the following substituents (a).

—Substituent (a)—

An acidic group, a group having a basic nitrogen atom, a urea group, a urethane group, an alkoxysilyl group, an epoxy group, an isocyanate group, or a hydroxyl group

The acidic group is not particularly limited, and examples thereof include a carboxylic acid group (carboxy group), a sulfonic acid group (sulfo group), a phosphoric acid group (also referred to as a phospho group or a phosphoryl group), a phosphonic acid group, and a phosphinic acid group (phosphinyl group). The sulfonic acid group, the phosphoric acid group, the phosphonic acid group, and the like are not particularly limited, and are synonymous with corresponding groups of the substituent Z described later. The group which can form a salt, such as the acidic group, may form a salt. Examples of the salt include salts of various metal salts and a salt of ammonium or amine.

Examples of the group having a basic nitrogen atom include an amino group, a pyridyl group, an imino group, and an amidine. The amino group is synonymous with the amino group of the substituent Z described later.

Preferred examples of the urea group include —NR^{A1}CONR^{A2}R^{A3} (here, R^{A1}, R^{A2}, and R^{A3} represent a hydrogen atom, an alkyl group having 1 to 20 carbon atoms, an aryl group, or an aralkyl group). As the urea group, —NR^{A1}CONHR^{A3} (here, R^{A1} and R^{A3} represent a hydrogen atom, an alkyl group having 1 to 10 carbon atoms, an aryl group, or an aralkyl group) is more preferable, and —NHCONHR^{A3} (here, R^{A3} represents a hydrogen atom, an alkyl group having 1 to 10 carbon atoms, an aryl group, or an aralkyl group) is particularly preferable.

Preferred examples of the urethane group include a group including at least an imino group and a carbonyl group, such as —NHCOR^{A4}, —NR^{A5}COOR^{A6}, —OCONHR^{A7}, and —OCONR^{A8}R^{A9} (here, R^{A4}, R^{A5}, R^{A6}, R^{A7}, R^{A8}, and R^{A9} represent an alkyl group having 1 to 20 carbon atoms, an aryl group, or an aralkyl group). As the urethane group, —NHCOOR^{A4} or —OCONHR^{A7} (here, R^{A4} and R^{A7} represent an alkyl group having 1 to 20 carbon atoms, an aryl group, or an aralkyl group) is more preferable, and —NHCOOR^{A4} or —OCONHR^{A7} (here, R^{A4} and R^{A7} represent an alkyl group having 1 to 10 carbon atoms, an aryl group, or an aralkyl group) is particularly preferable.

The number of carbon atoms in the aryl group which can be adopted as R^{A1} to R^{A8} is preferably 6 or more and is preferably 24 or less. The number of carbon atoms in the aralkyl group which can be adopted as R^{A1} to R^{A8} is preferably 7 or more and is preferably 23 or less and more preferably 10 or less.

The alkoxysilyl group is not particularly limited, and examples thereof include a mono-, di-, or, tri-alkoxysilyl group; and an alkoxysilyl group having 1 to 20 carbon atoms is preferable, and an alkoxysilyl group having 1 to 6 carbon atoms is more preferable. Examples thereof include methoxysilyl, ethoxysilyl, tert-butoxysilyl, cyclohexylsilyl, dimethoxysilyl, trimethoxysilyl, and triethoxysilyl.

### —Substituent Z—

Examples of the substitutent Z include an alkyl group (preferably an alkyl group having 1 to 20 carbon atoms; for example, methyl, ethyl, isopropyl, tert-butyl, pentyl, heptyl, 1-ethylpentyl, benzyl, 2-ethoxyethyl, 1-carboxymethyl, and the like); an alkenyl group (preferably an alkenyl group having 2 to 20 carbon atoms; for example, vinyl, allyl, oleyl, and the like); an alkynyl group (preferably an alkynyl group having 2 to 20 carbon atoms, for example, ethynyl, adynyl, phenylethynyl, and the like); a cycloalkyl group (preferably a cycloalkyl group having 3 to 20 carbon atoms; for example, cyclopropyl, cyclopentyl, cyclohexyl, 4-methylcyclohexyl, and the like; in the present invention, the alkyl group generally has a meaning including a cycloalkyl group in a case of being referred to, however, it will be described separately here); an aryl group (preferably an aryl group having 6 to 26 carbon atoms; for example, phenyl, 1-naphthyl, 4-methoxyphenyl, 2-chlorophenyl, 3-methylphenyl, and the like); an aralkyl group (preferably an aralkyl group having 7 to 23 carbon atoms; for example, benzyl, phenethyl, and the like); a heterocyclic group (preferably a heterocyclic group having 2 to 20 carbon atoms and more preferably a 5- or 6-membered heterocyclic group having at least one oxygen atom, one sulfur atom, or one nitrogen atom; the heterocyclic group includes an aromatic heterocyclic group and an aliphatic heterocyclic group; for example, a tetrahydropyran ring group, a tetrahydrofuran ring group, 2-pyridyl, 4-pyridyl, 2-imidazolyl, 2-benzimidazolyl, 2-thiazolyl, 2-oxazolyl, a pyrrolidone group, and the like); an alkoxy group (preferably an alkoxy group having 1 to 20 carbon atoms; for example, methoxy, ethoxy, isopropyloxy, benzyloxy, and the like); an aryloxy group (preferably an aryloxy group having 6 to 26 carbon atoms; for example, phenoxy, 1-naphthyloxy, 3-methylphenoxy, 4-methoxyphenoxy, and the like); a heterocyclic oxy group (a group in which an —O— group is bonded to the heterocyclic group); an alkoxycarbonyl group (preferably an alkoxycarbonyl group having 2 to 20 carbon atoms; for example, ethoxycarbonyl, 2-ethylhexyloxycarbonyl, dodecyloxycarbonyl, and the like); an aryloxycarbonyl group (preferably an aryloxycarbonyl group having 7 to 26 carbon atoms; for example, phenoxycarbonyl, 1-naphthyloxycarbonyl, 3-methylphenoxycarbonyl, 4-methoxyphenoxycarbonyl, and the like); a heterocyclic oxycarbonyl group (a group in which an —O—CO— group is bonded to the heterocyclic group); an amino group (preferably an amino group having 0 to 20 carbon atoms; including an alkylamino group and an arylamino group; for example, amino (—NH₂), N,N-dimethylamino, N,N-diethylamino, N-ethylamino, anilino, and the like); a sulfamoyl group (preferably a sulfamoyl group having 0 to 20 carbon atoms; for example, N,N-dimethylsulfamoyl, N-phenylsulfamoyl, and the like); an acyl group (including an alkylcarbonyl group, an alkenylcarbonyl group, an alkynylcarbonyl group, an arylcarbonyl group, and a heterocyclic carbonyl group; preferably an acyl group having 1 to 20 carbon atoms; for example, acetyl, propionyl, butyryl, octanoyl, hexadecanoyl, acryloyl, methacryloyl, crotonoyl, benzoyl, naphthoyl, nicotinoyl, and the like); an acyloxy group (including an alkylcarbonyloxy group, an alkenylcarbonyloxy group, an alkynylcarbonyloxy group, and a heterocyclic carbonyloxy group; preferably an acyloxy group having 1 to 20 carbon atoms; for example, acetyloxy, propionyloxy, butyryloxy, octanoyloxy, hexadecanoyloxy, acryloyloxy, methacryloyloxy, crotonyloxy, nicotinoyloxy, and the like); an aryloyloxy group (preferably an aryloyloxy group having 7 to 23 carbon atoms; for example, benzoyloxy, naphthoyloxy, and the like);
a carbamoyl group (preferably a carbamoyl group having 1 to 20 carbon atoms; for example, N,N-dimethylcarbamoyl, N-phenylcarbamoyl, and the like); an acylamino groups (preferably an acylamino group having 1 to 20 carbon atoms; for example, acetylamino, benzoylamino, and the like); an alkylthio group (preferably an alkylthio group having 1 to 20 carbon atoms; for example, methylthio, ethylthio, isopropylthio, benzylthio, and the like); an arylthio group (preferably an arylthio group having 6 to 26 carbon atoms; for example, phenylthio, 1-naphthylthio, 3-methylphenylthio, 4-methoxyphenylthio, and the like); a heterocyclic thio groups (a group in which an —S— group is bonded to the heterocyclic group); an alkylsulfonyl group (preferably an alkylsulfonyl group having 1 to 20 carbon atoms; for example, methyl sulfonyl, ethyl sulfonyl, and the like); an arylsulfonyl group (preferably an arylsulfonyl group having 6 to 22 carbon atoms; for example, benzenesulfonyl and the like); an alkylsilyl group (preferably an alkylsilyl group having 1 to 20 carbon atoms; for example, monomethylsilyl, dimethylsilyl, trimethylsilyl, triethylsilyl, and the like); an arylsilyl group (preferably an arylsilyl group having 6 to 42 carbon atoms; for example, triphenylsilyl and the like); an alkoxysilyl group (preferably an alkoxysilyl group having 1 to 20 carbon atoms; for example, monomethoxysilyl, dimethoxysilyl, trimethoxysilyl, triethoxysilyl, and the like); an aryloxysilyl groups (preferably an aryloxysilyl group having 6 to 42 carbon atoms; for example, triphenyloxysilyl and the like); a phosphoryl group (preferably a phosphate group having 0 to 20 carbon atoms; for example, —OP(═O)(R^{P})₂); a phosphonyl group (preferably a phosphonyl group having 0 to 20 carbon atoms; for example, —P(═O)(R^{P})₂), a phosphinyl group (preferably a phosphinyl group having 0 to 20 carbon atoms; for example, —P(R^{P})₂), a phosphonic acid group (preferably a phosphonic acid group having 0 to 20 carbon atoms; for example, —PO(ORP)₂); a sulfo group (sulfonic acid group), a carboxy group, a hydroxy group, a sulfanyl group, a cyano group, and a halogen atom (for example, a fluorine atom, a chlorine atom, a bromine atom, an iodine atom, and the like). R^{P} is a hydrogen atom or a substituent (preferably, a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like described above may be cyclic or chain-like, and may be linear or branched.

### (m and n in Formula (I))

In Formula (I), m represents the number of A²-S-groups, and is an integer of 1 to 9, preferably an integer of 2 to 5 and more preferably an integer of 3 to 5.

n represents the number of A¹-S-groups, and is an integer of 1 to 8, preferably an integer of 1 to 4, more preferably an integer of 1 to 3, and still more preferably 1 or 2. Here, in a case where A¹ has two or three of (A-1) to (A-3) described above, each number of the (A-1)-S-groups (HS-groups), the (A-2)-S-groups, and the (A-3)-S-groups is not particularly limited as long as it satisfies the value which can be adopted as n, and can be appropriately determined. For example, each of the number of (A-1)-S-groups and the number of (A-3)-S-groups can be set to be the same as n1 and n2 in Formula (IA) described later.

Here, m+n represents an integer of 2 to 10, preferably an integer of 3 to 8, more preferably an integer of 3 to 6, and still more preferably an integer of 4 to 6.

A content of R¹ in the polymer (I) is not particularly limited, but can be set to 1 to 90% by mass in total with “S” in the polymer (I), and is preferably 2 to 60% by mass, more preferably 3 to 40% by mass, and still more preferably 5 to 30% by mass from the viewpoint of the dispersion state of the solid particles and the resistance.

The total content of A¹ in the polymer (I) is not particularly limited, but can be set to 1 to 90% by mass. The lower limit value of the above-described total content is preferably 3% by mass or more, more preferably 5% by mass or more, and still more preferably 8% by mass or more from the viewpoint of the dispersion state of the solid particles and the resistance. The upper limit value of the above-described total content is preferably 50% by mass or less, more preferably 40% by mass or less, and still more preferably 30% by mass or less from the viewpoint of the dispersion state of the solid particles and the resistance.

Here, in a case where A¹ is the hydrogen atom of (A-1), the content of A¹ is small in consideration of the weight-average molecular weight of the polymer (I), and thus is not included in the “total content of A¹”. That is, the “total content of A¹” is synonymous with the total content of A¹ in the polymer (I) in a case where A¹ is (A-2) or (A-3). In the present invention, the total content of A¹ in the polymer (I) in a case where A¹ is the hydrogen atom of (A-1) is not particularly limited, but is a small value, and thus is specified by, for example, n of Formula (I), n2 of Formula (IA), or the like.

The total content of A² in the polymer (I) is not particularly limited, but can be set to 1 to 98% by mass, and is preferably 10 to 90% by mass, more preferably 20 to 80% by mass, and still more preferably 30 to 70% by mass from the viewpoint of the dispersion state of the solid particles and the resistance.

In the polymer (I), a ratio [Total content of A²/Total content of A¹] of the total content of A² to the total content of A¹ is not particularly limited, and can be, for example, 0.01 to 99, and is preferably 0.1 to 80, more preferably 1 to 50, still more preferably 2 to 30, and particularly preferably 5 to 20 from the viewpoint of the dispersion state of the solid particles and the resistance.

A polymer represented by Formula (IA) is also one of preferred aspects of the polymer represented by Formula (I).

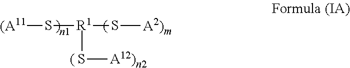

In Formula (IA), R¹ is an (m+n1+n2)-valent linking group, and is the same as R¹ in Formula (I) described above.

In Formula (IA), A¹¹ represents a functional group or a polymer chain, including at least one of an amide group, a sulfonamide group, or an imide group, and is the same as (A-2) or (A-3) which can be adopted as A¹ in Formula (I) described above. From the viewpoint of suppressing the deterioration of the solid particles, A¹¹ preferably includes a polymer chain including at least one of an amide group, a sulfonamide group, or an imide group, and more preferably includes a polymer chain including an amide group. In Formula (IA), A¹² represents a hydrogen atom.

In Formula (IA), A² represents a functional group or a polymer chain, including at least one of a fluorine atom or a polysiloxane structure, and is the same as A² in Formula (I).

In Formula (IA), m represents the number of A²-S-groups, and is the same as m in Formula (I). n1 represents the number of A¹¹-S-groups, and is an integer of 0 to 8, where the upper limit can be any of 2 to 4 and the lower limit can be any of 0 to 2. n2 represents the number of A¹²-S-groups, and is an integer of 0 to 8, where the upper limit can be any of 2 to 4 and the lower limit can be 1 or 2. Here, the total number (n1+n2) of n1 and n2 is an integer of 1 to 8, and is the same as n in Formula (I). In addition, the total number (m+n1+n2) of m, n1, and n2 is an integer of 2 to 10, and is the same as m+n in Formula (I).

Specific examples of the polymer represented by Formula (I) or Formula (IA) include specific examples of polymers shown below or polymers synthesized in Examples described later, but the present invention is not limited thereto.

In the following polymers, TMS represents a trimethylsilyl group, X¹ represents a linking group, and X² represents a substituent.

In the following chemical formulae, bonding positions of A¹ (including SH) and A² are specified to show the overall structure of each polymer, but the bonding positions of A¹ and A² are not limited to the positions specified in the following chemical formulae as long as the number (n and m) of A¹ and A² are the same. For example, in the polymer 1, both A¹'s represent a chemical structure bonded to the left structural portion with respect to the central oxygen atom, but one A¹ may be bonded to the right structural portion with respect to the central oxygen atom.

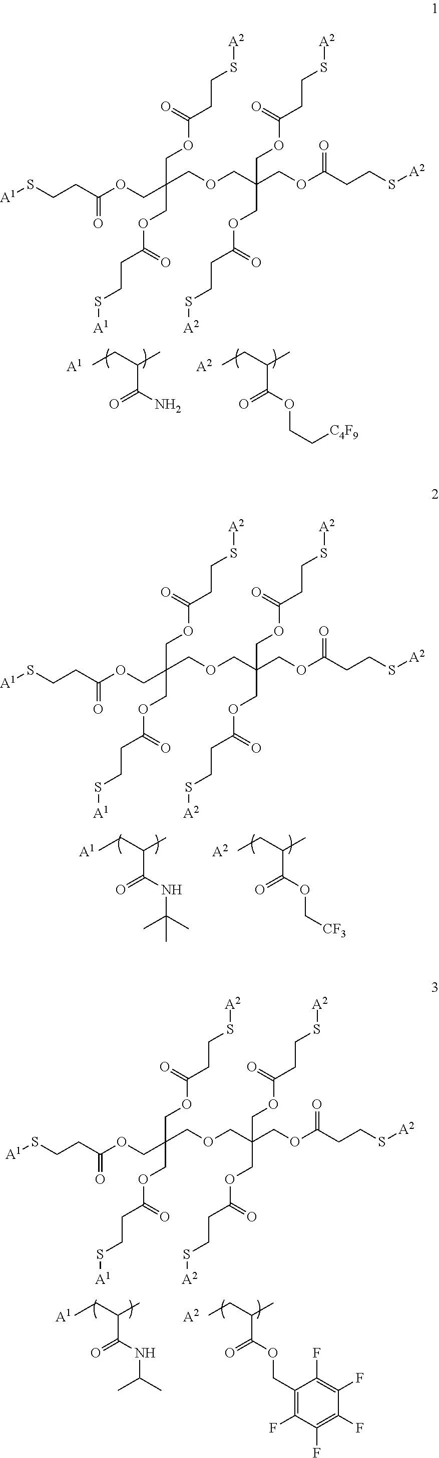

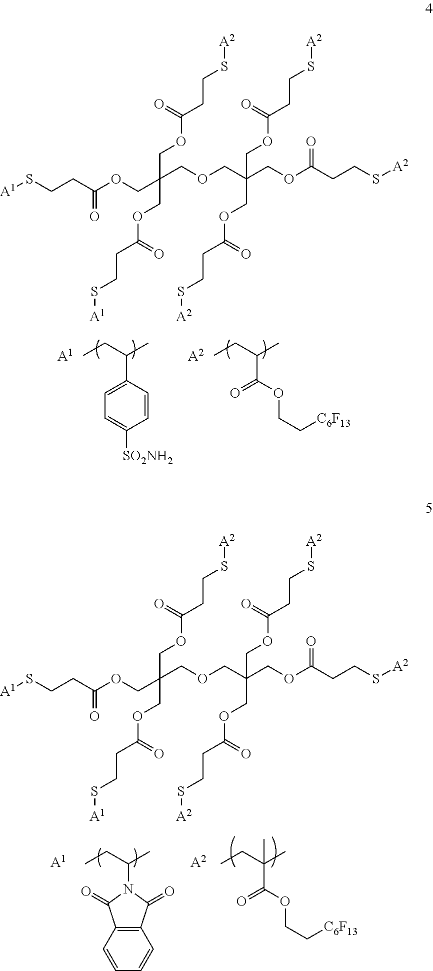

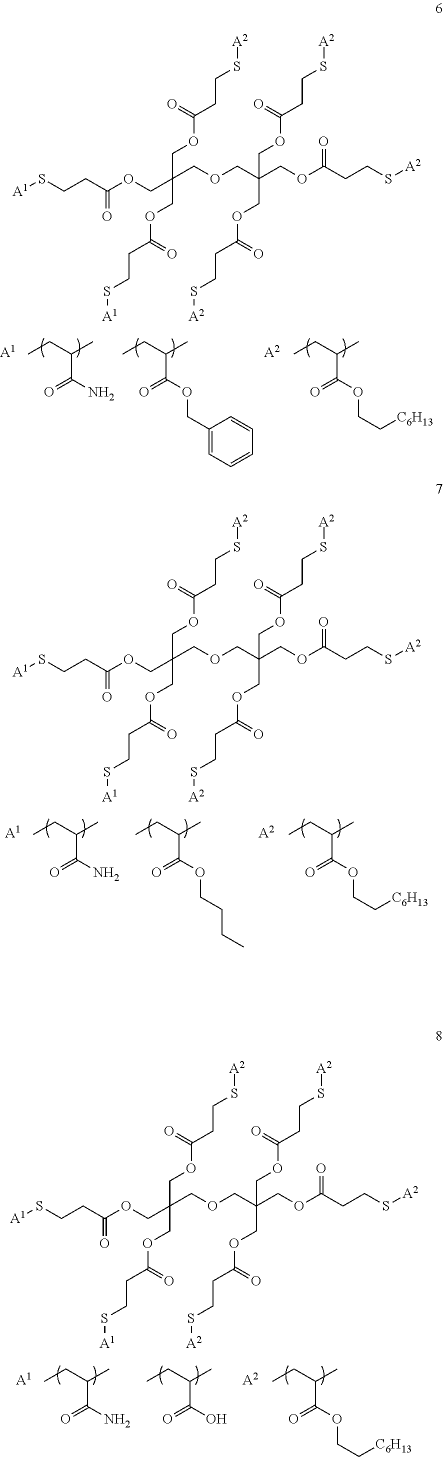

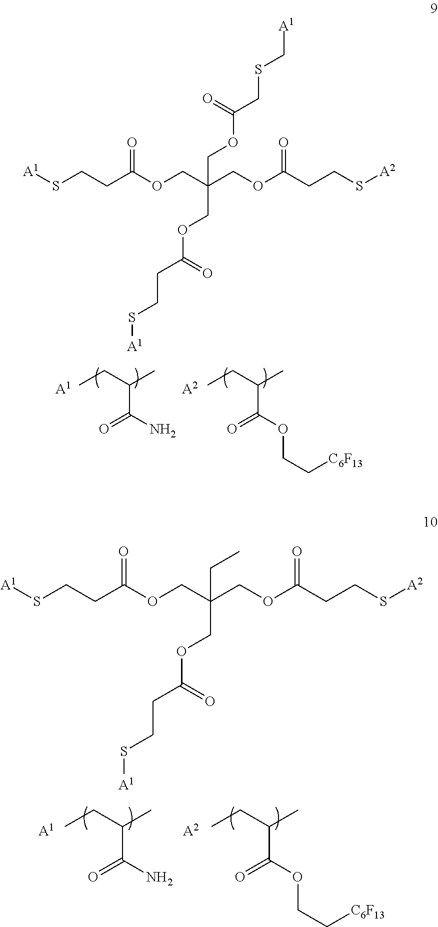

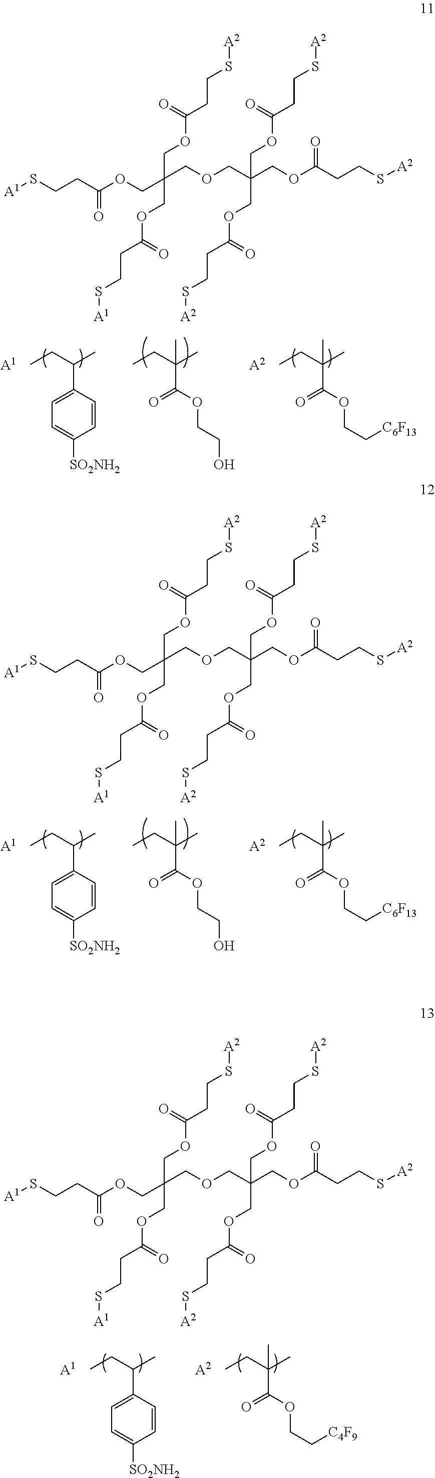

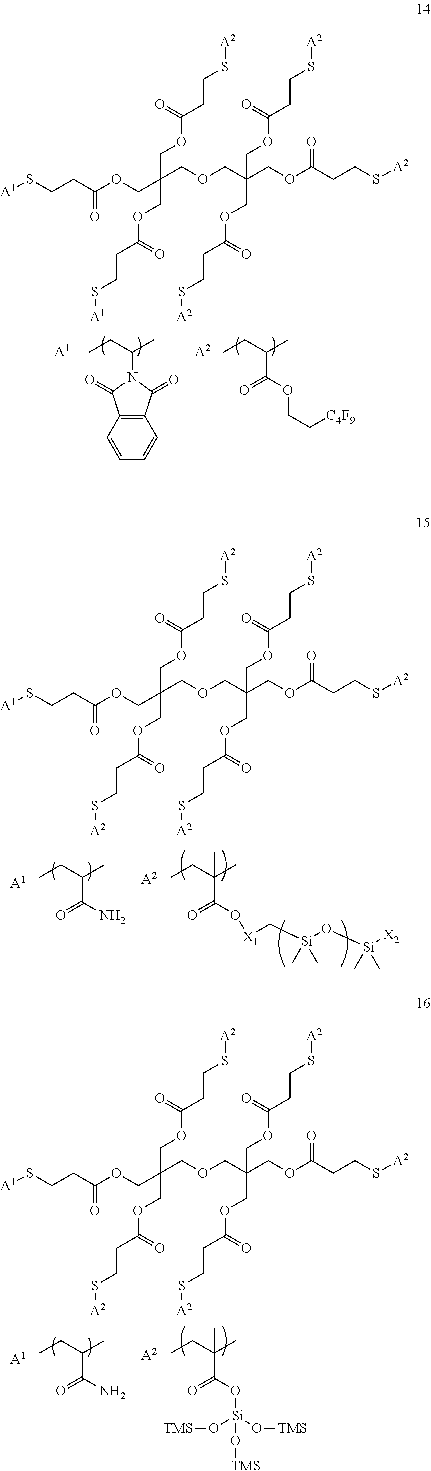

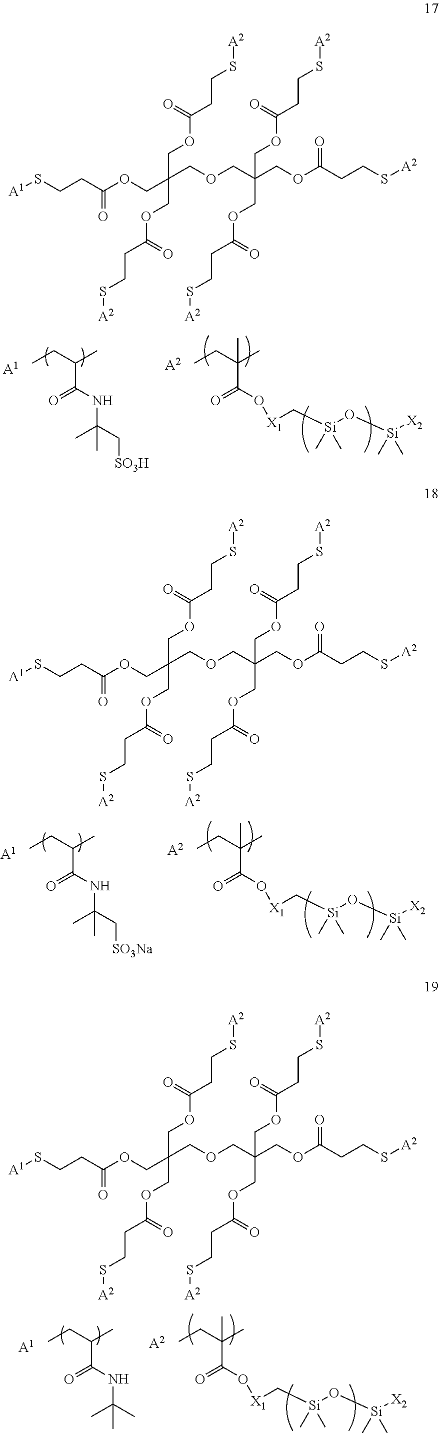

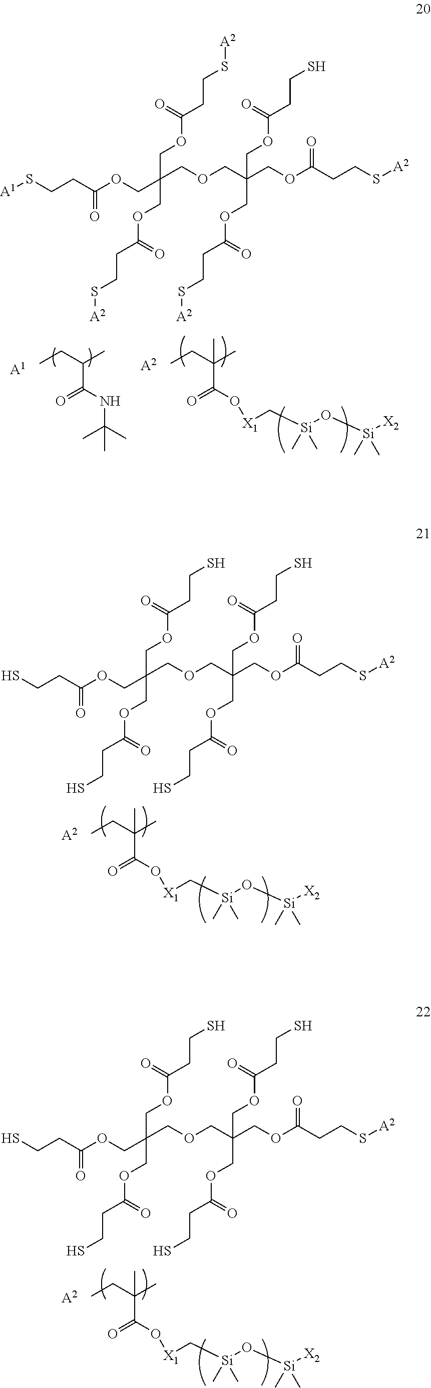

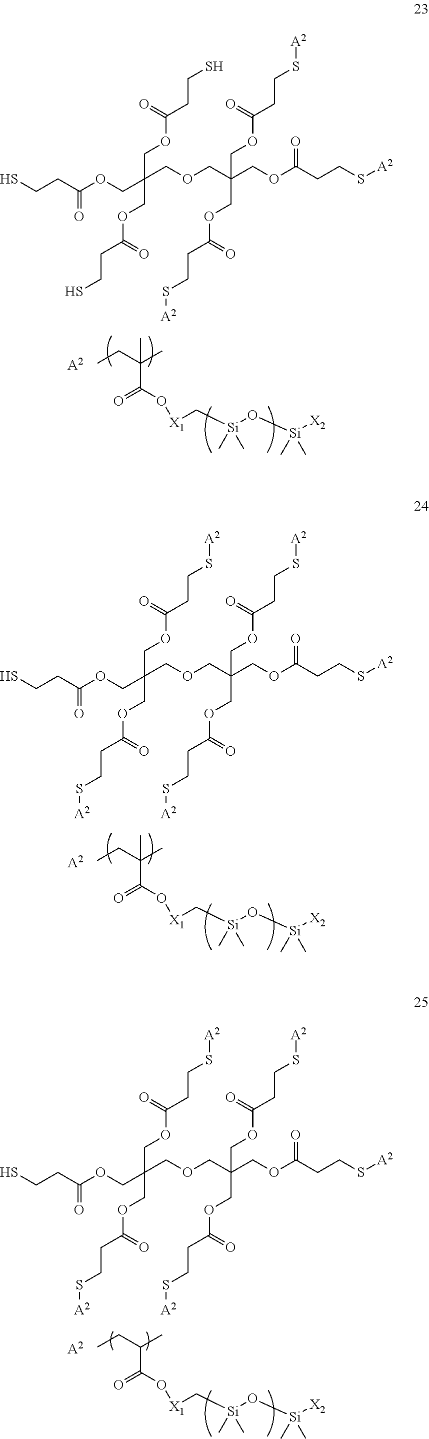

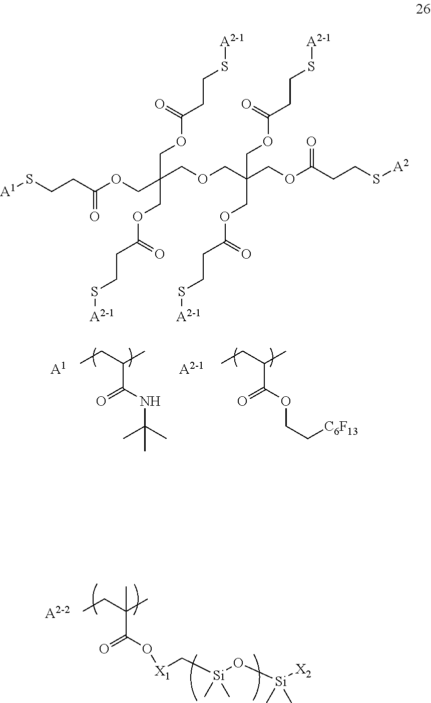

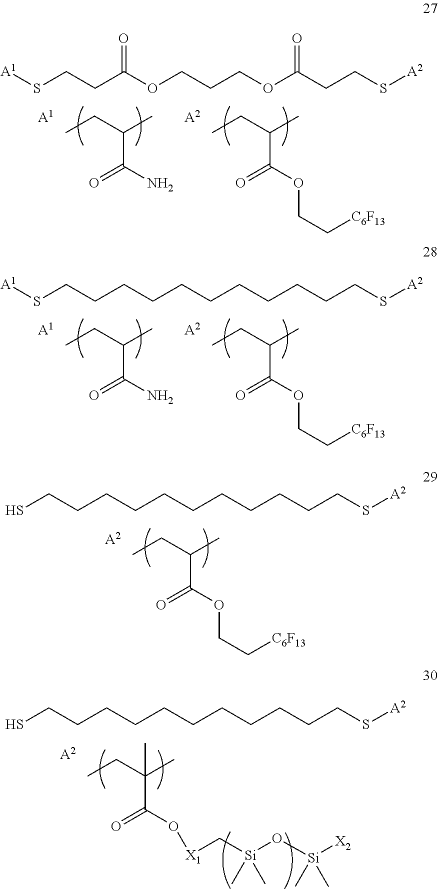

As the polymer (I) (in the present invention, the polymer represented by Formula (IA), which is one of preferred aspects, is included), a commercially available product can be used, and a synthesized product can also be used. The polymer (I) can be synthesized by selecting a raw material compound by a known method. For example, the polymer (I) can be synthesized by performing an addition reaction of a polyvalent thiol compound corresponding to R¹ of Formula (I) with a surfactant, an emulsifier or a dispersant, a reactive compound capable of forming A¹ ((A-2) or (A-3) described above), a reactive compound capable of forming A², a polymerizable compound capable of copolymerization, and the like. Specifically, the polymer (I) can be synthesized by a method disclosed in WO2020/067106A, and can be synthesized by a method described in Examples, which will be described later. The polymer represented by Formula (IA), in which n2 is an integer of 1 or more, can be synthesized, for example, by performing an addition reaction of a polyvalent thiol compound corresponding to R¹ in Formula (IA) with a reactive compound capable of forming A² in a proportion satisfying m in Formula (IA), and as necessary, further performing an addition reaction with a reactive compound capable of forming (A-2) or (A-3) as A¹ in a proportion satisfying n1 in Formula (IA). Here, the polymer represented by Formula (IA), in which n1 is 0, can be synthesized by performing an addition reaction of a polyvalent thiol compound corresponding to R¹ with a reactive compound capable of forming A² in a proportion satisfying m in Formula (IA), and can be synthesized as a synthesis intermediate in a synthesis method of the polymer (I) described in Examples, which will be described later.

A method of incorporating the functional group such as the substituent (a) is not particularly limited, and examples thereof include a method of copolymerizing with a compound having the functional group, a method of using a polymerization initiator or a chain transfer agent, having (generating) the functional group, a method ofusing a polymeric reaction, an ene reaction or thiol-ene reaction with a double bond, and an atom transfer radical polymerization (ATRP) method using a copper catalyst. In addition, the functional group can be introduced by using a functional group which is present in the main chain, the side chain, or the terminal of the polymer, as a reaction point. For example, the functional group can be introduced by various reactions with a dicarboxylic acid anhydride group in a polymerized chain using a compound having the functional group.

### —Physical Properties, Characteristics, and the Like of Polymer (I) or Binder According to Embodiment of Present Invention—

The polymer (I) has an acid value of 3 mgKOH/g or less. It is considered that, since the acid value is 3 mgKOH/g or less, as described above, excessive aggregation and precipitation of the binders and the solid particles can be suppressed.

From the viewpoint of the dispersion state of the solid particles, the acid value of the polymer (I) is preferably 2 mgKOH/g or less, more preferably 1 mgKOH/g or less, and still more preferably 0.5 mgKOH/g or less. The lower limit value of the acid value of the polymer (I) is preferably 0 mgKOH/g.

The acid value of the polymer (I) indicates the number of milligrams of potassium hydroxide required to neutralize an acidic group present in 1 g of the polymer (I), and can be measured by the following method.

The acidic group is not particularly limited as long as it is neutralized with potassium hydroxide, and examples thereof include a carboxylic acid group (carboxy group), a sulfonic acid group (sulfo group), a phosphoric acid group (phospho group), a phosphonic acid group, a phosphinic acid group, and salts thereof.

### (Measuring Method)

1 g of the polymer (I) is dissolved in 25 g of tetrahydrofuran, and is titrated with a 0.01 N—KOH solution using a potential difference titration device to be determined.

The polymer (I) or the binder according to the embodiment of the present invention preferably has the following physical properties, characteristics, and the like.

A base value of the polymer (I) is preferably 2 mgKOH/g or less. It is considered that, in a case where the base value is 2 mgKOH/g or less, excessive aggregation and precipitation of the binders and the solid particles can be suppressed. From the viewpoint of the dispersion state of the solid particles, the base value of the polymer (I) is more preferably 1 mgKOH/g or less, and still more preferably 0.5 mgKOH/g or less. The lower limit value of the base value of the polymer (I) is preferably 0 mgKOH/g.

The base value of the polymer (I) indicates the number of milligrams of potassium hydroxide corresponding to the number of moles of acid required to neutralize a basic group present in 1 g of the polymer (I), and can be measured by the following method.

The basic group is not particularly limited as long as it is neutralized with HCl, and examples thereof include a group having a basic nitrogen atom, preferably a group having a basic nitrogen atom bonded to a hydrogen atom. Specific examples thereof include an amino group, a pyridyl group, an imino group, an amidine group, and the above-described urea group or urethane group having a hydrogen atom bonded to a nitrogen atom.

### (Measuring Method)

1 g of the polymer (I) is dissolved in 25 g of tetrahydrofuran, and is titrated with a 1 N—HCl solution using a potential difference titration device to be determined. The number of moles of HCl required for the neutralization is converted into the number of milligrams of potassium hydroxide.

The acid value and the base value in the polymer (I) may be within the above-described ranges, but it is still more preferable that the acid value is 0.5 mgKOH/g or less and the base value is 0.5 mgKOH/g or less.

A weight-average molecular weight of the polymer (I) is not particularly limited. For example, the weight-average molecular weight is preferably 3,000 or more, more preferably 5,000 or more, and still more preferably 7,000 or more. The upper limit thereof is substantially 100,000 or less, but is preferably 50,000 or less, and more preferably 30,000 or less from the viewpoint of the dispersion state of the solid particles and the resistance.

The weight-average molecular weight of the polymer (I) can be appropriately adjusted by changing the kind and content of the polymerization initiator and the like, polymerization time, polymerization temperature, and the like.

### —Measurement of Molecular Weight—

In the present invention, a molecular weight of the polymer and the polymer chain means a weight-average molecular weight or a number-average molecular weight in terms of standard polystyrene, which is measured by gel permeation chromatography (GPC), unless otherwise specified. A measuring method thereof includes, basically, a method in which conditions are set to Condition 1 or Condition 2 (preferential) described below. In this case, an appropriate eluant may be selected and used depending on the type of the polymer and the polymer chain.

### (Condition 1)

Column: two connected columns of TOSOH TSKgel Super AWM-H (trade name, manufactured by Tosoh Corporation)
Carrier: 10 mM LiBr/N-methylpyrrolidone
Measurement temperature: 40° C.

Carrier flow rate: 1.0 ml/min
Sample concentration: 0.1 mass %
Detector: refractive index (RI) detector

### (Condition 2)

Column: column obtained by connecting TOSOH TSKgel Super HZM-H, TOSOH TSKgel Super HZ4000, and TOSOH TSKgel Super HZ2000 (all of which are trade names, manufactured by Tosoh Corporation)
Carrier: tetrahydrofuran
Measurement temperature: 40° C.
Carrier flow rate: 1.0 ml/min
Sample concentration: 0.1 mass %
Detector: refractive index (RI) detector

The polymer (I) may be a non-crosslinked polymer or a crosslinked polymer. In addition, in a case where crosslinking of the polymer (I) progresses due to heating or voltage application, the molecular weight may be higher than the above-described molecular weight. It is preferable that the polymer (I) has a weight-average molecular weight in the above-described range at the start of use of the all-solid-state secondary battery.

The polymer (I) is preferably amorphous. In the present invention, the description that a polymer is “amorphous” typically refers to that no endothermic peak due to crystal melting is observed in a case where the measurement is carried out at the glass transition temperature.

A watery moisture concentration of the polymer (I) is preferably 100 ppm (in terms of mass) or less. In addition, the polymer (I) may be dried by crystallization, or a polymer dispersion liquid may be used as it is.

### [Inorganic Solid Electrolyte-Containing Composition]

The inorganic solid electrolyte-containing composition according to the embodiment of the present invention contains the above-described polymer (I) according to the present invention, an inorganic solid electrolyte having conductivity of an ion of a metal belonging to Group 1 or Group 2 of the periodic table, and a dispersion medium.

Since the inorganic solid electrolyte-containing composition according to the embodiment of the present invention has an excellent dispersion state of the inorganic solid electrolyte, a sheet for an all-solid-state secondary battery, including a constituent layer having low resistance, and an all-solid-state secondary battery having low resistance (high conductivity) can be realized by using the composition as a constituent layer-forming material of the all-solid-state secondary battery.

Therefore, the inorganic solid electrolyte-containing composition according to the embodiment of the present invention can be preferably used as a forming material of a solid electrolyte layer or an active material layer of a sheet for an all-solid-state secondary battery (including an electrode sheet for an all-solid-state secondary battery) or an all-solid-state secondary battery.

The binder according to the embodiment of the present invention may be present in a particulate form in the dispersion medium contained in the inorganic solid electrolyte-containing composition, without exhibiting a characteristic (solubility) of being dissolved in the dispersion medium, but it is preferable to exhibit solubility. That is, the binder according to the embodiment of the present invention in the inorganic solid electrolyte-containing composition is preferably present in a state of being dissolved in the dispersion medium in the inorganic solid electrolyte-containing composition, depending on the content thereof. In a case where the binder according to the embodiment of the present invention is dissolved, a function of dispersing solid particles in the dispersion medium is stably exhibited, and the dispersion state of the solid particles in the inorganic solid electrolyte-containing composition can be further improved.

In the present invention, the binder according to the embodiment of the present invention being dissolved in the dispersion medium is not limited to an aspect in which all the binders according to the embodiment of the present invention are dissolved in the dispersion medium; and for example, a part of the binder according to the embodiment of the present invention may be present in an insoluble form in the inorganic solid electrolyte-containing composition as long as the following solubility in the dispersion medium is 80% or more.

A measuring method of the solubility is as follows. That is, a specified amount of the binder according to the embodiment of the present invention as a measurement target is weighed in a glass bottle, 100 g of a dispersion medium which is the same kind as the dispersion medium contained in the inorganic solid electrolyte-containing composition is added thereto, and stirring is carried out at a temperature of 25° C. on a mix rotor at a rotation speed of 80 rpm for 24 hours. After stirring for 24 hours, the mixed solution obtained in this way is subjected to a transmittance measurement under the following conditions. The test (transmittance measurement) is carried out by changing the amount of the binder dissolved (the above-described specified amount), and the upper limit concentration X (% by mass) at which the transmittance is 99.8% is defined as the solubility of the binder according to the embodiment of the present invention in the above-described dispersion medium.

### <Transmittance Measurement Conditions>

### Dynamic Light Scattering (DLS) Measurement

Device: DLS measuring device DLS-8000 manufactured by Otsuka Electronics Co., Ltd.
Laser wavelength, output: 488 nm/100 mW
Sample cell: NMR tube

In a case where the binder according to the embodiment of the present invention is in a particulate form (in a case where the binder according to the embodiment of the present invention is not dissolved in the dispersion medium contained in the inorganic solid electrolyte-containing composition), a shape thereof is not particularly limited, and may be flat, amorphous, or the like, but is preferably spherical or granular. In this case, in the inorganic solid electrolyte-containing composition, an average particle diameter of the particulate binder according to the embodiment of the present invention is not particularly limited, but is preferably 1 nm or more, more preferably 10 nm or more, and still more preferably 30 nm or more. The upper limit value thereof is preferably 5 μm or less, and more preferably 1 μm or less. The average particle diameter of the binder according to the embodiment of the present invention can be measured in the same manner as the particle diameter of the inorganic solid electrolyte described above. The average particle diameter of the binder according to the embodiment of the present invention can be adjusted, for example, by the type of the dispersion medium, the formulation of the polymer contained in the binder according to the embodiment of the present invention, and the like.

In the present invention, the solubility of the binder according to the embodiment of the present invention in the dispersion medium can be appropriately imparted by the structure, the formulation (the type and the content of the constitutional component), the weight-average molecular weight of the polymer (I) contained in the binder, and the combination with the dispersion medium.

The inorganic solid electrolyte-containing composition according to the embodiment of the present invention is preferably a slurry in which the inorganic solid electrolyte is dispersed in the dispersion medium.

In addition, the inorganic solid electrolyte-containing composition according to the embodiment of the present invention is preferably a non-aqueous composition. In the present invention, the non-aqueous composition includes not only an aspect including no watery moisture but also an aspect in which the moisture content (also referred to as the watery moisture content) is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (mass proportion to the inorganic solid electrolyte-containing composition) contained in the inorganic solid electrolyte-containing composition, and specifically, it is a value measured by carrying out filtration through a 0.02 μm membrane filter and then Karl Fischer titration.

The inorganic solid electrolyte-containing composition according to the embodiment of the present invention includes an aspect containing not only the inorganic solid electrolyte but also an active material, as well as a conductive auxiliary agent or the like (the composition in this aspect may be referred to as an electrode composition).

Hereinafter, components which are contained and components which can be contained in the inorganic solid electrolyte-containing composition according to the embodiment of the present invention will be described.

### <Binder>

The binder contained in the inorganic solid electrolyte-containing composition according to the embodiment of the present invention includes the above-described binder according to the embodiment of the present invention. The binder according to the embodiment of the present invention, contained in the inorganic solid electrolyte-containing composition according to the embodiment of the present invention, may be one kind or two or more kinds.

A content (in terms of solid contents) of the binder according to the embodiment of the present invention in the inorganic solid electrolyte-containing composition is not particularly limited, but is preferably 0.1 to 5.0% by mass, more preferably 0.2 to 4.0% by mass, and still more preferably 0.3 to 2.0% by mass from the viewpoint of the dispersion state of the solid particles and the resistance. For the same reason, the content (in terms of solid contents) of the binder according to the embodiment of the present invention in 100% by mass of the solid content of the inorganic solid electrolyte-containing composition is preferably 0.1% to 6.0% by mass, more preferably 0.3% to 5.0% by mass, and still more preferably 0.4% to 2.5% by mass.

In the present invention, in 100% by mass of the solid content, a mass ratio [(Mass of inorganic solid electrolyte+Mass of active material)/(Total mass of binder according to embodiment of present invention)] of the total mass (total amount) of the inorganic solid electrolyte and the active material to the mass of the binder according to the embodiment of the present invention is preferably in a range of 1,000 to 1. The ratio is more preferably 500 to 2 and still more preferably 100 to 10.

### <Inorganic Solid Electrolyte>

The inorganic solid electrolyte-containing composition according to the embodiment of the present invention contains an inorganic solid electrolyte.

In the present invention, the inorganic solid electrolyte is an inorganic solid electrolyte, where the solid electrolyte refers to a solid-form electrolyte capable of migrating ions therein. The inorganic solid electrolyte is clearly distinguished from an organic solid electrolyte (a polymeric electrolyte such as polyethylene oxide (PEO), and an organic electrolyte salt such as lithium bis(trifluoromethanesulfonyl)imide (LiTFSI)) since it does not include any organic substance as a principal ion-conductive material. In addition, the inorganic solid electrolyte is solid in a steady state, and thus, typically, is not dissociated or liberated into cations and anions. From the viewpoint, the inorganic solid electrolyte is also clearly distinguished from an inorganic electrolyte salt in which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has ionic conductivity of a metal belonging to Group 1 or Group 2 in the periodic table, and generally does not have electron conductivity. In a case where the all-solid-state secondary battery according to the embodiment of the present invention is a lithium ion battery, the inorganic solid electrolyte preferably has ion conductivity for lithium ions.

As the above-described inorganic solid electrolyte, a solid electrolyte material which is typically used for an all-solid-state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. Since the binder according to the embodiment of the present invention can suppress deterioration and decomposition of the inorganic solid electrolyte in a case of preparing the inorganic solid electrolyte-containing composition, a sulfide-based inorganic solid electrolyte which is generally likely to deteriorate and decompose can be used, and a favorable interface between the active material and the inorganic solid electrolyte can be formed to effectively suppress an increase in interface resistance.

### (i) Sulfide-Based Inorganic Solid Electrolyte

The sulfide-based inorganic solid electrolyte is preferably an electrolyte which contains a sulfur atom, has ionic conductivity of a metal belonging to Group 1 or Group 2 in the periodic table, and has electron-insulating properties. The sulfide-based inorganic solid electrolyte is preferably an inorganic solid electrolyte which contains, as elements, at least Li, S, and P and have lithium ion conductivity, but the sulfide-based inorganic solid electrolyte may appropriately contain elements other than Li, S, and P.

Examples of the sulfide-based inorganic solid electrolyte include an inorganic solid electrolyte having ionic conductivity for lithium ions, which satisfies a formulation represented by Formula (S1).

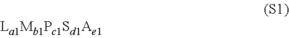

In Formula (S1), L represents an element selected from Li, Na, or K, and is preferably Li. M represents an element selected from B, Zn, Sn, Si, Cu, Ga, Sb, Al, or Ge. A represents an element selected from I, Br, Cl, or F. a1 to e1 represent compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolyte may be non-crystalline (glass) or crystallized (made into glass ceramic), and may be only partially crystallized. For example, it is possible to use Li—P—S-based glass containing Li, P, and S or Li—P—S-based glass ceramic containing Li, P, and S.

The sulfide-based inorganic solid electrolyte can be manufactured by a reaction of at least two or more raw materials of, for example, lithium sulfide (Li₂S), phosphorus sulfide (for example, diphosphorus pentasulfide (P₂S5)), a phosphorus single body, a sulfur single body, sodium sulfide, hydrogen sulfide, lithium halides (for example, LiI, LiBr, and LiCl), and sulfides of an element represented by M described above (for example, SiS₂, SnS, and GeS₂).

A ratio between Li₂S and P₂S₅ in the Li—P—S-based glass and the Li—P—S-based glass ceramic is preferably 60:40 to 90:10 and more preferably 68:32 to 78:22 in terms of a molar ratio between Li₂S:P₂S₅. In a case where the ratio between Li₂S and P₂S₅ is set in the above-described range, it is possible to increase the lithium ion conductivity. Specifically, the lithium ion conductivity can be preferably set to 1×10⁻⁴ S/cm or more, and more preferably set to 1×10⁻³ S/cm or more. The upper limit thereof is not particularly limited, and it is practically 1×10⁻¹ S/cm or less.

As specific examples of the sulfide-based inorganic solid electrolyte, combination examples of raw materials are described below. Examples thereof include Li₂S—P₂Ss, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S-Ges₂-Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and LiioGeP₂Si₂. However, a mixing ratio of the respective raw materials is not important. Examples of a method of synthesizing the sulfide-based inorganic solid electrolyte material using the above-described raw material compositions include an amorphization method. Examples of the amorphization method include a mechanical milling method, a solution method, and a melting quenching method. This is because the treatments can be carried out at normal temperature, and it is possible to simplify manufacturing process.

### (ii) Oxide-Based Inorganic Solid Electrolyte

The oxide-based inorganic solid electrolyte is preferably an electrolyte which contains an oxygen atom, has ionic conductivity of a metal belonging to Group 1 or Group 2 in the periodic table, and has electron-insulating properties.

An ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit thereof is not particularly limited, and it is practically 1×10⁻¹ S/cm or less.

Specific examples of the compound include LiₓₐLa_{ya}TiO₃ (LLT) [xa satisfies 0.3≤xa≤0.7 and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al,Ga)_{yd}(Ti,Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13); Li₍₃₋₂ₓₑM^{ee}ₓₑD^{ee}O (xe represents a number of 0 or more and 0.1 or less, M^{ee} represents a divalent metal atom, D^{ee} represents a halogen atom or a combination of two or more halogen atoms); Li_{Xf}SiyO_{z} (xf satisfies 1≤xf≤5, yf satisfies 0<yf≤3, and zf satisfies 1≤zf≤10); Li_{xg}S_{yg}O_{zg} (xg satisfies 1≤xg≤3, yg satisfies 0<yg≤2, and zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1 and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen elements in lithium phosphate are replaced with a nitrogen element; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Furthermore, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound which contains a halogen atom, has ionic conductivity of a metal belonging to Group 1 or Group 2 in the periodic table, and has electron-insulating properties.

The halide-based inorganic solid electrolyte is not particularly limited, and examples thereof include LiCl, LiBr, LiI, and compounds such as Li₃YBr₆ and Li₃YCl₆ described in ADVANCED MATERIALS, 2018, 30, 1803075. Among these, Li₃YBr₆ or Li₃YCl₆ is preferable.

### (iv) Hydride-Based Inorganic Solid Electrolyte

The hydride-based inorganic solid electrolyte is preferably a compound which contains a hydrogen atom, has ionic conductivity of a metal belonging to Group 1 or Group 2 in the periodic table, and has electron-insulating properties.

The hydride-based inorganic solid electrolyte is not particularly limited, and examples thereof include LiBH₄, Li₄(BH₄)³I, and 3LiBH₄—LiCl.

The inorganic solid electrolyte is preferably in a particulate form in the inorganic solid electrolyte-containing composition. In this case, a particle diameter (volume average particle size) of the inorganic solid electrolyte is not particularly limited, and is preferably 0.01 μm or more, and more preferably 0.1 μm or more. The upper limit thereof is preferably 100 μm or less, and more preferably 50 μm or less.

The particle diameter of the inorganic solid electrolyte is measured according to the following procedure. Particles of the inorganic solid electrolyte are diluted using water (heptane in a case where the material is unstable in water) in a 20 mL sample bottle to prepare 1% by mass of a dispersion liquid. The diluted dispersion liquid sample is irradiated with 1 kHz ultrasonic waves for 10 minutes, and then immediately used for test. Data collection is performed 50 times with the dispersion liquid sample using a laser diffraction/scattering-type particle size distribution analyzer LA-920 (product name, manufactured by Horiba Ltd.) and a quartz cell for measurement at a temperature of 25° C., thereby obtaining the volume average particle size. For other detailed conditions and the like, Japanese Industrial Standards (JIS) Z 8828: 2013 “Particle Diameter Analysis-Dynamic Light Scattering” is referred to as necessary. Five samples are produced for each level, and the average value thereof is adopted.

A method of adjusting the particle diameter is not particularly limited, and a known method can be applied. Examples thereof include a method using a typical pulverizer or a classifier. As the pulverizer or the classifier, for example, a mortar, a ball mill, a sand mill, a vibration ball mill, a satellite ball mill, a planetary ball mill, a swirling airflow-type jet mill, or a sieve is suitably used. During the pulverization, it is possible to carry out wet-type pulverization in which water or a dispersion medium such as methanol is allowed to be present together. In order to provide the desired particle diameter, classification is preferably performed. The classification is not particularly limited, and can be carried out using a sieve, a wind power classifier, or the like. Both a dry-type classification and a wet-type classification can be used.

The inorganic solid electrolyte-containing composition may contain one kind or two or more kinds of the inorganic solid electrolytes.

A content of the inorganic solid electrolyte in the inorganic solid electrolyte-containing composition is not particularly limited, but is preferably 50% by mass or more, more preferably 70% by mass or more, and particularly preferably 90% by mass or more in 100% by mass of the solid content from the viewpoint of the dispersion state of the solid particles and the resistance. From the same viewpoint, the upper limit thereof is preferably 99.9% by mass or less, more preferably 99.5% by mass or less, and particularly preferably 99% by mass or less. However, in a case where the inorganic solid electrolyte-containing composition contains an active material described later, regarding the content of the inorganic solid electrolyte in the inorganic solid electrolyte-containing composition, it is preferable that the total content of the active material and the inorganic solid electrolyte is within the above-described range.

In the present invention, the solid content (solid component) refers to components which do not disappear by being volatilized or evaporated in a case where the inorganic solid electrolyte-containing composition is subjected to drying treatment at 150° C. for 6 hours in a nitrogen atmosphere at a pressure of 1 mmHg. Typically, the solid content refers to a constitutional component other than the dispersion medium described later.

### <Dispersion Medium>

It is sufficient that the dispersion medium contained in the inorganic solid electrolyte-containing composition is an organic compound which is in a liquid state in the use environment, examples thereof include various organic solvents, and specific examples thereof include an alcohol compound, an ether compound, an amide compound, an amine compound, a ketone compound, an aromatic hydrocarbon compound, an aliphatic hydrocarbon compound, a nitrile compound, and an ester compound.

The dispersion medium may be a non-polar dispersion medium (a hydrophobic dispersion medium) or a polar dispersion medium (a hydrophilic dispersion medium), and a non-polar dispersion medium is preferable from the viewpoint that excellent dispersibility can be exhibited. The non-polar dispersion medium generally refers to a dispersion medium having a property of low affinity to water, and in the present invention, examples thereof include an ester compound, a ketone compound, an ether compound, an aromatic hydrocarbon compound, and an aliphatic hydrocarbon compound.

Examples of the alcohol compound include methyl alcohol, ethyl alcohol, 1-propyl alcohol, 2-propyl alcohol, 2-butanol, ethylene glycol, propylene glycol, glycerol, 1,6-hexanediol, cyclohexanediol, sorbitol, xylitol, 2-methyl-2,4-pentanediol, 1,3-butanediol, and 1,4-butanediol.

Examples of the ether compound include alkylene glycols (diethylene glycol, triethylene glycol, polyethylene glycol, dipropylene glycol, and the like), alkylene glycol monoalkyl ethers (ethylene glycol monomethyl ether, ethylene glycol monobutyl ether, diethylene glycol monomethyl ether, propylene glycol monomethyl ether, dipropylene glycol monomethyl ether, tripropylene glycol monomethyl ether, diethylene glycol monobutyl ether, and the like), alkylene glycol dialkyl ethers (ethylene glycol dimethyl ether and the like), dialkyl ethers (dimethyl ether, diethyl ether, diisopropyl ether, dibutyl ether, and the like), and cyclic ethers (tetrahydrofuran, dioxane (including 1,2-, 1,3- or 1,4-isomer), and the like).

Examples of the amide compound include N,N-dimethylformamide, N-methyl-2-pyrrolidone, 2-pyrrolidinone, 1,3-dimethyl-2-imidazolidinone, F-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic hydrocarbon compound include benzene, toluene, xylene, and perfluorotoluene.

Examples of the aliphatic hydrocarbon compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among the above, an ether compound, a ketone compound, an aromatic hydrocarbon compound, an aliphatic hydrocarbon compound, or an ester compound is preferable; and an ester compound, a ketone compound, an aromatic hydrocarbon compound, or an ether compound is more preferable.

The number of carbon atoms in the compound constituting the dispersion medium is not particularly limited, and it is preferably 2 to 30, more preferably 4 to 20, still more preferably 6 to 15, and particularly preferably 7 to 12.

The dispersion medium preferably has a boiling point of 50° C. or higher and more preferably 70° C. or higher at normal pressure (1 atm: 101,325 Pa). The upper limit thereof is preferably 250° C. or lower and more preferably 220° C. or lower.

The inorganic solid electrolyte-containing composition may contain one kind or two or more kinds of the dispersion media. Examples of two or more kinds of the dispersion media include xylene (a mixture of xylene isomers in which a mixing molar ratio between isomers is ortho-isomer:para-isomer:meta-isomer=1:5:2) and mixed xylene (a mixture of o-xylene, p-xylene, m-xylene, and ethylbenzene).

In the present invention, a content of the dispersion medium in the inorganic solid electrolyte-containing composition is not particularly limited and can be appropriately set. For example, in the inorganic solid electrolyte-containing composition, it is preferably 20% to 80% by mass, more preferably 30% to 70% by mass, and particularly preferably 40% to 60% by mass.

### <Active Material>

It is also one of preferred aspects that the inorganic solid electrolyte-containing composition according to the embodiment of the present invention contains an active material capable of intercalating and deintercalating ions of a metal belonging to Group 1 or Group 2 of the periodic table. Examples of the active material include a positive electrode active material and a negative electrode active material, which will be described later.

In the present invention, the inorganic solid electrolyte-containing composition containing an active material (a positive electrode active material or a negative electrode active material) may be referred to as an electrode composition (a positive electrode composition or a negative electrode composition).

### (Positive Electrode Active Material)

The positive electrode active material is an active material capable of intercalating and deintercalating an ion of a metal belonging to Group 1 or Group 2 of the periodic table, and an active material capable of reversibly intercalating and deintercalating lithium ions is preferable. The material is not particularly limited as long as the material has the above-described characteristics, and the material may be a transition metal oxide, an organic substance, an element capable of being complexed with Li, such as sulfur, or the like.

Among these, as the positive electrode active material, transition metal oxides are preferably used, and transition metal oxides having a transition metal element M^{a} (one or more elements selected from Co, Ni, Fe, Mn, Cu, and V) are more preferable. In addition, an element Mb (an element of Group 1 (Ia) of the periodic table other than lithium, an element of Group 2 (IIa), or an element such as Al, Ga, In, Ge, Sn, Pb, Sb, Bi, Si, P, or B) may be mixed into the transition metal oxide. A mixing amount thereof is preferably 0% to 30% by mole of the amount (100% by mole) of the transition metal element M^{a}. It is more preferable that the transition metal oxide is synthesized by mixing the above-described components such that a molar ratio Li/M^{a} is 0.3 to 2.2.

Specific examples of the transition metal oxide include (MA) transition metal oxides having a bedded salt-type structure, (MB) transition metal oxides having a spinel-type structure, (MC) lithium-containing transition metal phosphoric acid compounds, (MD) lithium-containing transition metal halogenated phosphoric acid compounds, and (ME) lithium-containing transition metal silicate compounds.

Specific examples of the transition metal oxide having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxide having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃; cobalt phosphates such as LiCoPO₄; iron pyrophosphates such as LiFeP₂O₇; and monoclinic NASICON-type vanadium phosphate salts such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, and cobalt fluorophosphates such as Li₂CoPO₄F. Examples of the lithium-containing transition metal silicate compound (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

A shape of the positive electrode active material is not particularly limited, but it is preferable that the positive electrode active material has a particulate shape in the inorganic solid electrolyte-containing composition. In a case where the positive electrode active material has a particulate shape, a particle diameter (a volume average particle size) of the positive electrode active material is not particularly limited. For example, it can be set to 0.1 to 50 km. The particle diameter of the positive electrode active material particle can be measured using the same method as that of the particle diameter of the inorganic solid electrolyte described above. In order to have a predetermined particle diameter, a normal pulverizer or classifier is used as in the inorganic solid electrolyte.

A positive electrode active material obtained using a baking method may be used after being washed with water, an acidic aqueous solution, an alkaline aqueous solution, or an organic solvent.

The inorganic solid electrolyte-containing composition may contain one kind or two or more kinds of the positive electrode active materials.

A content of the positive electrode active material in the inorganic solid electrolyte-containing composition is not particularly limited, and it is preferably 10% to 97% by mass, more preferably 30% to 95% by mass, still more preferably 40% to 93% by mass, and particularly preferably 50% to 90% by mass in 100% by mass of the solid content.

### (Negative Electrode Active Material)

The negative electrode active material is an active material capable of intercalating and deintercalating an ion of a metal belonging to Group 1 or Group 2 of the periodic table, and an active material capable of reversibly intercalating and deintercalating lithium ions is preferable. The material is not particularly limited as long as the material has the above-described characteristics, and examples thereof include a carbonaceous material, a metal oxide, a metal composite oxide, lithium, a lithium alloy, and a negative electrode active material capable of forming an alloy (capable of being alloyed) with lithium. Among these, a carbonaceous material, a metal composite oxide, or a lithium single body is preferably used from the viewpoint of reliability. An active material which is capable of being alloyed with lithium is preferable because a capacity of the all-solid-state secondary battery can be increased.

The carbonaceous material used as the negative electrode active material is a material substantially consisting of carbon. Examples thereof include petroleum pitch, carbon black such as acetylene black (AB), graphite (natural graphite and artificial graphite such as vapor-grown graphite), and carbonaceous material obtained by calcining a variety of synthetic resins such as a polyacrylonitrile (PAN)-based resin and a furfuryl alcohol resin. Furthermore, examples thereof also include various carbon fibers such as PAN-based carbon fiber, cellulose-based carbon fiber, pitch-based carbon fiber, vapor-grown carbon fiber, dehydrated polyvinyl alcohol (PVA)-based carbon fiber, lignin carbon fiber, vitreous carbon fiber, and activated carbon fiber; mesophase microspheres, graphite whisker, and tabular graphite.

These carbonaceous materials can be classified into non-graphitizable carbonaceous materials (also referred to as “hard carbon”) and graphitizable carbonaceous materials, based on the graphitization degree. In addition, it is preferable that the carbonaceous material has the surface spacing, density, and crystallite size described in JP1987-22066A (JP-S62-22066A), JP1990-6856A (JP-H2-6856A), and JP1991-45473A (JP-H3-45473A). The carbonaceous material is not necessarily a single material, and may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element, which is applied as the negative electrode active material, is not particularly limited as long as it is an oxide capable of intercalating and deintercalating lithium; and examples thereof include an oxide of a metal element (metal oxide), a composite oxide of a metal element or a composite oxide of a metal element and a metalloid element (collectively referred to as a metal composite oxide), and an oxide of a metalloid element (a metalloid oxide). The oxide is preferably an amorphous oxide, and preferred examples thereof include chalcogenides which are reaction products between metal elements and elements of Group 16 in the periodic table. In the present invention, the metalloid element refers to an element having intermediate properties between those of a metal element and a non-metal element, and typically, the metalloid element includes six elements including boron, silicon, germanium, arsenic, antimony, and tellurium, and further includes three elements including selenium, polonium, and astatine. In addition, the “noncrystalline” means an oxide having a broad scattering band with an apex in a range of 20° to 40° in terms of the 20 value in case of being measured by an X-ray diffraction method using a CuKα ray, and the oxide may have a crystalline diffraction line. The highest intensity in a crystalline diffraction line observed in a range of 400 to 700 in terms of the 20 value is preferably 100 times or less and more preferably 5 times or less with respect to the intensity of a diffraction line at the apex in a broad scattering band observed in a range of 200 to 400 in terms of the 20 value, and it is particularly preferable that the oxide does not have a crystalline diffraction line.

In the compound group consisting of the noncrystalline oxides and the chalcogenides described above, the noncrystalline oxide of a metalloid element or the above-described chalcogenide is more preferable; and a (composite) oxide consisting of one element or a combination of two or more elements selected from elements (for example, A₁, Ga, Si, Sn, Ge, Pb, Sb, and Bi) of Group 13 (IIIB) to Group 15 (VB) of the periodic table or the chalcogenide is particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅. Suitable examples of a negative electrode active material which can be used in combination with the noncrystalline oxide mainly using Sn, Si, or Ge include a carbonaceous material capable of intercalating and deintercalating lithium ions or lithium metal, a lithium single substance, a lithium alloy, and a negative electrode active material capable of forming an alloy with lithium.

It is preferable that an oxide of a metal or a metalloid element, in particular, a metal (composite) oxide and the above-described chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable from the viewpoint that the volume variation during the intercalation and deintercalation of lithium ions is small, and thus high-speed charging and discharging characteristics are excellent, and deterioration of electrodes is suppressed, whereby it is possible to improve life of the lithium ion secondary battery.

The lithium alloy as the negative electrode active material is not particularly limited as long as it is typically used as a negative electrode active material for a secondary battery; and examples thereof include a lithium aluminum alloy, specifically, a lithium aluminum alloy using lithium as a base metal, to which 10% by mass of aluminum is added.

The negative electrode active material capable of forming an alloy with lithium is not particularly limited as long as it is typically used as a negative electrode active material for a secondary battery. Examples of such an active material include a (negative electrode) active material (an alloy or the like) having a silicon element or a tin element, and a metal such as Al or In; and a negative electrode active material (a silicon element-containing active material) having a silicon element capable of exhibiting high battery capacity is preferable, and a silicon element-containing active material in which a content of the silicon element is 50% by mole or more with respect to all constitutional elements is more preferable.

Generally, a negative electrode containing these negative electrode active materials (for example, an Si negative electrode containing a silicon element-containing active material, an Sn negative electrode containing a tin element-containing active material, and the like) can absorb a larger amount of Li ions than carbon negative electrodes (such as graphite and acetylene black). That is, the amount of Li ions absorbed per unit mass increases. Therefore, the battery capacity (energy density) can be increased. As a result, there is an advantage in that the battery driving duration can be extended.

Examples of the silicon element-containing active material include a silicon-containing alloy (for example, LaSi₂, VSi₂, La—Si, Gd—Si, or Ni—Si) including a silicon material such as Si or SiOₓ (0<x≤1) and titanium, vanadium, chromium, manganese, nickel, copper, lanthanum, or the like or a structured active material thereof (for example, LaSi₂/Si), and an active material containing a silicon element and a tin element, such as SnSiO₃ or SnSiS₃. Since SiOₓ itself can be used as the negative electrode active material (the metalloid oxide) and Si is produced along with the operation of the all-solid-state secondary battery, SiOₓ can be used as a negative electrode active material (or a precursor material thereof) capable of forming an alloy with lithium.

Examples of the negative electrode active material containing a tin element include Sn, SnO, SnO₂, SnS, SnS₂, and the above-described active material containing a silicon element and a tin element. In addition, a composite oxide with lithium oxide, for example, Li₂SnO₂ can also be used.

In the present invention, the above-described negative electrode active material can be used without being particularly limited. However, from the viewpoint of battery capacity, a preferred aspect as the negative electrode active material is a negative electrode active material capable of being alloyed with lithium, and among these, the silicon material or the silicon-containing alloy (the alloy containing a silicon element) described above is more preferable, and it is still more preferable to contain a negative electrode active material containing silicon (Si) or a silicon-containing alloy.

A chemical formula of a compound obtained by the above-described baking method can be calculated using an inductively coupled plasma (ICP) emission spectroscopy as a measuring method from the mass difference of powder before and after baking as a convenient method.

A shape of the negative electrode active material is not particularly limited, but it is preferable that the negative electrode active material has a particulate shape in the inorganic solid electrolyte-containing composition. In a case where the negative electrode active material has a particulate shape, a particle diameter of the negative electrode active material is not particularly limited, but it is preferably 0.1 to 60 μm. The particle diameter of the negative electrode active material particle can be measured using the same method as that of the particle diameter of the inorganic solid electrolyte described above. In order to have a predetermined particle diameter, a normal pulverizer or classifier is used as in the inorganic solid electrolyte.

The inorganic solid electrolyte-containing composition may contain one kind or two or more kinds of the negative electrode active materials.

A content of the negative electrode active material in the inorganic solid electrolyte-containing composition is not particularly limited, and it is preferably 10% to 90% by mass, more preferably 20% to 85% by mass, still more preferably 30% to 80% by mass, and even more preferably 40% to 75% by mass in 100% by mass of the solid content.

In the present invention, in a case where a negative electrode active material layer is formed by charging a secondary battery, ions of a metal belonging to Group 1 or Group 2 in the periodic table, generated in the all-solid-state secondary battery, can be used instead of the above-described negative electrode active material. By bonding the ions to electrons and precipitating a metal, the negative electrode active material layer can be formed.

### (Coating of Active Material)

Surfaces of the positive electrode active material and the negative electrode active material may be subjected to surface coating with another metal oxide. Examples of a surface coating agent include metal oxides containing Ti, Nb, Ta, W, Zr, Al, Si, or Li. Examples thereof include titanium oxide spinel, tantalum-based oxides, niobium-based oxides, and lithium niobate-based compounds; and specific examples thereof include Li₄Ti₅O₁₂, Li₂Ti₂O₈, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or the negative electrode active material may be subjected to a surface treatment with sulfur or phosphorus.

Furthermore, the particle surface of the positive electrode active material or the negative electrode active material may be subjected to a surface treatment with an actinic ray or an active gas (plasma or the like) before and after the surface coating.

### <Conductive Auxiliary Agent>

It is also one of preferred aspects that the inorganic solid electrolyte-containing composition according to the embodiment of the present invention contains a conductive auxiliary agent, and it is preferable to use the active material and the conductive auxiliary agent in combination; for example, it is preferable to use a silicon atom-containing active material as the negative electrode active material and the conductive auxiliary agent in combination.

The conductive auxiliary agent is not particularly limited, a conductive auxiliary agent which is known as a general conductive auxiliary agent can be used. For example, the conductive auxiliary agent may be graphite such as natural graphite and artificial graphite; carbon black such as acetylene black, ketjen black, and furnace black; irregular carbon such as needle cokes; a carbon fiber such as vapor-grown carbon fiber and carbon nanotube; a carbonaceous material such as graphene and fullerene which are electron-conductive materials; metal powder or a metal fiber of copper, nickel, or the like; and a conductive polymer such as polyaniline, polypyrrole, polythiophene, polyacetylene, and a polyphenylene derivative.

In the present invention, in a case where the active material is used in combination with the conductive auxiliary agent, among the above-described conductive auxiliary agents, a conductive auxiliary agent which does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent which can function as the active material in the active material layer at the time of charging and discharging of the battery is classified as the active material, not as the conductive auxiliary agent. Whether or not the conductive auxiliary agent functions as the active material at the time of charging and discharging of the battery is not unambiguously determined, and determined by a combination with the active material.

The conductive auxiliary agent preferably has a particulate shape in the inorganic solid electrolyte-containing composition. In a case where the conductive auxiliary agent is in a particulate form, a particle diameter (volume average particle size) of the conductive auxiliary agent is not particularly limited, but is, for example, preferably 0.02 to 1.0 μm. The particle diameter of the conductive auxiliary agent can be measured using the same method as that of the particle diameter of the inorganic solid electrolyte.

The inorganic solid electrolyte-containing composition may contain one kind or two kinds of the conductive auxiliary agents.

In a case where the inorganic solid electrolyte-containing composition according to the embodiment of the present invention contains a conductive auxiliary agent, a content of the conductive auxiliary agent in the inorganic solid electrolyte-containing composition is preferably 0% to 10% by mass in 100% by mass of the solid content.

### <Lithium Salt>

It is also preferable that the inorganic solid electrolyte-containing composition according to the embodiment of the present invention contains a lithium salt (supporting electrolyte). Generally, the lithium salt is preferably a lithium salt which is used for this kind of product and is not particularly limited. For example, lithium salts described in paragraphs 0082 to 0085 of JP2015-088486A are preferable. In a case where the inorganic solid electrolyte-containing composition according to the embodiment of the present invention contains a lithium salt, a content of the lithium salt is preferably 0.1 part by mass or more and more preferably 5 parts by mass or more with respect to 100 parts by mass of the solid electrolyte. The upper limit thereof is preferably 50 parts by mass or less, and more preferably 20 parts by mass or less.

<Binder Other than Binder According to Embodiment of Present Invention>

The inorganic solid electrolyte-containing composition according to the embodiment of the present invention may not contain a binder other than the binder according to the embodiment of the present invention because the binder according to the embodiment of the present invention functions as a binder in the constituent layer, but may contain a binder other than the binder according to the embodiment of the present invention to reinforce the function of the binder according to the embodiment of the present invention. As such a binder, a binder usually used in the all-solid-state secondary battery can be appropriately selected and used. The inorganic solid electrolyte-containing composition according to the embodiment of the present invention may contain one or two or more kinds of binders other than the binder according to the embodiment of the present invention.

In a case where the inorganic solid electrolyte-containing composition according to the embodiment of the present invention contains a binder other than the binder according to the embodiment of the present invention, a content of the binder is appropriately determined, and can be, for example, 3% by mass or less in 100% by mass of the solid content of the inorganic solid electrolyte-containing composition.

### <Dispersant>

The inorganic solid electrolyte-containing composition according to the embodiment of the present invention may not contain a dispersant other than the binder according to the embodiment of the present invention because the binder according to the embodiment of the present invention also functions as a dispersant, but may contain other dispersants (referred to as other dispersants) to reinforce the dispersion function of the binder according to the embodiment of the present invention. As the other dispersants, a binder usually used in the all-solid-state secondary battery can be appropriately selected and used. In general, a compound intended for particle adsorption and steric repulsion and/or electrostatic repulsion is suitably used.

The inorganic solid electrolyte-containing composition according to the embodiment of the present invention may contain one or two or more kinds of other dispersants.

In a case where the inorganic solid electrolyte-containing composition according to the embodiment of the present invention contains other dispersants, a content of the other dispersants is appropriately determined, and can be, for example, 3% by mass or less in 100% by mass of the solid content of the inorganic solid electrolyte-containing composition.

### <Other Additives>

As components other than the respective components described above, the inorganic solid electrolyte-containing composition according to the embodiment of the present invention may appropriately contain an ionic liquid, a thickener, a crosslinking agent (agent causing a crosslinking reaction by radical polymerization, condensation polymerization, or ring-opening polymerization), a polymerization initiator (agent which generates an acid or a radical by heat or light), a defoamer, a leveling agent, a dehydrating agent, or an antioxidant. The ionic liquid is contained in order to further improve the ion conductivity, and the known ionic liquid can be used without being particularly limited.

### (Preparation of Inorganic Solid Electrolyte-Containing Composition)

The inorganic solid electrolyte-containing composition according to the embodiment of the present invention can be prepared, as a mixture and preferably as a slurry, by mixing an inorganic solid electrolyte, the binder according to the embodiment of the present invention, a dispersion medium, and preferably a dispersion medium and a conductive auxiliary agent, as well as a lithium salt and any other optionally constitutional components as appropriate, by using, for example, various mixers that are used generally. In a case of an electrode composition, an active material is further mixed.

The mixing method is not particularly limited, and it can be carried out using a known mixer such as a ball mill, a beads mill, a planetary mixer, a blade mixer, a roll mill, a kneader, a disc mill, a self-rotation type mixer, or a narrow gap type disperser. Each component may be mixed collectively or may be mixed sequentially. The environment in which the mixing is carried out is not particularly limited, and examples thereof include a dry air atmosphere (dew point of −20° C. or lower) or an inert gas atmosphere (for example, an argon gas atmosphere, a helium gas atmosphere, or a nitrogen gas atmosphere). In addition, the mixing conditions are not particularly limited and are appropriately set, and for example, the mixing temperature can be set to 15° C. to 40° C. In addition, a rotation speed of the self-rotation type mixer or the like can be set to 200 to 3,000 rpm.

The binder according to the embodiment of the present invention can suppress heat generation during mixing with solid particles such as an inorganic solid electrolyte. Therefore, the inorganic solid electrolyte-containing composition according to the embodiment of the present invention can be prepared by suppressing an increase in internal temperature of the mixed system without excessive heat generation without performing an excessive cooling operation. The internal temperature of the mixed system is not determined exclusively by changing the temperature of the dispersion medium or the like, the mixing amount, or the like, but can be suppressed to lower than 45° C., for example, in a case of mixing in a room temperature environment.

[Sheet for all-Solid-State Secondary Battery]

The sheet for an all-solid-state secondary battery according to the embodiment of the present invention is a sheet-shaped molded body with which a constituent layer of an all-solid-state secondary battery can be formed, and it includes various aspects depending on use applications thereof. Examples of thereof include a sheet which is preferably used in a solid electrolyte layer (also referred to as a solid electrolyte sheet for an all-solid-state secondary battery) and a sheet which is preferably used in an electrode or a laminate of an electrode and a solid electrolyte layer (an electrode sheet for an all-solid-state secondary battery). In the present invention, the variety of sheets described above will be collectively referred to as a sheet for an all-solid-state secondary battery.

In the present invention, each layer constituting the sheet for an all-solid-state secondary battery may have a monolayer structure or a multilayer structure.

In the sheet for an all-solid-state secondary battery, the solid electrolyte layer or the active material layer on a substrate is formed of the inorganic solid electrolyte-containing composition according to the embodiment of the present invention. Therefore, the layer formed of the inorganic solid electrolyte-containing composition according to the embodiment of the present invention is formed of components (excluding the dispersion medium) derived from the inorganic solid electrolyte-containing composition, and is usually in close contact (bonded) in a state in which solid particles (the inorganic solid electrolyte, the conductive auxiliary agent, and the active material) and the binder according to the embodiment of the present invention are mixed.

The sheet for an all-solid-state secondary battery can achieve a reduction in resistance (improvement in conductivity) of the all-solid-state secondary battery by appropriately peeling off the substrate or directly incorporating the sheet into the all-solid-state secondary battery.

It is sufficient that the solid electrolyte sheet for an all-solid-state secondary battery according to the embodiment of the present invention is a sheet including the solid electrolyte layer, and it may be a sheet in which a solid electrolyte layer is formed on a substrate or may be a sheet (sheet from which the substrate has been peeled off) which is formed of the solid electrolyte layer without including a substrate. The solid electrolyte sheet for an all-solid-state secondary battery may include other layers in addition to the solid electrolyte layer. Examples of the other layers include a protective layer (peeling sheet), a collector, and a coating layer. The solid electrolyte layer included in the solid electrolyte sheet for an all-solid-state secondary battery is preferably formed of the inorganic solid electrolyte-containing composition according to the embodiment of the present invention. A content of each component in the solid electrolyte layer is not particularly limited, but it preferably has the same meaning as the content of each component in the solid content of the inorganic solid electrolyte-containing composition according to the embodiment of the present invention. A layer thickness of each layer constituting the solid electrolyte sheet for an all-solid-state secondary battery is the same as a layer thickness of each layer in the all-solid-state secondary battery, which will be described later.

Examples of the solid electrolyte sheet for an all-solid-state secondary battery according to the embodiment of the present invention include a sheet including a layer formed of the inorganic solid electrolyte-containing composition according to the embodiment of the present invention, a typical solid electrolyte layer, and a protective layer on a substrate in this order.

The substrate is not particularly limited as long as it can support the solid electrolyte layer, and examples thereof include a sheet body (plate-shaped body) formed of materials described later regarding a collector, an organic material, an inorganic material, or the like. Examples of the organic material include various polymers, and specific examples thereof include polyethylene terephthalate, polypropylene, polyethylene, and cellulose. Examples of the inorganic material include glass and ceramic.

It is sufficient that the electrode sheet for an all-solid-state secondary battery according to the embodiment of the present invention (simply also referred to as “electrode sheet”) is an electrode sheet including the active material layer, and it may be a sheet in which the active material layer is formed on a substrate (collector) or may be a sheet (sheet from which the substrate has been peeled off) which is formed of the active material layer without including a substrate. The electrode sheet is typically a sheet including the collector and the active material layer, and examples of an aspect thereof include an aspect including the collector, the active material layer, and the solid electrolyte layer in this order and an aspect including the collector, the active material layer, the solid electrolyte layer, and the active material layer in this order. The solid electrolyte layer and the active material layer included in the electrode sheet are preferably formed of the inorganic solid electrolyte-containing composition according to the embodiment of the present invention. A content of each component in the solid electrolyte layer or the active material layer is not particularly limited, but it preferably has the same meaning as the content of each component in the solid content of the inorganic solid electrolyte-containing composition (electrode composition) according to the embodiment of the present invention. A layer thickness of each layer constituting the electrode sheet according to the embodiment of the present invention is the same as the layer thickness of each layer in the all-solid-state secondary battery, which will be described later. The electrode sheet may include the above-described other layers.

In a case where the solid electrolyte layer or the active material layer is not formed of the inorganic solid electrolyte-containing composition according to the embodiment of the present invention, it is formed of a general constituent layer-forming material.

In the sheet for an all-solid-state secondary battery according to the embodiment of the present invention, at least one layer of the solid electrolyte layer or the active material layer is formed of the inorganic solid electrolyte-containing composition according to the embodiment of the present invention. Therefore, the sheet for an all-solid-state secondary battery according to the present invention includes a constituent layer having low resistance, in which solid particles including the inorganic solid electrolyte are bonded. By using the constituent layer as a constituent layer of the all-solid-state secondary battery, low resistance (high conductivity) of the all-solid-state secondary battery can be realized.

[Manufacturing Method of Sheet for all-Solid-State Secondary Battery]

A manufacturing method of the sheet for an all-solid-state secondary battery according to the embodiment of the present invention is not particularly limited, and the sheet can be manufactured by forming each of the above-described layers using the inorganic solid electrolyte-containing composition according to the embodiment of the present invention. Examples thereof include a method in which film formation (coating and drying) is carried out preferably on a substrate or a collector (another layer may be interposed) to form a layer (coated and dried layer) consisting of the inorganic solid electrolyte-containing composition. As a result, it is possible to produce a sheet for an all-solid-state secondary battery, having the substrate or the collector and having the coated and dried layer. In particular, in a case where a film of the inorganic solid electrolyte-containing composition according to the embodiment of the present invention is formed on a collector to produce a sheet for an all-solid-state secondary battery, it is possible to reinforce adhesion between the collector and the active material layer. Here, the coated and dried layer refers to a layer formed by carrying out coating with the inorganic solid electrolyte-containing composition according to the embodiment of the present invention and drying the dispersion medium (that is, a layer formed of the inorganic solid electrolyte-containing composition according to the embodiment of the present invention and consisting of a composition obtained by removing the dispersion medium from the inorganic solid electrolyte-containing composition according to the embodiment of the present invention). In the active material layer and the coated and dried layer, the dispersion medium may remain within a range in which the effect of the present invention is not impaired, and a residual amount thereof in each of the layers may be, for example, 3% by mass or less.

In the manufacturing method of the sheet for an all-solid-state secondary battery according to the embodiment of the present invention, each of the steps such as coating and drying will be described in the manufacturing method of the all-solid-state secondary battery.

In the manufacturing method of the sheet for an all-solid-state secondary battery according to the embodiment of the present invention, the coated and dried layer obtained as described above can be pressurized. The pressurizing condition and the like will be described later in the section of the manufacturing method of the all-solid-state secondary battery.

In addition, in the manufacturing method of the sheet for an all-solid-state secondary battery according to the embodiment of the present invention, the substrate, the protective layer (particularly the peeling sheet), or the like can also be peeled off.

[all-Solid-State Secondary Battery]

The all-solid-state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid-state secondary battery according to the embodiment of the present invention is not particularly limited in the configuration as long as it includes the solid electrolyte layer between the positive electrode active material layer and the negative electrode active material layer, and for example, a known configuration which relates to the all-solid-state secondary battery can be employed. The positive electrode active material layer is preferably formed on a positive electrode collector to constitute a positive electrode. The negative electrode active material layer is preferably formed on a negative electrode collector to constitute a negative electrode. In the present invention, each constituent layer (including the collector layer and the like) constituting the all-solid-state secondary battery may have a monolayer structure or a multilayer structure.

It is preferable that at least one layer of the negative electrode active material layer, the positive electrode active material layer, or the solid electrolyte layer is formed of the inorganic solid electrolyte-containing composition according to the embodiment of the present invention. In addition, it is also one of preferred aspects that at least one of the negative electrode active material layer or the positive electrode active material layer is formed of the inorganic solid electrolyte-containing composition according to the embodiment of the present invention. In the present invention, an aspect in which all of the layers are formed of the inorganic solid electrolyte-containing composition according to the aspect of the present invention is also one of the preferred aspects. In the present invention, forming the constituent layer of the all-solid-state secondary battery using the inorganic solid electrolyte-containing composition according to the embodiment of the present invention includes an aspect in which the constituent layer is formed using the sheet for an all-solid-state secondary battery according to the embodiment of the present invention (however, in a case where a layer other than the layer formed of the inorganic solid electrolyte-containing composition according to the embodiment of the present invention is provided, a sheet from which the layer is removed). The all-solid-state secondary battery according to the embodiment of the present invention, in which at least one layer of the constituent layer is formed of the inorganic solid electrolyte-containing composition according to the embodiment of the present invention, exhibits low resistance (high conductivity). In addition, since the all-solid-state secondary battery according to the embodiment of the present invention exhibits low resistance and high ion conductivity, a large current can be taken out.

In a case where the active material layer or the solid electrolyte layer is not formed of the inorganic solid electrolyte-containing composition according to the embodiment of the present invention, a known material in the related art can be used.

In the present invention, each constituent layer (including the collector layer and the like) constituting the all-solid-state secondary battery may have a monolayer structure or a multilayer structure.

### <Positive Electrode Active Material Layer, Solid Electrolyte Layer, and Negative Electrode Active Material Layer>

In the active material layer or the solid electrolyte layer formed of the inorganic solid electrolyte-containing composition according to the embodiment of the present invention, the kinds of components to be contained and the contents thereof are preferably the same as those for the inorganic solid electrolyte-containing composition according to the embodiment of the present invention with respect to the solid content.

A thickness of each of the negative electrode active material layer, the solid electrolyte layer, and the positive electrode active material layer is not particularly limited. In a case of taking a dimension of a general all-solid-state secondary battery into account, the thickness of each of the layers is preferably 10 to 1,000 μm, and more preferably 20 μm or more and less than 500 μm. In the all-solid-state secondary battery according to the embodiment of the present invention, the thickness of at least one layer of the positive electrode active material layer or the negative electrode active material layer is still more preferably 50 μm or more and less than 500 μm.

### <Collector>

Each of the positive electrode active material layer and the negative electrode active material layer may include a collector on a side opposite to the solid electrolyte layer. The positive electrode collector and the negative electrode collector are preferably an electron conductor.

In the present invention, any one of the positive electrode collector or the negative electrode collector, or collectively both of them may be simply referred to as a collector.

As a material which forms the positive electrode collector, aluminum, an aluminum alloy, stainless steel, nickel, titanium, or a material (material on which a thin film has been formed) obtained by treating the surface of aluminum or stainless steel with carbon, nickel, titanium, or silver is preferable, and among these, aluminum or an aluminum alloy is more preferable.

As a material which forms the negative electrode collector, aluminum, copper, a copper alloy, stainless steel, nickel, titanium, or a material obtained by treating the surface of aluminum, copper, a copper alloy, or stainless steel with carbon, nickel, titanium, or silver is preferable, and aluminum, copper, a copper alloy, or stainless steel is more preferable.

Regarding a shape of the collector, a film sheet shape is typically used, but it is also possible to use a collector having a shape a net shape or a punched shape, or a collector of a lath body, a porous body, a foaming body, a molded body of a fiber group, or the like.

A thickness of the collector is not particularly limited, but it is preferably 1 to 500 μm. In addition, protrusions and recesses are preferably provided on a surface of the collector by performing a surface treatment.

### <Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

### <Housing>

Depending on the use application, the all-solid-state secondary battery according to the embodiment of the present invention may be used as the all-solid-state secondary battery having the above-described structure as it is, but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

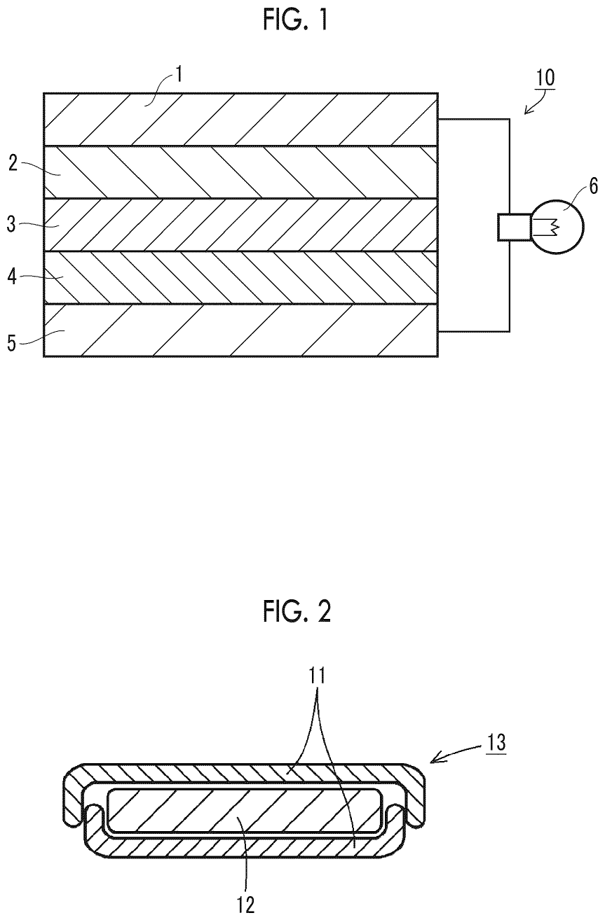

Hereinafter, the all-solid-state secondary battery according to the preferred embodiment of the present invention will be described with reference to FIG. 1, but the present invention is not limited thereto.

FIG. 1 is a cross-sectional view schematically showing the all-solid-state secondary battery (lithium ion secondary battery) according to the preferred embodiment of the present invention. In a case of being viewed from the negative electrode side, an all-solid-state secondary battery 10 according to the present embodiment includes a negative electrode collector 1, a negative electrode active material layer 2, a solid electrolyte layer 3, a positive electrode active material layer 4, and a positive electrode collector 5 in this order. The respective layers are in contact with each other to form an adjacent structure. By adopting such a structure, during charging, electrons (e⁻) are supplied to the negative electrode side, and lithium ions (Li⁺) are accumulated in the negative electrode. On the other hand, during discharging, lithium ions (Li⁺) accumulated in the negative electrode are returned to the positive electrode side, and electrons are supplied to an operation portion 6. In the illustrated example, an electric bulb is employed as a model of the operation portion 6, and is lit by the discharging.

In a case where the all-solid-state secondary battery having the layer configuration shown in FIG. 1 is put into a 2032-type coin case 11 (for example, see FIG. 2), the all-solid-state secondary battery will be referred to as a laminate 12 for an all-solid-state secondary battery, and a battery produced by putting the laminate 12 for an all-solid-state secondary battery into a 2032-type coin case 11 will be referred to as a (coin-type) all-solid-state secondary battery 13, thereby referring to both batteries distinctively in some cases.

### (Positive Electrode Active Material Layer, Solid Electrolyte Layer, and Negative Electrode Active Material Layer)

In the all-solid-state secondary battery 10, all of the positive electrode active material layer 4, the solid electrolyte layer 3, and the negative electrode active material layer 2 are formed of the inorganic solid electrolyte-containing composition according to the embodiment of the present invention. The kinds of the inorganic solid electrolyte and the binder according to the embodiment of the present invention, which are contained in the positive electrode active material layer 4, the solid electrolyte layer 3, and the negative electrode active material layer 2, may be the same or different from each other. In addition, the kinds of the conductive auxiliary agents contained in the positive electrode active material layer 4 and the negative electrode active material layer 2 may be the same or different from each other.

In the present invention, any one of the positive electrode active material layer or the negative electrode active material layer, or collectively both of them may be simply referred to as an active material layer or an electrode active material layer. In addition, in the present invention, any one of the positive electrode active material or the negative electrode active material, or collectively both of them may be simply referred to as an active material or an electrode active material.

The solid electrolyte layer contains an inorganic solid electrolyte having conductivity of an ion of a metal belonging to Group 1 or Group 2 of the periodic table, the binder according to the embodiment of the present invention, any component described above, and the like within a range not impairing the effect of the present invention, and it generally does not contain a positive electrode active material and/or a negative electrode active material.

The positive electrode active material layer contains an inorganic solid electrolyte having conductivity of an ion of a metal belonging to Group 1 or Group 2 of the periodic table, a positive electrode active material, the binder according to the embodiment of the present invention, any component described above, and the like within a range not impairing the effect of the present invention.

The negative electrode active material layer contains an inorganic solid electrolyte having conductivity of an ion of a metal belonging to Group 1 or Group 2 of the periodic table, a negative electrode active material, the binder according to the embodiment of the present invention, any component described above, and the like within a range not impairing the effect of the present invention.

In the all-solid-state secondary battery 10, the negative electrode active material layer may be a lithium metal layer. Examples of the lithium metal layer include a layer formed by depositing or molding a lithium metal powder, a lithium foil, and a lithium vapor-deposited film. A thickness of the lithium metal layer can be, for example, 1 to 500 μm regardless of the thickness of the negative electrode active material layer described above.

In the present invention, in a case where the constituent layer is formed of the inorganic solid electrolyte-containing composition according to the embodiment of the present invention, an all-solid-state secondary battery having low resistance can be realized.

### (Collector)

The positive electrode collector 5 and the negative electrode collector 1 are as described above.

In a case where the all-solid-state secondary battery 10 has a constituent layer other than the constituent layer formed of the inorganic solid electrolyte-containing composition according to the embodiment of the present invention, a layer formed of a known constituent layer-forming material can also be applied.

In addition, each layer may be composed of a single layer or may be composed of multiple layers.

[Manufacturing of all-Solid-State Secondary Battery]

The all-solid-state secondary battery can be manufactured according to a conventional method. Specifically, the all-solid-state secondary battery can be manufactured by forming each of the layers described above using the inorganic solid electrolyte-containing composition according to the embodiment of the present invention, or the like. Specifically, the all-solid-state secondary battery according to the embodiment of the present invention can be manufactured by performing a method (manufacturing method of the sheet for an all-solid-state secondary battery according to the embodiment of the present invention) which includes (is carried out through) a step of coating an appropriate substrate (for example, a metal foil which serves as a collector) with the inorganic solid electrolyte-containing composition according to the embodiment of the present invention and forming a coating film (forming a film).

More specifically, an inorganic solid electrolyte-containing composition containing a positive electrode active material is applied and dried as a material for a positive electrode (positive electrode composition) onto a metal foil which is a positive electrode collector to form a positive electrode active material layer, thereby producing a positive electrode sheet for an all-solid-state secondary battery. Next, the inorganic solid electrolyte-containing composition for forming a solid electrolyte layer is applied and dried onto the positive electrode active material layer to form the solid electrolyte layer. Furthermore, an inorganic solid electrolyte-containing composition containing a negative electrode active material is applied and dried as a negative electrode material (negative electrode composition) onto the solid electrolyte layer to form a negative electrode active material layer. A negative electrode collector (a metal foil) is superposed on the negative electrode active material layer, whereby it is possible to obtain an all-solid-state secondary battery having a structure in which the solid electrolyte layer is sandwiched between the positive electrode active material layer and the negative electrode active material layer. A desired all-solid-state secondary battery can also be manufactured by sealing the all-solid-state secondary battery in a housing.

In addition, it is also possible to manufacture an all-solid-state secondary battery by performing the forming method of each layer in reverse order to form the negative electrode active material layer, the solid electrolyte layer, and the positive electrode active material layer on the negative electrode collector, and then superposing the positive electrode collector thereon.

As another method, the following method can be exemplified. That is, a positive electrode sheet for an all-solid-state secondary battery is produced as described above. In addition, an inorganic solid electrolyte-containing composition containing a negative electrode active material is applied and dried as a negative electrode material (negative electrode composition) onto a metal foil which is a negative electrode collector to form a negative electrode active material layer, thereby producing a negative electrode sheet for an all-solid-state secondary battery. Next, a solid electrolyte layer is formed on the active material layer in any one of these sheets as described above. Furthermore, the other of the positive electrode sheet for an all-solid-state secondary battery and the negative electrode sheet for an all-solid-state secondary battery is laminated on the solid electrolyte layer such that the solid electrolyte layer and the active material layer come into contact with each other. In this manner, an all-solid-state secondary battery can be manufactured.

In addition, as still another method, the following method can be exemplified. That is, the positive electrode sheet for an all-solid-state secondary battery and the negative electrode sheet for an all-solid-state secondary battery are produced as described above. In addition, separately from the positive electrode sheet for an all-solid-state secondary battery and the negative electrode sheet for an all-solid-state secondary battery, an inorganic solid electrolyte-containing composition is applied and dried onto a substrate, thereby producing a solid electrolyte sheet for an all-solid-state secondary battery consisting of the solid electrolyte layer. Furthermore, the positive electrode sheet for an all-solid-state secondary battery and the negative electrode sheet for an all-solid-state secondary battery are laminated such that the solid electrolyte layer removed from the substrate is sandwiched therebetween. In this manner, an all-solid-state secondary battery can be manufactured.

Furthermore, the positive electrode sheet for an all-solid-state secondary battery, the negative electrode sheet for an all-solid-state secondary battery, and the solid electrolyte sheet for an all-solid-state secondary battery are produced as described above. Next, the positive electrode sheet for an all-solid-state secondary battery or the negative electrode sheet for an all-solid-state secondary battery, and the solid electrolyte sheet for an all-solid-state secondary battery are superimposed and pressurized into a state in which the positive electrode active material layer or the negative electrode active material layer is brought into contact with the solid electrolyte layer. In this manner, the solid electrolyte layer is transferred to the positive electrode sheet for an all-solid-state secondary battery or the negative electrode sheet for an all-solid-state secondary battery. Thereafter, the solid electrolyte layer from which the substrate of the solid electrolyte sheet for an all-solid-state secondary battery has been peeled off and the negative electrode sheet for an all-solid-state secondary battery or the positive electrode sheet for an all-solid-state secondary battery are superimposed and pressurized (into a state in which the negative electrode active material layer or the positive electrode active material layer is brought into contact with the solid electrolyte layer). In this manner, an all-solid-state secondary battery can be manufactured. The pressurizing method and the pressurizing conditions in the method are not particularly limited, and a method and pressurizing conditions described in the pressurization step, which will be described later, can be adopted.

The solid electrolyte layer and the like can also be formed by, for example, pressurizing and molding the inorganic solid electrolyte-containing composition or the like on a substrate or an active material layer under pressurizing conditions described later.

In the above-described manufacturing method, it is sufficient that the inorganic solid electrolyte-containing composition according to the embodiment of the present invention is used in any one of the positive electrode composition, the inorganic solid electrolyte-containing composition, or the negative electrode composition. The inorganic solid electrolyte-containing composition according to the embodiment of the present invention is preferably used in the inorganic solid electrolyte-containing composition or at least one of the positive electrode composition or the negative electrode composition, or the inorganic solid electrolyte-containing composition according to the embodiment of the present invention can be used in any of the compositions.

In a case where the solid electrolyte layer or the active material layer is formed of a composition other than the inorganic solid electrolyte-containing composition according to the embodiment of the present invention, examples thereof include a typically used composition. In addition, the negative electrode active material layer can also be formed by bonding ions of a metal belonging to Group 1 or Group 2 in the periodic table, which are accumulated on a negative electrode collector during initialization described later or during charging for use, without forming the negative electrode active material layer during the manufacturing of the all-solid-state secondary battery to electrons and precipitating the ions on the negative electrode collector and the like as a metal.

### <Formation (Film Formation) of Each Layer>

A method of applying the inorganic solid electrolyte-containing composition is not particularly limited and can be appropriately selected. Examples thereof include coating (preferably wet-type coating), spray coating, spin coating, dip coating, slit coating, stripe coating, and bar coating. A coating temperature is not particularly limited, and examples thereof include a temperature range of usually room temperature (for example, 15° C. to 30° C.) under non-heating.

The applied inorganic solid electrolyte-containing composition is subjected to a drying treatment (heating treatment). The drying treatment may be performed after applying each composition, or may be performed after multilayer coating with a plurality of compositions. A drying temperature is not particularly limited. The lower limit thereof is preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the composition is heated in the above-described temperature range, the dispersion medium can be removed and the layer can be made into a solid state (coated and dried layer). The temperature range is preferable since the temperature is not excessively increased and each member of the all-solid-state secondary battery is not impaired. As a result, excellent overall performance is exhibited in the all-solid-state secondary battery, and it is possible to obtain favorable bonding property and favorable ion conductivity.

After applying and drying the inorganic solid electrolyte-containing composition, it is preferable to pressurize each layer or the all-solid-state secondary battery after superimposing the constituent layers or producing the all-solid-state secondary battery. In addition, it is also preferable that each of the layers is pressurized together in a state of being laminated. Examples of the pressurizing method include a method using a hydraulic cylinder press machine. A pressurizing force is not particularly limited, but it is generally preferably in a range of 5 to 1,500 MPa.

In addition, the applied inorganic solid electrolyte-containing composition may be heated at the same time with the pressurization. A heating temperature is not particularly limited, but is generally in a range of 30° C. to 300° C. The pressing can also be applied at a temperature higher than a glass transition temperature of the inorganic solid electrolyte. The pressing can also be performed at a temperature higher than the glass transition temperature of the polymer (I) contained in the binder according to the embodiment of the present invention. Here, the temperature is generally a temperature not exceeding a melting point of the polymer (I).

The pressurization may be carried out in a state in which the coating solvent or the dispersion medium has been dried in advance or in a state in which the solvent or the dispersion medium remains.

The respective compositions may be applied at the same time, and the application, the drying, and the pressing may be carried out simultaneously and/or sequentially. Each of the compositions may be applied onto each of the separate substrates, and then laminated by carrying out the transfer.

The atmosphere in the film forming method (coating, drying, and pressurization (under heating) is not particularly limited, and may be any atmosphere such as atmospheric air, dry air (dew point of −20° C. or lower), or inert gas (for example, an argon gas, a helium gas, or a nitrogen gas).

A pressurization time may be a short time (for example, within several hours) under the application of a high pressure, or a long time (one day or longer) under the application of an intermediate pressure. In a case of members other than the sheet for an all-solid-state secondary battery, for example, the all-solid-state secondary battery, it is also possible to use a restraining tool (screw fastening pressure or the like) of the all-solid-state secondary battery in order to continuously apply an intermediate pressure. A pressing pressure may be a pressure that is uniform or varies with respect to a portion under pressure such as a sheet surface. The pressing pressure may be changed according to the area or the film thickness of the portion under pressure. In addition, the pressure may also be variable stepwise for the same portion. A pressing surface may be flat or roughened.

### <Initialization>

The all-solid-state secondary battery manufactured as described above is preferably initialized after the manufacturing or before use. The initialization is not particularly limited, and it is possible to initialize the all-solid-state secondary battery by, for example, carrying out initial charging and discharging in a state in which the pressing pressure is increased and then releasing the pressure until it reaches a general working pressure of the all-solid-state secondary battery.

[Use Application of all-Solid-State Secondary Battery]

The all-solid-state secondary battery according to the embodiment of the present invention can be applied to a variety of use applications. The application aspect is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. In addition, in a case of being used for consumer applications, examples thereof include an automobile (electric vehicle and the like), an electric vehicle, a motor, a lighting instrument, a toy, a game device, a road conditioner, a watch, a strobe, a camera, and a medical device (a pacemaker, a hearing aid, a shoulder massage device, and the like). Furthermore, the non-aqueous electrolytic solution secondary can be used for various military usages and universe usages. In addition, the secondary battery according to the embodiment of the present invention can also be combined with a solar cell.

### EXAMPLES

Hereinafter, the present invention will be described in more detail based on Examples, but the present invention is not limited thereto be interpreted. “Part” and “%” that represent compositions in the following Examples are based on the mass unless particularly otherwise described. In the present invention, “room temperature” means 25° C.

### [[Example 1]] Synthesis of Polymer and Preparation of Binder Solution or Dispersion Liquid

The following polymers shown in the following chemical formulae and Tables 1-1 and 1-2 (collectively referred to as Table 1) were synthesized as follows to prepare a binder solution or a dispersion liquid.

### Synthesis Example S-1: Synthesis of Polymer S-1 and Preparation of Binder Solution S-1

First, dipentaerythritol hexakis(3-mercaptopropionate) (3.4 g), butyl butyrate (15.0 g), and nonafluorohexyl acrylate (5.6 g) were charged into a three-neck flask, and the temperature was raised to 80° C. under a nitrogen stream. Thereafter, an azo-based polymerization initiator V-601 (0.03 g, manufactured by Wako Pure Chemical Industries, Ltd.) was added to the above-described three-neck flask, and the mixture was stirred for 4 hours.

Next, acrylamide (1.0 g) was added to the above-described three-neck flask and dissolved therein, and then the azo-based polymerization initiator V-601 (0.02 g) was added thereto, and the mixture was stirred at 80° C. for 2 hours.

In this way, the polymer S-1 was synthesized, and a binder solution S-1 (concentration: 67% by mass) consisting of the polymer was obtained.

### Synthesis Examples S-2 to S-20: Synthesis of Polymers S-2 to S-20 and Preparation of Binder Solutions S-2 to S-20

Polymers S-2 to S-20 were synthesized in the same manner as in Synthesis Example S-1, except that, in Synthesis Example S-1, a compound for deriving each constitutional component was used such that the polymers S-2 to S-20 had the formulation (the type and the content of the constitutional component) shown in Table 1, and the amount of the polymerization initiator was adjusted such that the weight-average molecular weight was as shown in Table 1. As a result, binder solutions S-2 to S-20 consisting of the respective polymers were obtained.

### Synthesis Example S-21: Synthesis of Polymer S-21 and Preparation of Polymer Dispersion Liquid S-21

A polymer S-21 was synthesized in the same manner as in Synthesis Example S-1, except that, in Synthesis Example S-1, a compound for deriving each constitutional component was used such that the polymer S-21 had the formulation (the type and the content of the constitutional component) shown in Table 1, and the amount of the polymerization initiator was adjusted such that the weight-average molecular weight was as shown in Table 1. As a result, a binder dispersion liquid S-21 consisting of the polymer was obtained. In the binder dispersion liquid S-21, in a case where a particle diameter of the polymer S-21 was measured by the above-described measuring method of the inorganic solid electrolyte, it was 200 nm.

### Synthesis Example S-22: Synthesis of Polymer S-22 and Preparation of Polymer Solution S-22

A polymer S-22 was synthesized in the same manner as in Synthesis Example S-1, except that, in Synthesis Example S-1, the di-pentaerythritol hexakis(3-mercaptopropionate) and the nonafluorohexyl acrylate were reacted with each other in a proportion such that the contents thereof were as shown in Table 1, the amount of the polymerization initiator was adjusted such that the weight-average molecular weight thereof was as shown in Table 1, and the reaction with acrylamide was not carried out. As a result, a binder solution S-22 consisting of the polymer was obtained.

### Synthesis Example S-23: Synthesis of Polymer S-23 and Preparation of Polymer Solution S-23

A polymer S-23 was synthesized in the same manner as in Synthesis Example S-20, except that, in Synthesis Example S-20, the di-pentaerythritol hexakis(3-mercaptopropionate) and a compound having a polysiloxane structure (KF-2012; product number) were reacted with each other in a proportion such that the contents thereof were as shown in Table 1, the amount of the polymerization initiator was adjusted such that the weight-average molecular weight thereof was as shown in Table 1, and the reaction with acrylamide was not carried out. As a result, a binder solution S-23 consisting of the polymer was obtained.

### Comparative Synthesis Example T-1: Synthesis of Polymer T-1 and Preparation of Binder Solution T-1

A polymer T-1 was synthesized in the same manner as in Synthesis Example S-1, except that, in Synthesis Example S-1, a compound for deriving each constitutional component was used such that the polymer T-1 had the formulation (the type and the content of the constitutional component) shown in Table 1. As a result, a binder solution T-1 consisting of the polymer was obtained.

### Comparative Synthesis Example T-2: Synthesis of Polymer T-2 and Preparation of Binder Solution T-2

Acrylamide (2.5 g), nonafluorohexyl acrylate (47.5 g), and butyl butyrate (50.0 g) were charged into a three-neck flask, and the temperature was raised to 80° C. under a nitrogen stream. Thereafter, an azo-based polymerization initiator V-601 (0.1 g, manufactured by Wako Pure Chemical Industries, Ltd.) was added to the above-described three-neck flask, and the mixture was stirred for 4 hours.

In this way, the polymer T-2 was synthesized, and a binder solution T-2 (concentration: 50% by mass) consisting of the polymer was obtained.

### Comparative Synthesis Example T-3: Synthesis of Polymer T-3 and Preparation of Binder Dispersion Liquid T-3

A polymer T-3 was synthesized in the same manner as in Synthesis Example S-1, except that, in Synthesis Example S-1, a compound for deriving each constitutional component was used such that the polymer T-3 had the formulation (the type and the content of the constitutional component) shown in Table 1. As a result, a binder dispersion liquid T-3 consisting of the polymer was obtained. In the binder dispersion liquid T-3, in a case where a particle diameter of the polymer T-3 was measured by the above-described measuring method of the inorganic solid electrolyte, it was 100 nm.

### Comparative Synthesis Examples T-4 and T-5: Synthesis of Polymers T-4 and T-5 and Preparation of Binder Solutions T-4 and T-5

Polymers T-4 and T-5 were each synthesized in the same manner as in Synthesis Example S-1, except that, in Synthesis Example S-1, a compound for deriving each constitutional component was used such that the polymers T-4 and T-5 had the formulation (the type and the content of the constitutional component) shown in Table 1. As a result, binder solutions T-4 and T-5 consisting of the respective polymers were obtained.

Chemical formulae of the synthesized polymers are shown below.

In each of the polymers, A¹ (A¹¹) and A² were both polymer chains. The polymer chain corresponding to A¹ in the polymers S-6 to S-12, S-21, T-4, and T-5 was a polymer chain in which two kinds of constitutional components were randomly bonded. In the polymers S-16 to S-21 and S-23, X¹ was a linking group, and X² was a substituent.

In the following chemical formulae, bonding positions of the polymer chains A¹ and A² were specified to show the overall structure of each polymer, but the bonding positions of the polymer chains A¹ and A² were not limited to the positions specified in the following chemical formulae as long as the number (n and m) of the polymer chains A¹ and A² were the same. For example, in the polymer S-1, both polymer chains A¹'s represented a chemical structure bonded to the left structural portion with respect to the central oxygen atom, but one polymer chain A¹ may be bonded to the right structural portion with respect to the central oxygen atom.

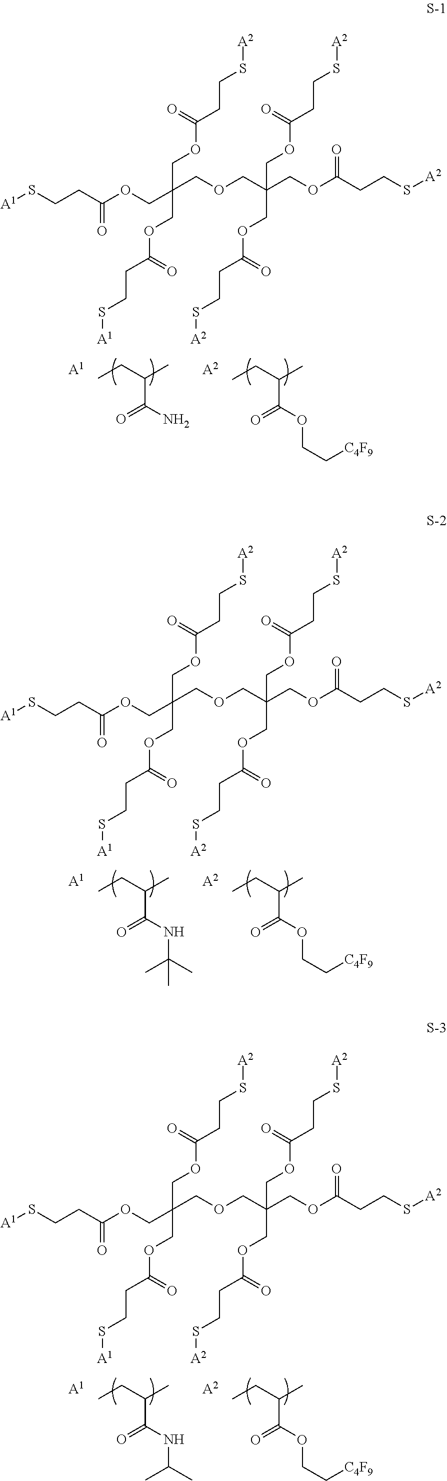

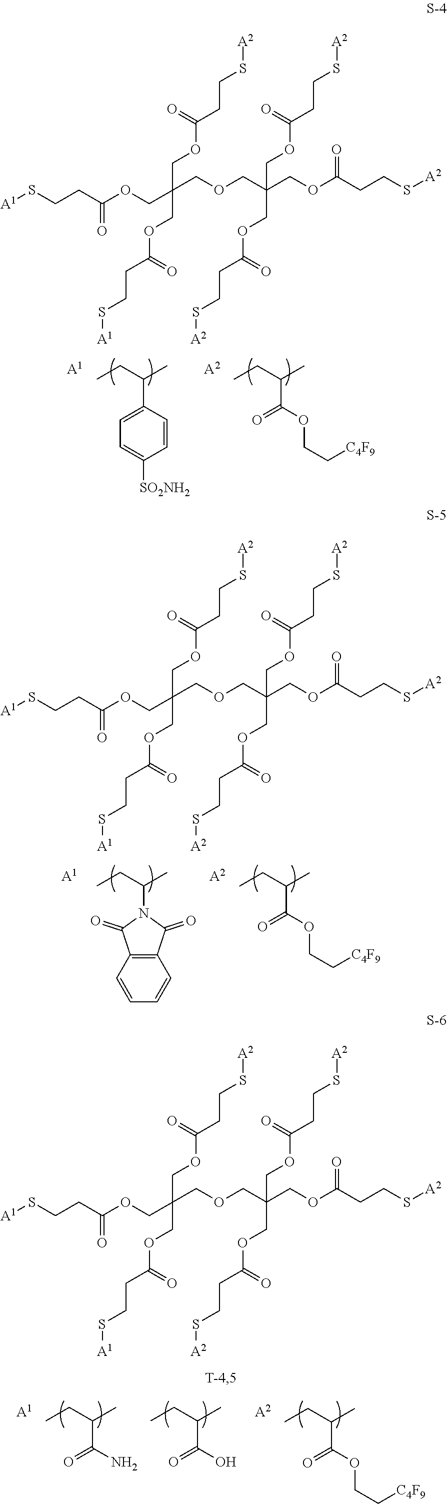

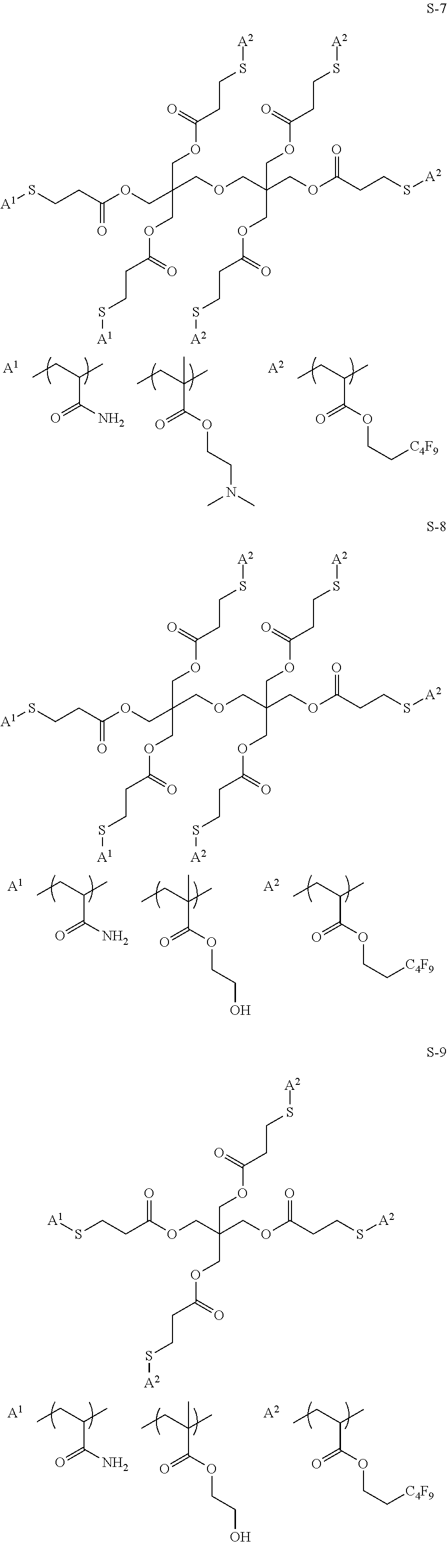

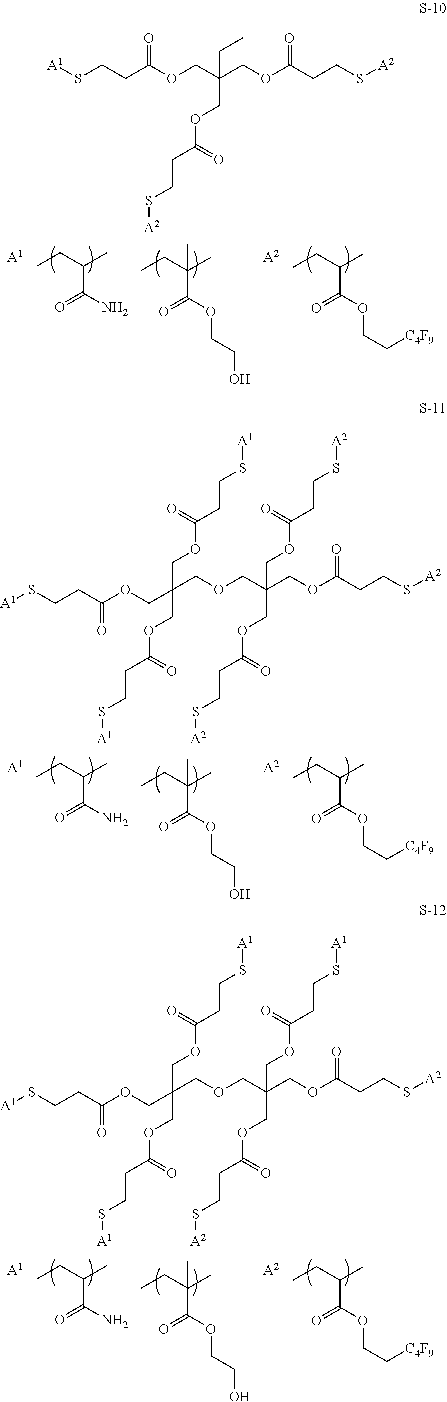

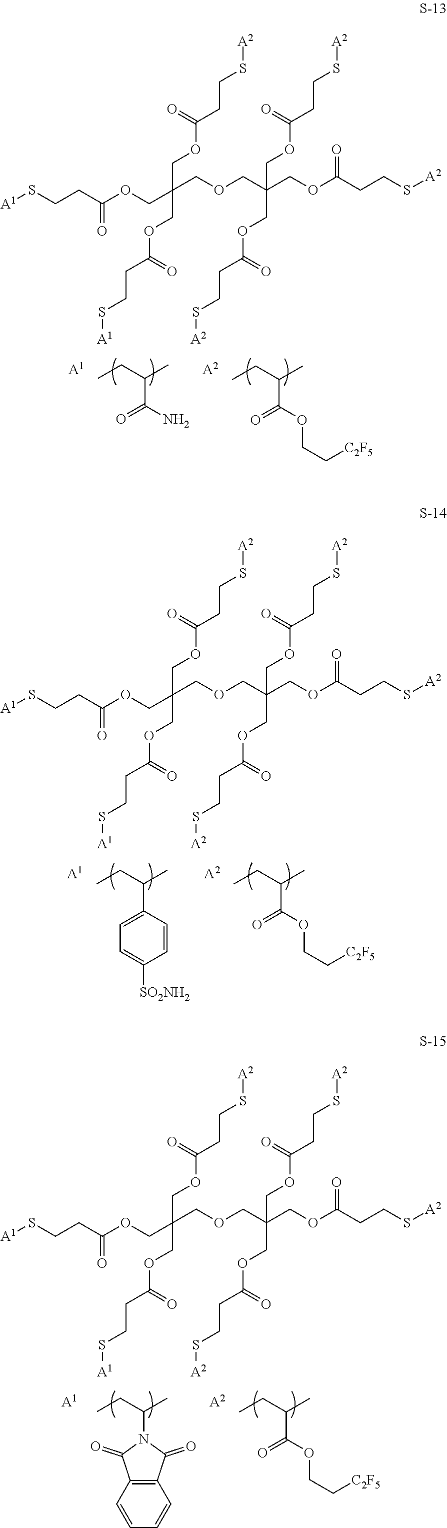

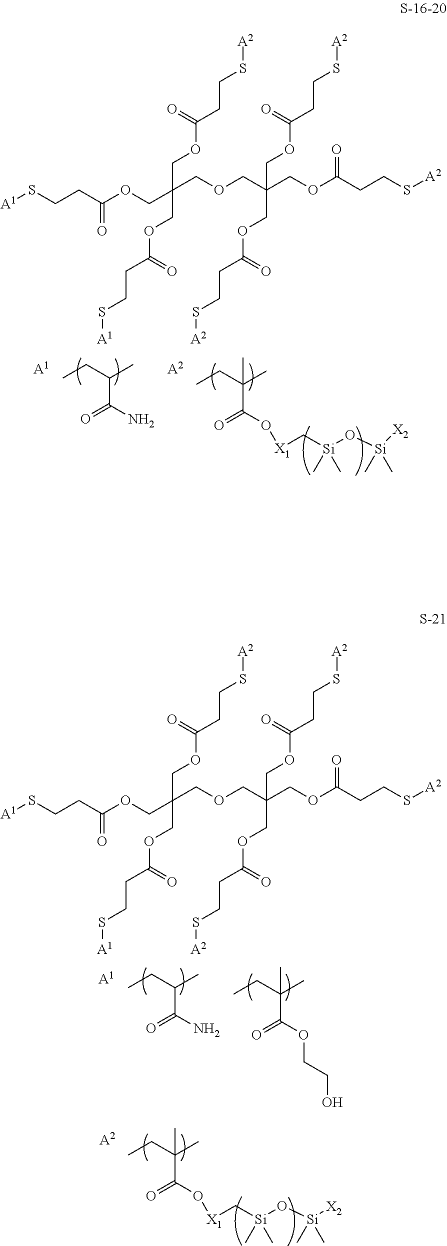

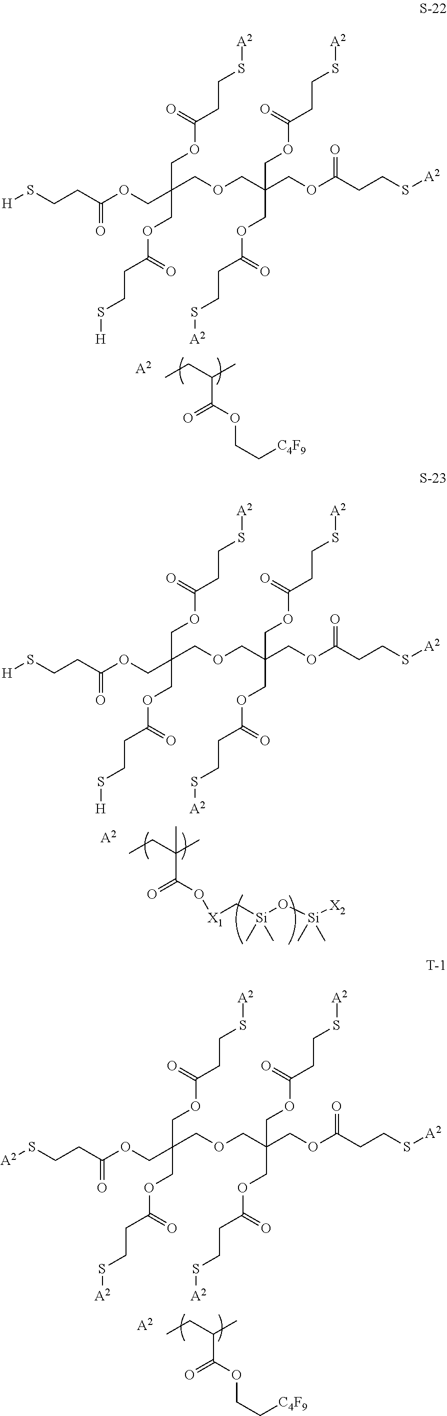

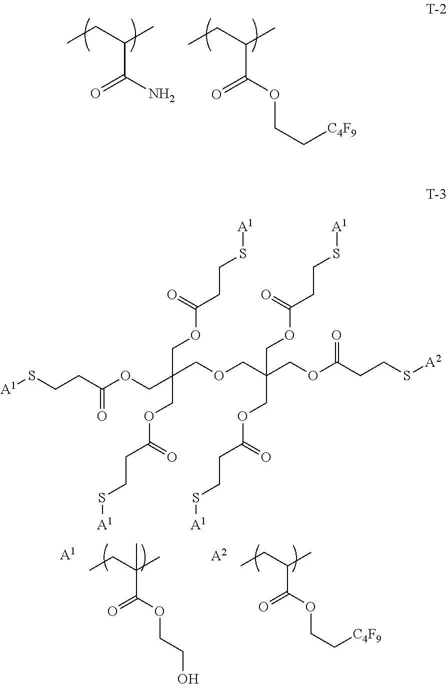

The acid value, the base value, and the weight-average molecular weight of each of the synthesized polymers are shown in Table 1. The acid value, the base value, and the weight-average molecular weight were measured by the above-described methods. In addition, the column of “State” of Table 1 indicates the state of the binder in each composition described later where the state had been determined to be dissolved or particles (dispersed in a particle shape without being dissolved) based on the results obtained by measuring the solubility in the dispersion medium according to the above-described method. Furthermore, the column of “A²/A¹” in Table 1 indicates a ratio [Total content of A²/Total content of A¹] of the total content of A² to the total content of A¹.

The “Content” described in Table 1 is a value calculated from the preparation ratio of each compound during the preparation. In the polymers S-22 and S-23, the total content of A¹ was “2/weight-average molecular weight”, but since the values thereof were small, the values of “total content of A¹” and “A²/A” were not described in Table 1.

In Table 1, the units of the acid value, the base value, and the content are “mgKOH/g”, “mgKOH/g”, and “% by mass”, respectively, but are omitted.

TABLE 1

| | R¹ | | A¹ (A¹¹) | | | | | A² | |
|---|---|---|---|---|---|---|---|---|---|
| | | Con- | Amide-based | Con- | Other | Con- | | | Con- |
| No. | | tent | component | tent | components | tent | A¹² | | tent |
| S-1 | DPMP | 34 | Acrylamide | 10 | — | 0 | — | Nonafluorohexyl | 56 |
| | | | | | | | | acrylate | |
| S-2 | DPMP | 34 | tert- | 10 | — | 0 | — | Nonafluorohexyl | 56 |
| | | | Butylacrylamide | | | | | acrylate | |
| S-3 | DPMP | 34 | i-Propylacrylamide | 10 | — | 0 | — | Nonafluorohexyl | 56 |
| | | | | | | | | acrylate | |
| S-4 | DPMP | 34 | Vinylbenzenesul- | 10 | — | 0 | — | Nonafluorohexyl | 56 |
| | | | fonamide | | | | | acrylate | |
| S-5 | DPMP | 34 | Vinyl phthalimide | 10 | — | 0 | — | Nonafluorohexyl | 56 |
| | | | | | | | | acrylate | |
| S-22 | DPMP | 38 | — | 0 | — | 0 | H | Nonafluorohexyl | 62 |
| | | | | | | | | acrylate | |
| S-6 | DPMP | 34 | Acrylamide | 9.7 | Acrylic acid | 0.3 | — | Nonafluorohexyl | 56 |
| | | | | | | | | acrylate | |
| S-7 | DPMP | 32 | Acrylamide | 10 | Diethylaminoethyl | 5 | — | Nonafluorohexyl | 53 |
| | | | | | methacrylate | | | acrylate | |
| S-8 | DPMP | 32 | Acrylamide | 10 | Hydroxyethyl | 5 | — | Nonafluorohexyl | 53 |
| | | | | | methacrylate | | | acrylate | |
| S-9 | PEMP | 29 | Acrylamide | 10 | Hydroxyethyl | 5 | — | Nonafluorohexyl | 56 |
| | | | | | methacrylate | | | acrylate | |
| S-10 | TMMP | 33 | Acrylamide | 10 | Hydroxyethyl | 5 | — | Nonafluorohexyl | 52 |
| | | | | | methacrylate | | | acrylate | |
| S-11 | DPMP | 38 | Acrylamide | 10 | Hydroxyethyl | 5 | — | Nonafluorohexyl | 47 |
| | | | | | methacrylate | | | acrylate | |
| S-12 | DPMP | 47 | Acrylamide | 10 | Hydroxyethyl | 5 | — | Nonafluorohexyl | 38 |
| | | | | | methacrylate | | | acrylate | |
| S-13 | DPMP | 38 | Acrylamide | 10 | — | 0 | — | Heptafluorobutyl | 52 |
| | | | | | | | | acrylate | |
| S-14 | DPMP | 38 | Vinylbenzenesul- | 10 | — | 0 | — | Heptafluorobutyl | 52 |
| | | | fonamide | | | | | acrylate | |
| S-15 | DPMP | 38 | Vinyl phthalimide | 10 | — | 0 | — | Heptafluorobutyl | 52 |
| | | | | | | | | acrylate | |
| S-16 | DPMP | 16 | Acrylamide | 10 | — | 0 | — | X-22-174ASX | 74 |
| S-17 | DPMP | 13 | Acrylamide | 30 | — | 0 | — | X-22-174ASX | 57 |
| S-18 | DPMP | 11 | Acrylamide | 40 | — | 0 | — | X-22-174ASX | 49 |
| S-19 | DPMP | 7 | Acrylamide | 10 | — | 0 | — | X-22-174BX | 83 |
| S-20 | DPMP | 4 | Acrylamide | 10 | — | 0 | — | KF-2012 | 86 |
| S-23 | DPMP | 4 | — | 0 | — | 0 | H | KF-2012 | 96 |
| S-21 | DPMP | 2 | Acrylamide | 10 | Hydroxyethyl | 50 | — | KF-2012 | 38 |
| | | | | | methacrylate | | | | |
| T-1 | DPMP | 3 | — | 0 | — | 0 | — | Nonafluorohexy1 | 97 |
| | | | | | | | | acrylate | |
| T-2 | — | 0 | Acrylamide | 5 | — | 0 | — | Nonafluorohexyl | 95 |
| | | | | | | | | acrylate | |
| T-3 | DPMP | 7 | — | 0 | Hydroxyethyl | 50 | — | Nonafluorohexyl | 43 |
| | | | | | methacrylate | | | acrylate | |
| T-4 | DPMP | 4 | Acrylamide | 9.5 | Acrylic acid | 0.5 | — | Nonafluorohexyl | 86 |
| | | | | | | | | acrylate | |
| T-5 | DPMP | 3 | Acrylamide | 9.5 | Acrylic acid | 5 | — | Nonafluorohexyl | 82 |
| | | | | | | | | acrylate | |

| | | | | | | | Weight-avearge |
|---|---|---|---|---|---|---|---|
| | | | | Acid | Base | | molecular |
| No. | A²/A¹ | n | m | value | value | State | weight |
| S-1 | 5.6 | 2 | 4 | 0 | 0 | Dissolved | 11000 |
| S-2 | 5.6 | 2 | 4 | 0 | 0 | Dissolved | 12000 |
| S-3 | 5.6 | 2 | 4 | 0 | 0 | Dissolved | 9000 |
| S-4 | 5.6 | 2 | 4 | 0 | 0 | Dissolved | 10000 |
| S-5 | 5.6 | 2 | 4 | 0 | 0 | Dissolved | 11000 |
| S-22 | — | 2 | 4 | 0 | 0 | Dissolved | 6000 |
| S-6 | 5.6 | 2 | 4 | 2 | 0 | Dissolved | 12000 |
| S-7 | 3.5 | 2 | 4 | 0 | 0 | Dissolved | 9000 |
| S-8 | 3.5 | 2 | 4 | 0 | 0 | Dissolved | 12000 |
| S-9 | 3.7 | 1 | 3 | 0 | 0 | Dissolved | 9000 |
| S-10 | 3.5 | 1 | 2 | 0 | 0 | Dissolved | 12000 |
| S-11 | 3.1 | 3 | 3 | 0 | 0 | Dissolved | 12000 |
| S-12 | 2.5 | 4 | 2 | 0 | 0 | Dissolved | 15000 |
| S-13 | 5.2 | 2 | 4 | 0 | 0 | Dissolved | 12000 |
| S-14 | 5.2 | 2 | 4 | 0 | 0 | Dissolved | 9000 |
| S-15 | 5.2 | 2 | 4 | 0 | 0 | Dissolved | 12000 |
| S-16 | 7.4 | 2 | 4 | 0 | 0 | Dissolved | 12000 |
| S-17 | 1.9 | 2 | 4 | 0 | 0 | Dissolved | 21000 |
| S-18 | 1.2 | 2 | 4 | 0 | 0 | Dissolved | 30000 |
| S-19 | 8.3 | 2 | 4 | 0 | 0 | Dissolved | 21000 |
| S-20 | 8.6 | 2 | 4 | 0 | 0 | Dissolved | 30000 |
| S-23 | — | 2 | 4 | 0 | 0 | Dissolved | 25000 |
| S-21 | 0.6 | 2 | 4 | 0 | 0 | Particles | 30000 |
| T-1 | — | 0 | 6 | 0 | 0 | Dissolved | 12000 |
| T-2 | 19.0 | — | — | 0 | 0 | Dissolved | 9000 |
| T-3 | 0.9 | 5 | 1 | 0 | 0 | Particles | 30000 |
| T-4 | 8.6 | 2 | 4 | 4 | 0 | Dissolved | 12000 |
| T-5 | 5.7 | 2 | 4 | 39 | 0 | Dissolved | 9000 |

<Abbreviations in table>
In the table, “—” in the column of the constitutional component indicates that the compound did not have a corresponding constitutional component.
In the table, “R¹” indicates the following compound for deriving “—S—R¹—S—” in Formula (I)
DPMP: dipentaerythritol hexakis(3-mercaptopropionate); manufactured by FUJIFILM Wako Pure Chemical Corporation
PEMP: pentaerythritol tetra(3-mercaptopropionate); manufactured by FUJIFILM Wako Pure Chemical Corporation
TMMP: trimethylolpropane tris(3-mercaptopropionate); manufactured by FUJIFILM Wako Pure Chemical Corporation
In the table, “A¹ (A¹¹)” indicates the following compound for deriving “A¹” (the above-described (A-3)) in Formula (I), “Amide-based component” indicates the following compound for deriving a constitutional component having an amide group, a sulfonamide group, or an imide group, and “other components” indicate a compound for deriving a constitutional component having no amide group, sulfonamide group, or imide group.
In the table, “A¹²” was a hydrogen atom corresponding to “A¹” ((A-1) described above) in Formula (I), and corresponds to “A¹²” in Formula (IA).
In the table, “A²” indicates the following compound for deriving “A²” in Formula (I).
Nonafluorohexyl acrylate: 3,3,4,4,5,5,6,6,6-nonafluorohexyl acrylate; manufactured by Tokyo Chemical Industry Co., Ltd.
Heptafluorobutyl acrylate: 2,2,3,3,4,4,4-heptafluorobutyl acrylate; manufactured by Tokyo Chemical Industry Co., Ltd.
X-22-174ASX (product number, manufactured by Shin-Etsu Chemical Co., Ltd.): compound having a polysiloxane structure (molecular weight: 900)
X-22-174BX: (product number, manufactured by Shin-Etsu Chemical Co., Ltd.): compound having a polysiloxane structure (molecular weight: 2,300)
KF-2012: (product number, manufactured by Shin-Etsu Chemical Co., Ltd.): compound having a polysiloxane structure (molecular weight: 4,600)

### Example 2

### 1. Synthesis of Sulfide-Based Inorganic Solid Electrolyte

### Synthesis Example A

A sulfide-based inorganic solid electrolyte was synthesized with reference to non-patent documents of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a glove box in an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed using an agate pestle for 5 minutes. A mixing ratio between Li₂S and P₂S₅(Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above-described lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining a yellow powder (6.20 g) of a sulfide-based inorganic solid electrolyte (Li—P—S-based glass, hereinafter, may be denoted as LPS). A particle diameter of the Li—P—S-based glass was 15 μm.

2. Each of compositions shown in Table 2-1 to Table 2-4 (collectively referred to as Table 2) was prepared as follows.

### <Preparation of Inorganic Solid Electrolyte-Containing Composition>

60 g of zirconia beads having a diameter of 5 mm was put into a 45 mL container made of zirconia (manufactured by FRITSCH), and 12.33 g of LPS synthesized in Synthesis Example A described above, 0.2 g (in terms of solid content mass) of the binder solution or the dispersion liquid shown in Table 2-1 or Table 2-4, and 12.5 g (total amount) of butyl butyrate as a dispersion medium were put thereinto. Thereafter, the container was set in a planetary ball mill P-7 (product name). The mixture was stirred at an initial temperature of 25° C. and a rotation speed of 150 rpm for 10 minutes (temperature adjustment was not performed during the mixing) to prepare each of the inorganic solid electrolyte-containing compositions (slurries) K-1 to K-23 and Kc11 to Kc15.

### <Preparation of Positive Electrode Composition>

60 g of zirconia beads having a diameter of 5 mm were put into a 45 mL container made of zirconia (manufactured by FRITSCH), and then 4.8 g of LPS synthesized in Synthesis Example A, and 7.5 g (total amount) of butyl butyrate as a dispersion medium were put into the container. The container was set in a planetary ball mill P-7 (product name), and the mixture was stirred at an initial temperature of 25° C. and a rotation speed of 200 rpm for 30 minutes (temperature adjustment was not carried out during the mixing). Thereafter, into the container, 12.3 g of NMC (manufactured by Sigma-Aldrich Co., LLC) as a positive electrode active material, 0.33 g of acetylene black (AB) as a conductive auxiliary agent, and 0.15 g (in terms of solid content mass) of the binder solution or the dispersion liquid shown in Table 2-2 or Table 2-4 were put. The container was set in a planetary ball mill P-7 (product name), and mixing was continued for 30 minutes at an initial temperature of 25° C. and a rotation speed of 200 rpm (temperature adjustment was not carried out during the mixing) to prepare each of positive electrode compositions (slurries) PK-1 to PK-23 and PKc21 to PKc25.

### <Preparation of Negative Electrode Composition>

60 g of zirconia beads having a diameter of 5 mm was put into a 45 mL container made of zirconia (manufactured by FRITSCH), and 4.58 g of LPS synthesized in Synthesis Example A, 0.1 g (in terms of solid content mass) of the binder solution or the dispersion liquid shown in Table 2-3 or Table 2-4, and 12 g (total amount) of butyl butyrate were put thereinto. The container was set in a planetary ball mill P-7 (product name), and the mixture was stirred at an initial temperature of 25° C. and a rotation speed of 300 rpm for 60 minutes (temperature adjustment was not carried out during the mixing). Thereafter, 7.8 g of silicon (Si) as a negative electrode active material and 0.53 g of VGCF (manufactured by Showa Denko K.K.) as a conductive auxiliary agent were charged, and the container was set in a planetary ball mill P-7 (product name) in the same manner, and the mixture was stirred at an initial temperature of 25° C. and a rotation speed of 100 rpm for 10 minutes (temperature adjustment was not carried out during the mixing) to prepare each of negative electrode compositions (slurries) NK-1 to NK-23 and NKc31 to NKc35.

In Table 2, the composition content is the content (% by mass) with respect to the total mass of the composition, the solid content is the content (% by mass) with respect to 100% by mass of the solid content of the composition, and the unit is omitted in the table.

### <Evaluation 1: Temperature Measurement During Composition Preparation>

The internal temperature of the mixture in a case of preparing each composition as described above was measured, and a heat generation amount during the mixing of the inorganic solid electrolyte and the binder was evaluated based on which of the following evaluation standards the highest temperature of the internal temperature was included in. In the present test, the internal temperature of the mixture was evaluated as a pass in a case of “D” or higher. The results are shown in the column of “Heat generation test during dispersion” in Table 2.

### —Evaluation Standard—

A: highest temperature of internal temperature<30° C.
B: 30° C.≤highest temperature of internal temperature<35° C.
C: 35° C.≤highest temperature of internal temperature<40° C.
D: 40° C.≤highest temperature of internal temperature<45° C.
E: 45° C.≤highest temperature of internal temperature<50° C.
F: 50° C.≤highest temperature of internal temperature

TABLE 2

| | | Inorganic solid | | | Binder solution or | | | Dispersion | | | | |
|---|---|---|---|---|---|---|---|---|---|---|---|---|
| | | electrolyte | | | dispersion liquid | | | medium | | Active material | | |
| | | | Composition | Solid | | Composition | Solid | | Composition | | Composition | Solid |
| | No. | | content | content | | content | content | | content | | content | content |
| Inorganic | K-1 | LPS | 49.3 | 98.5 | S-1 | 0.8 | 1.5 | Butyl | 50.0 | — | — | — |
| solid | | | | | | | | butyrate | | | | |
| electrolyte- | K-2 | LPS | 49.3 | 98.5 | S-2 | 0.8 | 1.5 | Butyl | 50.0 | — | — | — |
| containing | | | | | | | | butyrate | | | | |
| composition | K-3 | LPS | 49.3 | 98.5 | S-3 | 0.8 | 1.5 | Butyl | 50.0 | — | — | — |
| | | | | | | | | butyrate | | | | |
| | K-4 | LPS | 49.3 | 98.5 | S-4 | 0.8 | 1.5 | Butyl | 50.0 | — | — | — |
| | | | | | | | | butyrate | | | | |
| | K-5 | LPS | 49.3 | 98.5 | S-5 | 0.8 | 1.5 | Butyl | 50.0 | — | — | — |
| | | | | | | | | butyrate | | | | |
| | K-22 | LPS | 49.3 | 98.5 | S-22 | 0.8 | 1.5 | Butyl | 50.0 | — | — | — |
| | | | | | | | | butyrate | | | | |
| | K-6 | LPS | 49.3 | 98.5 | S-6 | 0.8 | 1.5 | Butyl | 50.0 | — | — | — |
| | | | | | | | | butyrate | | | | |
| | K-7 | LPS | 49.3 | 98.5 | S-7 | 0.8 | 1.5 | Butyl | 50.0 | — | — | — |
| | | | | | | | | butyrate | | | | |
| | K-8 | LPS | 49.3 | 98.5 | S-8 | 0.8 | 1.5 | Butyl | 50.0 | — | — | — |
| | | | | | | | | butyrate | | | | |
| | K-9 | LPS | 49.3 | 98.5 | S-9 | 0.8 | 1.5 | Butyl | 50.0 | — | — | — |
| | | | | | | | | butyrate | | | | |
| | K-10 | LPS | 49.3 | 98.5 | S-10 | 0.8 | 1.5 | Butyl | 50.0 | — | — | — |
| | | | | | | | | butyrate | | | | |
| | K-11 | LPS | 49.3 | 98.5 | S-11 | 0.8 | 1.5 | Butyl | 50.0 | — | — | — |
| | | | | | | | | butyrate | | | | |
| | K-12 | LPS | 49.3 | 98.5 | S-12 | 0.8 | 1.5 | Butyl | 50.0 | — | — | — |
| | | | | | | | | butyrate | | | | |
| | K-13 | LPS | 49.3 | 98.5 | S-13 | 0.8 | 1.5 | Butyl | 50.0 | — | — | — |
| | | | | | | | | butyrate | | | | |
| | K-14 | LPS | 49.3 | 98.5 | S-14 | 0.8 | 1.5 | Butyl | 50.0 | — | — | — |
| | | | | | | | | butyrate | | | | |
| | K-15 | LPS | 49.3 | 98.5 | S-15 | 0.8 | 1.5 | Butyl | 50.0 | — | — | — |
| | | | | | | | | butyrate | | | | |
| | K-16 | LPS | 49.3 | 98.5 | S-16 | 0.8 | 1.5 | Butyl | 50.0 | — | — | — |
| | | | | | | | | butyrate | | | | |
| | K-17 | LPS | 49.3 | 98.5 | S-17 | 0.8 | 1.5 | Butyl | 50.0 | — | — | — |
| | | | | | | | | butyrate | | | | |
| | K-18 | LPS | 49.3 | 98.5 | S-18 | 0.8 | 1.5 | Butyl | 50.0 | — | — | — |
| | | | | | | | | butyrate | | | | |
| | K-19 | LPS | 49.3 | 98.5 | S-19 | 0.8 | 1.5 | Butyl | 50.0 | — | — | — |
| | | | | | | | | butyrate | | | | |
| | K-20 | LPS | 49.3 | 98.5 | S-20 | 0.8 | 1.5 | Butyl | 50.0 | — | — | — |
| | | | | | | | | butyrate | | | | |
| | K-23 | LPS | 49.3 | 98.5 | S-23 | 0.8 | 1.5 | Butyl | 50.0 | — | — | — |
| | | | | | | | | butyrate | | | | |
| | K-21 | LPS | 49.3 | 98.5 | S-21 | 0.8 | 1.5 | Butyl | 50.0 | — | — | — |
| | | | | | | | | butyrate | | | | |
| Positive | PK-1 | LPS | 19.2 | 27.4 | S-1 | 0.6 | 0.8 | Butyl | 30.0 | NMC | 49.0 | 70.0 |
| electrode | | | | | | | | butyrate | | | | |
| composition | PK-2 | LPS | 19.2 | 27.4 | S-2 | 0.6 | 0.8 | Butyl | 30.0 | NMC | 49.0 | 70.0 |
| | | | | | | | | butyrate | | | | |
| | PK-3 | LPS | 19.2 | 27.4 | S-3 | 0.6 | 0.8 | Buty1 | 30.0 | NMC | 49.0 | 70.0 |
| | | | | | | | | butyrate | | | | |
| | PK-4 | LPS | 19.2 | 27.4 | S-4 | 0.6 | 0.8 | Buty1 | 30.0 | NMC | 49.0 | 70.0 |
| | | | | | | | | butyrate | | | | |
| | PK-5 | LPS | 19.2 | 27.4 | S-5 | 0.6 | 0.8 | Buty1 | 30.0 | NMC | 49.0 | 70.0 |
| | | | | | | | | butyrate | | | | |
| | PK-22 | LPS | 19.2 | 27.4 | S-22 | 0.6 | 0.8 | Buty1 | 30.0 | NMC | 49.0 | 70.0 |
| | | | | | | | | butyrate | | | | |
| | PK-6 | LPS | 19.2 | 27.4 | S-6 | 0.6 | 0.8 | Buty1 | 30.0 | NMC | 49.0 | 70.0 |
| | | | | | | | | butyrate | | | | |
| | PK-7 | LPS | 19.2 | 27.4 | S-7 | 0.6 | 0.8 | Butyl | 30.0 | NMC | 49.0 | 70.0 |
| | | | | | | | | butyrate | | | | |
| | PK-8 | LPS | 19.2 | 27.4 | S-8 | 0.6 | 0.8 | Buty1 | 30.0 | NMC | 49.0 | 70.0 |
| | | | | | | | | butyrate | | | | |
| | PK-9 | LPS | 19.2 | 27.4 | S-9 | 0.6 | 0.8 | Butyl | 30.0 | NMC | 49.0 | 70.0 |
| | | | | | | | | butyrate | | | | |
| | PK-10 | LPS | 19.2 | 27.4 | S-10 | 0.6 | 0.8 | Buty1 | 30.0 | NMC | 49.0 | 70.0 |
| | | | | | | | | butyrate | | | | |
| | PK-11 | LPS | 19.2 | 27.4 | S-11 | 0.6 | 0.8 | Buty1 | 30.0 | NMC | 49.0 | 70.0 |
| | | | | | | | | butyrate | | | | |
| | PK-12 | LPS | 19.2 | 27.4 | S-12 | 0.6 | 0.8 | Butyl | 30.0 | NMC | 49.0 | 70.0 |
| | | | | | | | | butyrate | | | | |
| | PK-13 | LPS | 19.2 | 27.4 | S-13 | 0.6 | 0.8 | Buty1 | 30.0 | NMC | 49.0 | 70.0 |
| | | | | | | | | butyrate | | | | |
| | PK-14 | LPS | 19.2 | 27.4 | S-14 | 0.6 | 0.8 | Buty1 | 30.0 | NMC | 49.0 | 70.0 |
| | | | | | | | | butyrate | | | | |
| | PK-15 | LPS | 19.2 | 27.4 | S-15 | 0.6 | 0.8 | Butyl | 30.0 | NMC | 49.0 | 70.0 |
| | | | | | | | | butyrate | | | | |
| | PK-16 | LPS | 19.2 | 27.4 | S-16 | 0.6 | 0.8 | Buty1 | 30.0 | NMC | 49.0 | 70.0 |
| | | | | | | | | butyrate | | | | |
| | PK-17 | LPS | 19.2 | 27.4 | S-17 | 0.6 | 0.8 | Buty1 | 30.0 | NMC | 49.0 | 70.0 |
| | | | | | | | | butyrate | | | | |
| | PK-18 | LPS | 19.2 | 27.4 | S-18 | 0.6 | 0.8 | Buty1 | 30.0 | NMC | 49.0 | 70.0 |
| | | | | | | | | butyrate | | | | |
| | PK-19 | LPS | 19.2 | 27.4 | S-19 | 0.6 | 0.8 | Butyl | 30.0 | NMC | 49.0 | 70.0 |
| | | | | | | | | butyrate | | | | |
| | PK-20 | LPS | 19.2 | 27.4 | S-20 | 0.6 | 0.8 | Buty1 | 30.0 | NMC | 49.0 | 70.0 |
| | | | | | | | | butyrate | | | | |
| | PK-23 | LPS | 19.2 | 27.4 | S-23 | 0.6 | 0.8 | Butyl | 30.0 | NMC | 49.0 | 70.0 |
| | | | | | | | | butyrate | | | | |
| | PK-21 | LPS | 19.2 | 27.4 | S-21 | 0.6 | 0.8 | Butyl | 30.0 | NMC | 49.0 | 70.0 |
| | | | | | | | | butyrate | | | | |
| Negative | NK-1 | LPS | 18.3 | 35.2 | S-1 | 0.4 | 0.8 | Butyl | 48.0 | Si | 31.2 | 60.0 |
| electrode | | | | | | | | butyrate | | | | |
| composition | NK-2 | LPS | 18.3 | 35.2 | S-2 | 0.4 | 0.8 | Butyl | 48.0 | Si | 31.2 | 60.0 |
| | | | | | | | | butyrate | | | | |
| | NK-3 | LPS | 18.3 | 35.2 | S-3 | 0.4 | 0.8 | Butyl | 48.0 | Si | 31.2 | 60.0 |
| | | | | | | | | butyrate | | | | |
| | NK-4 | LPS | 18.3 | 35.2 | S-4 | 0.4 | 0.8 | Butyl | 48.0 | Si | 31.2 | 60.0 |
| | | | | | | | | butyrate | | | | |
| | NK-5 | LPS | 18.3 | 35.2 | S-5 | 0.4 | 0.8 | Butyl | 48.0 | Si | 31.2 | 60.0 |
| | | | | | | | | butyrate | | | | |
| | NK-22 | LPS | 18.3 | 35.2 | S-22 | 0.4 | 0.8 | Butyl | 48.0 | Si | 31.2 | 60.0 |
| | | | | | | | | butyrate | | | | |
| | NK-6 | LPS | 18.3 | 35.2 | S-6 | 0.4 | 0.8 | Butyl | 48.0 | Si | 31.2 | 60.0 |
| | | | | | | | | butyrate | | | | |
| | NK-7 | LPS | 18.3 | 35.2 | S-7 | 0.4 | 0.8 | Butyl | 48.0 | Si | 31.2 | 60.0 |
| | | | | | | | | butyrate | | | | |
| | NK-8 | LPS | 18.3 | 35.2 | S-8 | 0.4 | 0.8 | Butyl | 48.0 | Si | 31.2 | 60.0 |
| | | | | | | | | butyrate | | | | |
| | NK-9 | LPS | 18.3 | 35.2 | S-9 | 0.4 | 0.8 | Butyl | 48.0 | Si | 31.2 | 60.0 |
| | | | | | | | | butyrate | | | | |
| | NK-10 | LPS | 18.3 | 35.2 | S-10 | 0.4 | 0.8 | Butyl | 48.0 | Si | 31.2 | 60.0 |
| | | | | | | | | butyrate | | | | |
| | NK-11 | LPS | 18.3 | 35.2 | S-11 | 0.4 | 0.8 | Butyl | 48.0 | Si | 31.2 | 60.0 |
| | | | | | | | | butyrate | | | | |
| | NK-12 | LPS | 18.3 | 35.2 | S-12 | 0.4 | 0.8 | Butyl | 48.0 | Si | 31.2 | 60.0 |
| | | | | | | | | butyrate | | | | |
| | NK-13 | LPS | 18.3 | 35.2 | S-13 | 0.4 | 0.8 | Butyl | 48.0 | Si | 31.2 | 60.0 |
| | | | | | | | | butyrate | | | | |
| | NK-14 | LPS | 18.3 | 35.2 | S-14 | 0.4 | 0.8 | Butyl | 48.0 | Si | 31.2 | 60.0 |
| | | | | | | | | butyrate | | | | |
| | NK-15 | LPS | 18.3 | 35.2 | S-15 | 0.4 | 0.8 | Butyl | 48.0 | Si | 31.2 | 60.0 |
| | | | | | | | | butyrate | | | | |
| | NK-16 | LPS | 18.3 | 35.2 | S-16 | 0.4 | 0.8 | Butyl | 48.0 | Si | 31.2 | 60.0 |
| | | | | | | | | butyrate | | | | |
| | NK-17 | LPS | 18.3 | 35.2 | S-17 | 0.4 | 0.8 | Butyl | 48.0 | Si | 31.2 | 60.0 |
| | | | | | | | | butyrate | | | | |
| | NK-18 | LPS | 18.3 | 35.2 | S-18 | 0.4 | 0.8 | Butyl | 48.0 | Si | 31.2 | 60.0 |
| | | | | | | | | butyrate | | | | |
| | NK-19 | LPS | 18.3 | 35.2 | S-19 | 0.4 | 0.8 | Butyl | 48.0 | Si | 31.2 | 60.0 |
| | | | | | | | | butyrate | | | | |
| | NK-20 | LPS | 18.3 | 35.2 | S-20 | 0.4 | 0.8 | Butyl | 48.0 | Si | 31.2 | 60.0 |
| | | | | | | | | butyrate | | | | |
| | NK-23 | LPS | 18.3 | 35.2 | S-23 | 0.4 | 0.8 | Butyl | 48.0 | Si | 31.2 | 60.0 |
| | | | | | | | | butyrate | | | | |
| | NK-21 | LPS | 18.3 | 35.2 | S-21 | 0.4 | 0.8 | Butyl | 48.0 | Si | 31.2 | 60.0 |
| | | | | | | | | butyrate | | | | |
| Inorganic | Kc11 | LPS | 49.3 | 98.5 | T-1 | 0.8 | 1.5 | Butyl | 50.0 | — | — | — |
| solid | | | | | | | | butyrate | | | | |
| electrolyte- | Kc12 | LPS | 49.3 | 98.5 | T-2 | 0.8 | 1.5 | Butyl | 50.0 | — | — | — |
| containing | | | | | | | | butyrate | | | | |
| composition | Kc13 | LPS | 49.3 | 98.5 | T-3 | 0.8 | 1.5 | Butyl | 50.0 | — | — | — |
| | | | | | | | | butyrate | | | | |
| | Kc14 | LPS | 49.3 | 98.5 | T-4 | 0.8 | 1.5 | Butyl | 50.0 | — | — | — |
| | | | | | | | | butyrate | | | | |
| | Kc15 | LPS | 49.3 | 98.5 | T-5 | 0.8 | 1.5 | Butyl | 50.0 | — | — | — |
| | | | | | | | | butyrate | | | | |
| Positive | PKc21 | LPS | 19.2 | 27.4 | T-1 | 0.6 | 0.8 | Butyl | 30.0 | NMC | 49.0 | 70.0 |
| electrode | | | | | | | | butyrate | | | | |
| composition | PKc22 | LPS | 19.2 | 27.4 | T-2 | 0.6 | 0.8 | Butyl | 30.0 | NMC | 49.0 | 70.0 |
| | | | | | | | | butyrate | | | | |
| | PKc23 | LPS | 19.2 | 27.4 | T-3 | 0.6 | 0.8 | Butyl | 30.0 | NMC | 49.0 | 70.0 |
| | | | | | | | | butyrate | | | | |
| | PKc24 | LPS | 19.2 | 27.4 | T-4 | 0.6 | 0.8 | Butyl | 30.0 | NMC | 49.0 | 70.0 |
| | | | | | | | | butyrate | | | | |
| | PKc25 | LPS | 19.2 | 27.4 | T-5 | 0.6 | 0.8 | Butyl | 30.0 | NMC | 49.0 | 70.0 |
| | | | | | | | | butyrate | | | | |
| Negative | NKc31 | LPS | 18.3 | 35.2 | T-1 | 0.4 | 0.8 | Butyl | 48.0 | Si | 31.2 | 60.0 |
| electrode | | | | | | | | butyrate | | | | |
| composition | NKc32 | LPS | 18.3 | 35.2 | T-2 | 0.4 | 0.8 | Butyl | 48.0 | Si | 31.2 | 60.0 |
| | | | | | | | | butyrate | | | | |
| | NKc33 | LPS | 18.3 | 35.2 | T-3 | 0.4 | 0.8 | Butyl | 48.0 | Si | 31.2 | 60.0 |
| | | | | | | | | butyrate | | | | |
| | NKc34 | LPS | 18.3 | 35.2 | T-4 | 0.4 | 0.8 | Butyl | 48.0 | Si | 31.2 | 60.0 |
| | | | | | | | | butyrate | | | | |
| | NKc35 | LPS | 18.3 | 35.2 | T-5 | 0.4 | 0.8 | Butyl | 48.0 | Si | 31.2 | 60.0 |
| | | | | | | | | butyrate | | | | |

| | | Conductive | | | Heat | |
|---|---|---|---|---|---|---|
| | | auxiliary agent | | | generation | |
| | | | Composition | Solid | test during | |
| | No. | | content | content | dispersion | Remark |
| Inorganic | K-1 | — | — | — | C | Present |
| solid | | | | | | invention |
| electrolyte- | K-2 | — | — | — | B | Present |
| containing | | | | | | invention |
| composition | K-3 | — | — | — | B | Present |
| | | | | | | invention |
| | K-4 | — | — | — | D | Present |
| | | | | | | invention |
| | K-5 | — | — | — | D | Present |
| | | | | | | invention |
| | K-22 | — | — | — | C | Present |
| | | | | | | invention |
| | K-6 | — | — | — | D | Present |
| | | | | | | invention |
| | K-7 | — | — | — | D | Present |
| | | | | | | invention |
| | K-8 | — | — | — | D | Present |
| | | | | | | invention |
| | K-9 | — | — | — | D | Present |
| | | | | | | invention |
| | K-10 | — | — | — | D | Present |
| | | | | | | invention |
| | K-11 | — | — | — | D | Present |
| | | | | | | invention |
| | K-12 | — | — | — | D | Present |
| | | | | | | invention |
| | K-13 | — | — | — | B | Present |
| | | | | | | invention |
| | K-14 | — | — | — | D | Present |
| | | | | | | invention |
| | K-15 | — | — | — | D | Present |
| | | | | | | invention |
| | K-16 | — | — | — | B | Present |
| | | | | | | invention |
| | K-17 | — | — | — | B | Present |
| | | | | | | invention |
| | K-18 | — | — | — | C | Present |
| | | | | | | invention |
| | K-19 | — | — | — | B | Present |
| | | | | | | invention |
| | K-20 | — | — | — | A | Present |
| | | | | | | invention |
| | K-23 | — | — | — | B | Present |
| | | | | | | invention |
| | K-21 | — | — | — | D | Present |
| | | | | | | invention |
| Positive | PK-1 | AB | 1.3 | 1.8 | C | Present |
| electrode | | | | | | invention |
| composition | PK-2 | AB | 1.3 | 1.8 | B | Present |
| | | | | | | invention |
| | PK-3 | AB | 1.3 | 1.8 | B | Present |
| | | | | | | invention |
| | PK-4 | AB | 1.3 | 1.8 | D | Present |
| | | | | | | invention |
| | PK-5 | AB | 1.3 | 1.8 | D | Present |
| | | | | | | invention |
| | PK-22 | AB | 1.3 | 1.8 | C | Present |
| | | | | | | invention |
| | PK-6 | AB | 1.3 | 1.8 | D | Present |
| | | | | | | invention |
| | PK-7 | AB | 1.3 | 1.8 | D | Present |
| | | | | | | invention |
| | PK-8 | AB | 1.3 | 1.8 | D | Present |
| | | | | | | invention |
| | PK-9 | AB | 1.3 | 1.8 | D | Present |
| | | | | | | invention |
| | PK-10 | AB | 1.3 | 1.8 | D | Present |
| | | | | | | invention |
| | PK-11 | AB | 1.3 | 1.8 | D | Present |
| | | | | | | invention |
| | PK-12 | AB | 1.3 | 1.8 | D | Present |
| | | | | | | invention |
| | PK-13 | AB | 1.3 | 1.8 | B | Present |
| | | | | | | invention |
| | PK-14 | AB | 1.3 | 1.8 | D | Present |
| | | | | | | invention |
| | PK-15 | AB | 1.3 | 1.8 | D | Present |
| | | | | | | invention |
| | PK-16 | AB | 1.3 | 1.8 | B | Present |
| | | | | | | invention |
| | PK-17 | AB | 1.3 | 1.8 | B | Present |
| | | | | | | invention |
| | PK-18 | AB | 1.3 | 1.8 | C | Present |
| | | | | | | invention |
| | PK-19 | AB | 1.3 | 1.8 | B | Present |
| | | | | | | invention |
| | PK-20 | AB | 1.3 | 1.8 | A | Present |
| | | | | | | invention |
| | PK-23 | AB | 1.3 | 1.8 | B | Present |
| | | | | | | invention |
| | PK-21 | AB | 1.3 | 1.8 | D | Present |
| | | | | | | invention |
| Negative | NK-1 | VGCF | 2.1 | 4.0 | C | Present |
| electrode | | | | | | invention |
| composition | NK-2 | VGCF | 2.1 | 4.0 | B | Present |
| | | | | | | invention |
| | NK-3 | VGCF | 2.1 | 4.0 | B | Present |
| | | | | | | invention |
| | NK-4 | VGCF | 2.1 | 4.0 | D | Present |
| | | | | | | invention |
| | NK-5 | VGCF | 2.1 | 4.0 | D | Present |
| | | | | | | invention |
| | NK-22 | VGCF | 2.1 | 4.0 | C | Present |
| | | | | | | invention |
| | NK-6 | VGCF | 2.1 | 4.0 | D | Present |
| | | | | | | invention |
| | NK-7 | VGCF | 2.1 | 4.0 | D | Present |
| | | | | | | invention |
| | NK-8 | VGCF | 2.1 | 4.0 | D | Present |
| | | | | | | invention |
| | NK-9 | VGCF | 2.1 | 4.0 | D | Present |
| | | | | | | invention |
| | NK-10 | VGCF | 2.1 | 4.0 | D | Present |
| | | | | | | invention |
| | NK-11 | VGCF | 2.1 | 4.0 | D | Present |
| | | | | | | invention |
| | NK-12 | VGCF | 2.1 | 4.0 | D | Present |
| | | | | | | invention |
| | NK-13 | VGCF | 2.1 | 4.0 | B | Present |
| | | | | | | invention |
| | NK-14 | VGCF | 2.1 | 4.0 | D | Present |
| | | | | | | invention |
| | NK-15 | VGCF | 2.1 | 4.0 | D | Present |
| | | | | | | invention |
| | NK-16 | VGCF | 2.1 | 4.0 | B | Present |
| | | | | | | invention |
| | NK-17 | VGCF | 2.1 | 4.0 | B | Present |
| | | | | | | invention |
| | NK-18 | VGCF | 2.1 | 4.0 | C | Present |
| | | | | | | invention |
| | NK-19 | VGCF | 2.1 | 4.0 | B | Present |
| | | | | | | invention |
| | NK-20 | VGCF | 2.1 | 4.0 | A | Present |
| | | | | | | invention |
| | NK-23 | VGCF | 2.1 | 4.0 | B | Present |
| | | | | | | invention |
| | NK-21 | VGCF | 2.1 | 4.0 | D | Present |
| | | | | | | invention |
| Inorganic | Kc11 | — | — | — | E | Comparative |
| solid | | | | | | Example |
| electrolyte- | Kc12 | — | — | — | F | Comparative |
| containing | | | | | | Example |
| composition | Kc13 | — | — | — | F | Comparative |
| | | | | | | Example |
| | Kc14 | — | — | — | E | Comparative |
| | | | | | | Example |
| | Kc15 | — | — | — | F | Comparative |
| | | | | | | Example |
| Positive | PKc21 | AB | 1.3 | 1.8 | E | Comparative |
| electrode | | | | | | Example |
| composition | PKc22 | AB | 1.3 | 1.8 | F | Comparative |
| | | | | | | Example |
| | PKc23 | AB | 1.3 | 1.8 | F | Comparative |
| | | | | | | Example |
| | PKc24 | AB | 1.3 | 1.8 | E | Comparative |
| | | | | | | Example |
| | PKc25 | AB | 1.3 | 1.8 | F | Comparative |
| | | | | | | Example |
| Negative | NKc31 | VGCF | 2.1 | 4.0 | E | Comparative |
| electrode | | | | | | Example |
| composition | NKc32 | VGCF | 2.1 | 4.0 | F | Comparative |
| | | | | | | Example |
| | NKc33 | VGCF | 2.1 | 4.0 | F | Comparative |
| | | | | | | Example |
| | NKc34 | VGCF | 2.1 | 4.0 | E | Comparative |
| | | | | | | Example |
| | NKc35 | VGCF | 2.1 | 4.0 | F | Comparative |
| | | | | | | Example |

<Abbreviations in table>
LPS: LPS synthesized in Synthesis Example A
NMC: LiNi_{1/3}Co_{1/3}Mn_{1/3}O₂
Si: Silicon (APS of 1 to 5 μm, manufactured by Alfa Aesar)
AB: Acetylene black
VGCF: Carbon nanofiber

### 3. Production of Solid Electrolyte Sheet for all-Solid-State Secondary Battery

<Production of Solid Electrolyte Sheet for all-Solid-State Secondary Battery>

Each of the inorganic solid electrolyte-containing compositions shown in the column of “Solid electrolyte composition No.” of Table 3-1 or Table 3-4 obtained as described above was applied onto an aluminum foil having a thickness of 20 μm using a baker type applicator (product name: SA-201, manufactured by Tester Sangyo Co., Ltd.) and heated at 80° C. for 2 hours to dry (to remove the dispersion medium) the inorganic solid electrolyte-containing composition. Thereafter, using a heat press machine, the inorganic solid electrolyte-containing composition which had been dried at a temperature of 120° C. and a pressure of 40 MPa for 10 seconds was heated and pressurized to produce each of solid electrolyte sheets 101 to 123 and c11 to c15 for an all-solid-state secondary battery (in Table 3-1 and Table 3-4, it is indicated as “Solid electrolyte sheet”). A film thickness of the solid electrolyte layer was 40 μm.

<Production of Positive Electrode Sheet for all-Solid-State Secondary Battery>

Each of the positive electrode compositions obtained as described above, which is shown in the column of “Electrode composition No.” in Table 3-2 or Table 3-4, was applied onto an aluminum foil having a thickness of 20 μm by using a baker type applicator (product name: SA-201), heating was carried out at 80° C. for 1 hour, and then heating was further carried out at 110° C. for 1 hour to dry (to remove the dispersion medium) the positive electrode composition. Thereafter, using a heat press machine, the dried positive electrode composition was pressurized (10 MPa, 1 minute) at 25° C. to produce each of positive electrode sheets 201 to 223, and c21 to c25 for an all-solid-state secondary battery, having a positive electrode active material layer having a film thickness of 70 μm (in Table 3-2 and Table 3-4, it is indicated as “Positive electrode sheet”).

<Production of Negative Electrode Sheet for all-Solid-State Secondary Battery>

Each of the negative electrode compositions obtained as described above, which is shown in the column of “Electrode composition No.” in Table 3-3 or Table 3-4, was applied onto a copper foil having a thickness of 20 μm by using a baker type applicator (product name: SA-201), heating was carried out at 80° C. for 1 hour, and then heating was further carried out at 110° C. for 1 hour to dry (to remove the dispersion medium) the negative electrode composition. Thereafter, using a heat press machine, the dried negative electrode composition was pressurized (10 MPa, 1 minute) at 25° C. to produce each of negative electrode sheets 301 to 323, and c31 to c35 for an all-solid state secondary battery, having a negative electrode active material layer having a film thickness of 60 μm (in Table 3-3 and Table 3-4, it is indicated as “Negative electrode sheet”).

TABLE 3

| | Inorganic solid | | Electrode | | | |
|---|---|---|---|---|---|---|
| Sheet | electrolyte-containing | Binder | composition | Binder | | |
| No. | composition No. | No. | No. | No. | Remark 1 | Remark 2 |
| 101 | K-1 | S-1 | — | — | Solid | Present |
| | | | | | electrolyte | invention |
| 102 | K-2 | S-2 | — | — | sheet | Present |
| | | | | | | invention |
| 103 | K-3 | S-3 | — | — | | Present |
| | | | | | | invention |
| 104 | K-4 | S-4 | — | — | | Present |
| | | | | | | invention |
| 105 | K-5 | S-5 | — | — | | Present |
| | | | | | | invention |
| 122 | K-22 | S-22 | — | — | | Present |
| | | | | | | invention |
| 106 | K-6 | S-6 | — | — | | Present |
| | | | | | | invention |
| 107 | K-7 | S-7 | — | — | | Present |
| | | | | | | invention |
| 108 | K-8 | S-8 | — | — | | Present |
| | | | | | | invention |
| 109 | K-9 | S-9 | — | — | | Present |
| | | | | | | invention |
| 110 | K-10 | S-10 | — | — | | Present |
| | | | | | | invention |
| 111 | K-11 | S-11 | — | — | | Present |
| | | | | | | invention |
| 112 | K-12 | S-12 | — | — | | Present |
| | | | | | | invention |
| 113 | K-13 | S-13 | — | — | | Present |
| | | | | | | invention |
| 114 | K-14 | S-14 | — | — | | Present |
| | | | | | | invention |
| 115 | K-15 | S-15 | — | — | | Present |
| | | | | | | invention |
| 116 | K-16 | S-16 | — | — | | Present |
| | | | | | | invention |
| 117 | K-17 | S-17 | — | — | | Present |
| | | | | | | invention |
| 118 | K-18 | S-18 | — | — | | Present |
| | | | | | | invention |
| 119 | K-19 | S-19 | — | — | | Present |
| | | | | | | invention |
| 120 | K-20 | S-20 | — | — | | Present |
| | | | | | | invention |
| 123 | K-23 | S-23 | — | — | | Present |
| | | | | | | invention |
| 121 | K-21 | S-21 | — | — | | Present |
| | | | | | | invention |
| 201 | — | — | PK-1 | S-1 | Positive | Present |
| | | | | | electrode | invention |
| 202 | — | — | PK-2 | S-2 | sheet | Present |
| | | | | | | invention |
| 203 | — | — | PK-3 | S-3 | | Present |
| | | | | | | invention |
| 204 | — | — | PK-4 | S-4 | | Present |
| | | | | | | invention |
| 205 | — | — | PK-5 | S-5 | | Present |
| | | | | | | invention |
| 222 | — | — | PK-22 | S-22 | | Present |
| | | | | | | invention |
| 206 | — | — | PK-6 | S-6 | | Present |
| | | | | | | invention |
| 207 | — | — | PK-7 | S-7 | | Present |
| | | | | | | invention |
| 208 | — | — | PK-8 | S-8 | | Present |
| | | | | | | invention |
| 209 | — | — | PK-9 | S-9 | | Present |
| | | | | | | invention |
| 210 | — | — | PK-10 | S-10 | | Present |
| | | | | | | invention |
| 211 | — | — | PK-11 | S-11 | | Present |
| | | | | | | invention |
| 212 | — | — | PK-12 | S-12 | | Present |
| | | | | | | invention |
| 213 | — | — | PK-13 | S-13 | | Present |
| | | | | | | invention |
| 214 | — | — | PK-14 | S-14 | | Present |
| | | | | | | invention |
| 215 | — | — | PK-15 | S-15 | | Present |
| | | | | | | invention |
| 216 | — | — | PK-16 | S-16 | | Present |
| | | | | | | invention |
| 217 | — | — | PK-17 | S-17 | | Present |
| | | | | | | invention |
| 218 | — | — | PK-18 | S-18 | | Present |
| | | | | | | invention |
| 219 | — | — | PK-19 | S-19 | | Present |
| | | | | | | invention |
| 220 | — | — | PK-20 | S-20 | | Present |
| | | | | | | invention |
| 223 | — | — | PK-23 | S-23 | | Present |
| | | | | | | invention |
| 221 | — | — | PK-21 | S-21 | | Present |
| | | | | | | invention |
| 301 | — | — | NK-1 | S-1 | Negative | Present |
| | | | | | electrode | invention |
| 302 | — | — | NK-2 | S-2 | sheet | Present |
| | | | | | | invention |
| 303 | — | — | NK-3 | S-3 | | Present |
| | | | | | | invention |
| 304 | — | — | NK-4 | S-4 | | Present |
| | | | | | | invention |
| 305 | — | — | NK-5 | S-5 | | Present |
| | | | | | | invention |
| 322 | — | — | NK-22 | S-22 | | Present |
| | | | | | | invention |
| 306 | — | — | NK-6 | S-6 | | Present |
| | | | | | | invention |
| 307 | — | — | NK-7 | S-7 | | Present |
| | | | | | | invention |
| 308 | — | — | NK-8 | S-8 | | Present |
| | | | | | | invention |
| 309 | — | — | NK-9 | S-9 | | Present |
| | | | | | | invention |
| 310 | — | — | NK-10 | S-10 | | Present |
| | | | | | | invention |
| 311 | — | — | NK-11 | S-11 | | Present |
| | | | | | | invention |
| 312 | — | — | NK-12 | S-12 | | Present |
| | | | | | | invention |
| 313 | — | — | NK-13 | S-13 | | Present |
| | | | | | | invention |
| 314 | — | — | NK-14 | S-14 | | Present |
| | | | | | | invention |
| 315 | — | — | NK-15 | S-15 | | Present |
| | | | | | | invention |
| 316 | — | — | NK-16 | S-16 | | Present |
| | | | | | | invention |
| 317 | — | — | NK-17 | S-17 | | Present |
| | | | | | | invention |
| 318 | — | — | NK-18 | S-18 | | Present |
| | | | | | | invention |
| 319 | — | — | NK-19 | S-19 | | Present |
| | | | | | | invention |
| 320 | — | — | NK-20 | S-20 | | Present |
| | | | | | | invention |
| 323 | — | — | NK-23 | S-23 | | Present |
| | | | | | | invention |
| 321 | — | — | NK-21 | S-21 | | Present |
| | | | | | | invention |
| c11 | Kc11 | T-1 | — | — | Solid | Comparative |
| | | | | | electrolyte | Example |
| c12 | Kc12 | T-2 | — | — | sheet | Comparative |
| | | | | | | Example |
| c13 | Kc13 | T-3 | — | — | | Comparative |
| | | | | | | Example |
| c14 | Kc14 | T-4 | — | — | | Comparative |
| | | | | | | Example |
| c15 | Kc15 | T-5 | — | — | | Comparative |
| | | | | | | Example |
| c21 | — | — | PKc21 | T-1 | Positive | Comparative |
| | | | | | electrode | Example |
| c22 | — | — | PKc22 | T-2 | sheet | Comparative |
| | | | | | | Example |
| c23 | — | — | PKc23 | T-3 | | Comparative |
| | | | | | | Example |
| c24 | — | — | PKc24 | T-4 | | Comparative |
| | | | | | | Example |
| c25 | — | — | PKc25 | T-5 | | Comparative |
| | | | | | | Example |
| c31 | — | — | NKc31 | T-1 | Negative | Comparative |
| | | | | | electrode | Example |
| c32 | — | — | NKc32 | T-2 | sheet | Comparative |
| | | | | | | Example |
| c33 | — | — | NKc33 | T-3 | | Comparative |
| | | | | | | Example |
| c34 | — | — | NKc34 | T-4 | | Comparative |
| | | | | | | Example |
| c35 | — | — | NKc35 | T-5 | | Comparative |
| | | | | | | Example |

### 4. Production of all-Solid-State Secondary Battery

First, each of a positive electrode sheet for an all-solid-state secondary battery, including a solid electrolyte layer, and a negative electrode sheet for an all-solid-state secondary battery, including a solid electrolyte layer, which would be used for manufacturing an all-solid-state secondary battery, was produced.

—Production of Positive Electrode Sheet for all-Solid-State Secondary Battery, Including Solid Electrolyte Layer—

The solid electrolyte sheet shown in the column of “Solid electrolyte layer (sheet No.)” of Table 4-1 and Table 4-3, prepared as described above, was overlaid on the positive electrode active material layer of each of the positive electrode sheets for an all-solid-state secondary battery shown in the column of “Electrode active material layer (sheet No.)” of Table 4-1 and Table 4-3 so that it came into contact with the positive electrode active material layer, transferred (laminated) by being pressurized at 50 MPa and 25° C. using a press machine, and then pressurized at 600 MPa and at 25° C., whereby each of positive electrode sheet Nos. 201 to 223, and c21 to c25 for an all-solid-state secondary battery having a thickness of 25 m (thickness of positive electrode active material layer: 50 μm) was produced.

—Production of Negative Electrode Sheet for all-Solid-State Secondary Battery, Including Solid Electrolyte Layer—

Next, the solid electrolyte sheet shown in the column of “Solid electrolyte layer (sheet No.)” of Table 4-2 and Table 4-3, prepared as described above, was overlaid on the negative electrode active material layer of each of the negative electrode sheets for an all-solid-state secondary battery shown in the column of “Electrode active material layer (sheet No.)” of Table 4-2 and Table 4-3 so that it came into contact with the negative electrode active material layer, transferred (laminated) by being pressurized at 50 MPa and 25° C. using a press machine, and then pressurized at 600 MPa and at 25° C., whereby each of negative electrode sheets 301 to 323, and c31 to c35 for an all-solid-state secondary battery having a film thickness of 25 m (thickness of negative electrode active material layer: 40 μm) was produced.

An all-solid-state secondary battery No. 401 having a layer configuration shown in FIG. 1 was produced as follows.

The positive electrode sheet No. 201 for an all-solid-state secondary battery (the aluminum foil of the solid electrolyte-containing sheet had been peeled off), which included the solid electrolyte layer obtained as described above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a lithium foil cut out in a disk shape having a diameter of 15 mm was overlaid on the solid electrolyte layer. After further overlaying a stainless steel foil thereon, the 2032-type coin case 11 was crimped to produce an all-solid-state secondary battery 13 (No. 401), shown in FIG. 2. The all-solid-state secondary battery manufactured in this manner has a layer configuration illustrated in FIG. 1 (however, the lithium foil corresponds to a negative electrode active material layer 2 and a negative electrode collector 1).

All-solid-state secondary batteries No. 402 to 423 and c101 to c105 were produced as follows.

Each of all-solid state secondary batteries Nos. 402 to 423 and c101 to c105 was manufactured in the same manner as in the manufacturing of the all-solid-state secondary battery No. 401, except that in the manufacturing of the all-solid-state secondary battery No. 401, a negative electrode sheet for an all-solid-state secondary battery, which had a solid electrolyte layer and is indicated by No. shown in the column of “Electrode active material layer (sheet No.)” of Table 4-1 and Table 4-3 was used instead of the positive electrode sheet No. 201 for a secondary battery, which has a solid electrolyte layer.

An all-solid-state secondary battery No. 501 having a layer configuration illustrated in FIG. 1 was manufactured as follows.

The negative electrode sheet No. 301 for an all-solid-state secondary battery (the aluminum foil of the solid electrolyte-containing sheet had been peeled off), which included the solid electrolyte obtained as described above, was cut out into a disk shape having a diameter of 14.5 mm and placed, as shown in FIG. 2, in a stainless 2032-type coin case 11 into which a spacer and a washer (not illustrated in FIG. 2) had been incorporated. Next, a positive electrode sheet (a positive electrode active material layer) punched out from the positive electrode sheet for an all-solid-state secondary battery produced below into a disk shape having a diameter of 14.0 mm was overlaid on the solid electrolyte layer. A stainless steel foil (a positive electrode collector) was further layered thereon to form a laminate 12 for an all-solid-state secondary battery (a laminate consisting of stainless steel foil-aluminum foil-positive electrode active material layer-solid electrolyte layer-negative electrode active material layer-copper foil). Thereafter, the 2032-type coin case 11 was crimped to manufacture an all-solid-state secondary battery No. 501 shown in FIG. 2.

A positive electrode sheet for a solid state secondary battery to be used in the manufacturing of the all-solid-state secondary battery No. 501 was prepared as follows.

### —Preparation of Positive Electrode Composition—

180 beads of zirconia beads having a diameter of 5 mm were put into a 45 mL container made of zirconia (manufactured by Fritsch Japan Co., Ltd.), 2.7 g of LPS synthesized in the above Synthesis Example A, and 0.3 g of KYNAR FLEX 2500-20 (product name, PVdF-HFP: polyvinylidene fluoride-hexafluoropropylene copolymer, manufactured by Arkema S.A.) in terms of solid content mass and 22 g of butyl butyrate were put into the above container. The container was set in a planetary ball mill P-7 (product name, manufactured by Fritsch Japan Co., Ltd.) and the components were stirred for 60 minutes at 25° C. and a rotation speed of 300 rpm. Thereafter, 7.0 g of LiNi_{1/3}Co_{1/3}Mn_{1/3}O₂ (NMC) was put into the container as the positive electrode active material, and similarly, the container was set in a planetary ball mill P-7, mixing was continued at 25° C. and a rotation speed of 100 rpm for 5 minutes to prepare a positive electrode composition.

### —Production of Positive Electrode Sheet for Solid State Secondary Battery—

The positive electrode composition obtained as described above was applied onto an aluminum foil (a positive electrode collector) having a thickness of 20 μm with a baker type applicator (product name: SA-201, manufactured by Tester Sangyo Co., Ltd.), heating was carried out at 100° C. for 2 hours to dry (to remove the dispersion medium) the positive electrode composition. Thereafter, using a heat press machine, the dried positive electrode composition was pressurized (10 MPa, 1 minute) at 25° C. to produce each of positive electrode sheets for an all-solid-state secondary battery, having a positive electrode active material layer having a film thickness of 80 μm.

All-solid-state secondary batteries No. 502 to 523 and c201 to c205 were produced as follows.

Each of all-solid state secondary batteries Nos. 502 to 523 and c201 to c205 was manufactured in the same manner as in the manufacturing of the all-solid-state secondary battery No. 501, except that in the manufacturing of the all-solid-state secondary battery No. 501, a positive electrode sheet for an all-solid-state secondary battery, which had a solid electrolyte layer and is indicated by No. shown in the column of “Electrode active material layer (sheet No.)” of Table 4-2 and Table 4-3 was used instead of the negative electrode sheet No. 301 for a secondary battery, which had a solid electrolyte layer.

### <Evaluation 2: Ion Conductivity Measurement>

Ion conductivity of each of the produced all-solid state secondary batteries was measured. Specifically, each of the all-solid-state secondary batteries was used as a sample for measuring ion conductivity, and an alternating current impedance was measured at a voltage amplitude of 5 mV and a frequency of 1 MHz to 1 Hz using 1255B FREQUENCY RESPONSE ANALYZER (product name, manufactured by Solartron Analytical) in a constant-temperature tank at 25° C. From the measurement result, a resistance of the sample for measuring ion conductivity in the layer thickness direction was determined, and the ion conductivity was determined by the calculation according to Expression (C1). The results are shown in Tables 4-1 to Table 4-3 (collectively referred to as Table 4).

Ion conductivity σ(mS/cm)=1000×Sample layer thickness (cm)/[Resistance (Ω)×Sample area (cm²)] Expression (C1):

In Expression (C1), the sample layer thickness is a value obtained by measuring the thickness before placing the laminate 12 in the 2032-type coin case 11 and subtracting the thickness of the collector (the total layer thickness of the solid electrolyte layer and the electrode active material layer). The sample area is the area of the disk-shaped sheet having a diameter of 14.5 mm.

It was determined where the obtained ion conductivity a was included in any of the following evaluation standards.

In the present test, the ion conductivity a was evaluated as a pass in a case of “D” or higher.

### —Evaluation Standard—

$$\begin{matrix}A : 0.3 \leq σ \\ B : 0.25 \leq σ < 0. 30 \\ C : 0.2 \leq σ < 0.25 \\ D : 0.15 \leq σ < 0. 20 \\ E : 0.1 \leq σ < 0. 15 \\ F : σ < 0.1\end{matrix}$$

TABLE 4

| | Layer configuration | | | |
|---|---|---|---|---|
| | Electrode | Solid | | |
| | active | electrolyte | Ion | |
| Battery | material layer | layer | conduc- | |
| No. | (sheet No.) | (sheet No.) | tivity | Remark |
| 401 | 201 | 101 | C | Present invention |
| 402 | 202 | 102 | B | Present invention |
| 403 | 203 | 103 | B | Present invention |
| 404 | 204 | 104 | D | Present invention |
| 405 | 205 | 105 | D | Present invention |
| 422 | 222 | 122 | C | Present invention |
| 406 | 206 | 106 | D | Present invention |
| 407 | 207 | 107 | D | Present invention |
| 408 | 208 | 108 | D | Present invention |
| 409 | 209 | 109 | D | Present invention |
| 410 | 210 | 110 | D | Present invention |
| 411 | 211 | 111 | D | Present invention |
| 412 | 212 | 112 | D | Present invention |
| 413 | 213 | 113 | B | Present invention |
| 414 | 214 | 114 | D | Present invention |
| 415 | 215 | 115 | D | Present invention |
| 416 | 216 | 116 | B | Present invention |
| 417 | 217 | 117 | B | Present invention |
| 418 | 218 | 118 | C | Present invention |
| 419 | 219 | 119 | B | Present invention |
| 420 | 220 | 120 | A | Present invention |
| 423 | 223 | 123 | B | Present invention |
| 421 | 221 | 121 | D | Present invention |
| 501 | 301 | 101 | C | Present invention |
| 502 | 302 | 102 | B | Present invention |
| 503 | 303 | 103 | B | Present invention |
| 504 | 304 | 104 | D | Present invention |
| 505 | 305 | 105 | D | Present invention |
| 522 | 322 | 122 | C | Present invention |
| 506 | 306 | 106 | D | Present invention |
| 507 | 307 | 107 | D | Present invention |
| 508 | 308 | 108 | D | Present invention |
| 509 | 309 | 109 | D | Present invention |
| 510 | 310 | 110 | D | Present invention |
| 511 | 311 | 111 | D | Present invention |
| 512 | 312 | 112 | D | Present invention |
| 513 | 313 | 113 | B | Present invention |
| 514 | 314 | 114 | D | Present invention |
| 515 | 315 | 115 | D | Present invention |
| 516 | 316 | 116 | B | Present invention |
| 517 | 317 | 117 | B | Present invention |
| 518 | 318 | 118 | C | Present invention |
| 519 | 319 | 119 | B | Present invention |
| 520 | 320 | 120 | A | Present invention |
| 523 | 323 | 123 | B | Present invention |
| 521 | 321 | 121 | D | Present invention |
| c101 | c21 | c11 | E | Comparative Example |
| c102 | c22 | c12 | F | Comparative Example |
| c103 | c23 | c13 | F | Comparative Example |
| c104 | c24 | c14 | E | Comparative Example |
| c105 | c25 | c15 | F | Comparative Example |
| c201 | c31 | c11 | E | Comparative Example |
| c202 | c32 | c12 | F | Comparative Example |
| c203 | c33 | c13 | F | Comparative Example |
| c204 | c34 | c14 | E | Comparative Example |
| c205 | c35 | c15 | F | Comparative Example |

The following facts could be found from the results of Table 1 to Table 4.

It was found that, in a case where the binder of Comparative example, which did not contain the polymer represented by Formula (I) and having an acid value of 3 mgKOH/g or less, was used, the heat generation during the preparation of the inorganic solid electrolyte-containing composition could not be suppressed, and thus the resistance of the all-solid-state secondary battery increased. Specifically, all of the polymers T-1 and T-3 having no A¹ of Formula (I), the linear polymer T-2, and the polymers T-4 and T-5 having an excessively large acid value generated heat during the mixing with solid particles such as the inorganic solid electrolyte. All of the inorganic solid electrolyte-containig compositions of Comparative Examples, which were prepared by mixing in such a heat generation state, had a high resistance of the all-solid-state secondary battery.

On the other hand, in a case where the binder according to the embodiment of the present invention, which contained the polymer represented by Formula (I) and having an acid value of 3 mgKOH/g or less, was used, the heat generation during the preparation of the inorganic solid electrolyte-containing composition could be suppressed, and thus the increase in the resistance of the all-solid-state secondary battery could be suppressed.

The present invention has been described with the embodiments thereof, any details of the description of the present invention are not limited unless otherwise specified, and it is obvious that the present invention is widely construed without departing from the gist and scope of the present invention described in the accompanying claims.

Priority is claimed on JP2023-108489 filed in Japan on Jun. 30, 2023 and JP2023-220463 filed in Japan on Dec. 27, 2023, the contents of which are incorporated herein by reference.

### EXPLANATION OF REFERENCES

1: negative electrode collector
2: negative electrode active material layer
3: solid electrolyte layer
4: positive electrode active material layer
5: positive electrode collector
6: operation portion
10: all-solid-state secondary battery
11: 2032-type coin case
12: laminate for all-solid-state secondary battery
13: coin-type all-solid-state secondary battery

What is claimed is:

1. A binder for an all-solid-state secondary battery, comprising:
a polymer which is represented by Formula (I) and has an acid value of 3 mgKOH/g or less, 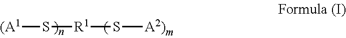
in Formula (I), R¹ represents an (m+n)-valent linking group,
A¹ represents a hydrogen atom, or a functional group or a polymer chain, including at least one of an amide group, a sulfonamide group, or an imide group,
A² represents a functional group or a polymer chain, including at least one of a fluorine atom or a polysiloxane structure,
n represents an integer of 1 to 8, and m represents an integer of 1 to 9, where m+n represents an integer of 2 to 10.

2. The binder for an all-solid-state secondary battery according to claim 1,
wherein A¹ represents a functional group or a polymer chain, including at least one of an amide group, a sulfonamide group, or an imide group.

3. The binder for an all-solid-state secondary battery according to claim 1,
wherein A² includes a functional group or a polymer chain, including a polysiloxane structure.

4. The binder for an all-solid-state secondary battery according to claim 1,
wherein the acid value of the polymer is 0.5 mgKOH/g or less, and a base value of the polymer is 0.5 mgKOH/g or less.

5. The binder for an all-solid-state secondary battery according to claim 1,
wherein A¹ includes a polymer chain of a (meth)acrylamide compound.

6. The binder for an all-solid-state secondary battery according to claim 1,
wherein A¹ includes a hydrogen atom and a polymer chain of a (meth)acrylamide compound.

7. The binder for an all-solid-state secondary battery according to claim 1,
wherein a content of A¹ in the polymer is 1% to 30% by mass.

8. The binder for an all-solid-state secondary battery according to claim 1,
wherein a weight-average molecular weight of the polymer is 30,000 or less.

9. An inorganic solid electrolyte-containing composition comprising:
the binder for an all-solid-state secondary battery according to claim 1;
an inorganic solid electrolyte having conductivity of an ion of a metal belonging to Group 1 or Group 2 of the periodic table; and
a dispersion medium.

10. The inorganic solid electrolyte-containing composition according to claim 9, further comprising:
an active material.

11. The inorganic solid electrolyte-containing composition according to claim 9, further comprising:
a conductive auxiliary agent.

12. A sheet for an all-solid-state secondary battery, comprising:
a layer formed of the inorganic solid electrolyte-containing composition according to claim 9.

13. A sheet for an all-solid-state secondary battery, comprising:
an active material layer formed of the inorganic solid electrolyte-containing composition according to claim 10.

14. An all-solid-state secondary battery comprising, in the following order:
a positive electrode active material layer;
a solid electrolyte layer; and
a negative electrode active material layer,
wherein at least one of the positive electrode active material layer, the solid electrolyte layer, or the negative electrode active material layer is a layer formed of the inorganic solid electrolyte-containing composition according to claim 9.

15. An all-solid-state secondary battery comprising, in the following order:
a positive electrode active material layer;
a solid electrolyte layer; and
a negative electrode active material layer,
wherein at least one of the positive electrode active material layer or the negative electrode active material layer is a layer formed of the inorganic solid electrolyte-containing composition according to claim 10.
